(19) United States
(12) Patent Application Publication
(10) Pub. No.: US 2016/0016860 A1
(43) Pub. Date: Jan. 21, 2016

(54) METHODS FOR PHOSPHINE OXIDE REDUCTION IN CATALYTIC WITTIG REACTIONS

(71) Applicant: DUBLIN CITY UNIVERSITY, Dublin (IE)

(72) Inventor: Christopher O'BRIEN, Runcorn (GB)

(21) Appl. No.: 14/775,931

(22) PCT Filed: Mar. 14, 2014
(86) PCT No.: PCT/EP2014/055217

§ 371 Date: Sep. 14, 2015

Related U.S. Application Data
(60) Provisional application No. 61/781,665, filed on Mar. 14, 2013.

(51) Int. Cl. C07B 37/04; C07F 9/6568

(52) U.S. Cl. CPC C07B 37/04; C07F 9/65685

(57) ABSTRACT

A method for increasing the rate of phosphine oxide reduction, preferably during a Wittig reaction comprising use of an acid additive is provided. A room temperature catalytic Wittig reaction (CWR) the rate of reduction of the phosphine oxide is increased due to the addition of the acid additive is described. Furthermore, the extension of the CWR to semi-stabilized and non-stabilized ylides has been accomplished by utilization of a masked base and/or ylide-tuning.

### FIELD OF THE INVENTION

The present invention relates to methods for performing one-pot catalytic Wittig reactions, with phosphine catalysts which are generated in situ by the reduction of substoichiometric quantities of phosphine oxide precatalysts. The rate of phosphine oxide reduction is enhanced through the addition of acid additive components.

### BACKGROUND TO THE INVENTION

Discovery of new and refinement of existing synthetic methodologies are essential if chemistry is to adapt to the changes and consequently challenges in its application landscape. The impediments to new synthetic methodologies can be represented in terms of substrate diversity, energy cost, ease-of-use, or deployment. In regard to organic synthesis this generally relies on the interplay and reactivity of functional groups.

Carbon-carbon double bonds present a multitude of synthetic opportunities. Arguably, the most utilized methodology for the construction of this important functional group is the Wittig reaction. Consequently, the Wittig reaction has received considerable attention by numerous groups both in application and mechanistic understanding. Recently, our laboratory was successful in developing the first catalytic Wittig reaction (C. J. O'Brien, et al., Angew. Chem. 2009, 121, 6968-6971; Angew. Chem. Int. Ed. 2009, 48, 6836-6839; US2012/0029211). Subsequently others applied this reduction strategy to the Appel and Staudinger reactions (A. D. Kosal et al., Angew. Chem. Int. Ed. 2012, 51, 12036-12040; H. A. van Kalkeren et al., Adv. Synth. Catal. 2012, 354, 1417-1421; H. A. van Kalkeren et al., Chem. Eur. J. 2011, 17, 11290-11295).

US2012/0029211 describes a catalytic Wittig reaction (CWR) utilizing a phosphine comprising the steps of providing a phosphine oxide precatalyst and reducing the phosphine oxide precatalyst to produce the phosphine forming a phosphonium ylide precursor from the phosphine and an organohalide; generating a phosphonium ylide from the phosphonium ylide precursor; reacting the phosphonium ylide precursor with an aldehyde, ketone or ester to form an olefin and a phosphine oxide which re-enters the catalytic cycle.

Though these results were an advance they represent the start of the process to develop a robust user-friendly olefination methodology. Indeed, the reactions described in the above mentioned works were performed at high temperature (100° C.) and were not kinetically highly diastereoselective. The observed high E-selectivity relied on a phosphine mediated post olefination isomerization event. The actual kinetic selectivity ranged from 2:1 to 3:1, E:Z. Furthermore, the protocol was reliant on the use of a cyclic phosphine oxide. Ideally a catalytic Wittig process performed at room temperature and/or utilizing readily available acyclic trialkyl or triaryl phosphine oxides would offer greater synthetic flexibility and aid wider adoption of the methodology. Yet, both of these enhancements hinge on the key problem of selective reduction of the phosphine oxide in the presence of other reactive functionalities. The employment of silane yielded the answer in our previous work.

However, in our previous work, a temperature of 100° C. was required to achieve a viable turnover rate of the phosphine oxide/phosphine required for adoption in a catalytic process. Consequently, in order to decrease the reaction temperature, an increase in the reactivity of the phosphine oxide (toward reduction) is desired.

Furthermore, the next challenge in the development of the CWR is to expand the methodology to semi-stabilized and non-stabilized ylides. Fundamentally, the key barrier to the utilization of these ylide classes in the CWR is selective deprotonation of the phosphonium salt requisite for ylide generation. The success of this critical deprotonation hinges on the choice of base, which must be of sufficient power to remove the ylide-forming proton of the phosphonium salt (pKₐ (DMSO) 17-18 for semi-stabilized, 22-25 for non-stabilized), yet mild enough to be compatible with the wider CWR. An additional challenge for non-stabilized ylides will be to ensure a viable rate of phosphonium salt formation.

### SUMMARY OF THE INVENTION

In a first aspect, the present invention provides a method to increase the rate of reduction of phosphine oxide that is amenable for the inclusion in catalytic methodology for example the catalytic Wittig reaction. The reduction is achieved by inclusion of an acid additive. In a preferred embodiment the acid additive is a protic acid. In a more preferred embodiment, the acid additive is a carboxylic acid.

The present invention further provides a method for performing a catalytic Wittig reaction with a higher rate of phosphine oxide reduction comprising the step of adding an acid additive. In a preferred embodiment the acid additive is a carboxylic acid.

In one embodiment the present invention provides a method for increasing the rate of phosphine oxide reduction comprising the use of an acid additive; suitably the acid additive is a carboxylic acid. Preferably the acid additive is an aryl carboxylic acid.

In some embodiments the rate of reduction of the phosphine oxide is higher with an aryl carboxylic acid with a lower pKa; for example an aryl carboxylic acid with a pKa of less than 5 in water; preferably an aryl carboxylic acid with a pKa of less than 4 in water.

In some embodiments the phosphine oxide reduction is performed during a synthesis involving a carbon-carbon double bond. In other embodiments the phosphine oxide reduction is performed during a catalytic Wittig reaction.

In some embodiments the phosphine oxide is a cyclic phosphine oxide and the method is performed at room temperature.

In other embodiments the phosphine oxide is an acyclic phosphine oxide and the method is performed at a temperature higher than 80° C.

Advantageously, the method of the invention achieves high diastereocontrol. For example, the method of the invention provides an olefin product with an E:Z ratio in the range of from about 60:40 to about >99:1; preferably the E:Z ratio is >80:20; more preferably the E:Z ratio is >90:10; even more preferably the E:Z ratio is >95:5.

The method of the invention also provides a method for performing a one-pot catalytic Wittig reaction with a higher rate of phosphine oxide reduction comprising the step of adding an acid additive. Suitably, the acid additive is a carboxylic acid. Preferably, the acid additive is a carboxylic acid.

In some embodiments the invention provides a method for performing a one-pot catalytic Wittig reaction wherein the rate of reduction of the phosphine oxide is higher with an aryl carboxylic acid with a lower pKa. Suitably the phosphine oxide is a cyclic phosphine oxide and the method is performed at room temperature. Alternatively, the phosphine oxide is an acyclic phosphine oxide and the method is performed at a temperature higher than 80° C.

In a first aspect, the present invention provides a method for increasing the rate of phosphine oxide reduction during a one-pot catalytic Wittig reaction, comprising the use of an acid additive, wherein the acid additive is an aryl carboxylic acid.

The present invention also provides a method for performing a catalytic Wittig reaction comprising the steps of:
(i) providing a phosphine oxide precatalyst;
(ii) reducing the phosphine oxide precatalyst to produce a phosphine, using an organosilane, in the presence of an acid additive component, wherein the acid additive component is an aryl carboxylic acid;
(iii) forming a phosphonium ylide precursor by reacting the phosphine with a primary or secondary organohalide;
(iv) generating a phosphonium ylide from the phosphonium ylide precursor; and
   reacting the phosphonium ylide with a carbonyl containing compound for example an aldehyde, ketone or ester to form an olefin and a phosphine oxide which re-enters the catalytic cycle; wherein the olefin formed comprises the carbon which formed the carbonyl group of the carbonyl containing compound.

In one embodiment the phosphine oxide is a cyclic phosphine oxide and the method is performed at room temperature. In another embodiment, the phosphine oxide is an acyclic phosphine oxide and the method is performed at a temperature higher than 80° C.

In some embodiments the phosphine oxide has the formula:

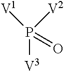

wherein V¹, V², and V³ are independently selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic; or together at least 2 of V¹, V² and V³ together form a ring system, comprising from 2 C atoms to 20 C atoms;
wherein any of V¹, V² and V³; or said ring system;
are unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

Preferably, the halo C₁-C₆ alkyl group is selected from the group consisting of: —CF₃, —CHF₂, —CH₂F and —CF₂CF₃.

In some embodiments the phosphine oxide has the formula:

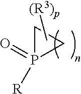

wherein n is 1 to 4; p is 0 to 10;

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

Preferably, the halo C₁-C₆ alkyl group is selected from the group consisting of: —CF₃, —CHF₂, —CH₂F and —CF₂CF₃.

In some embodiments the phosphine oxide has the formula:

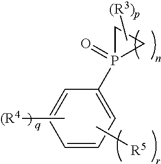

wherein n is 1 to 4; p is 0 to 14; q is 0 to 5; r is 1 to 5;

R³ is selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R⁴ is selected from the group consisting of selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R⁴ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R⁵ is selected from the group consisting of selected from the group consisting of hydrogen, halogen, nitro, nitroso, halogen, cyano, —C(O)O—C₁-C₆ alkyl, a C₁-C₆ sulfone, a C₁-C₆ sulfoxide, a C₁-C₆ primary amide, a C₁-C₆ secondary amide, a C₁-C₁₂ aliphatic, a C₃-C₁₀ cycloaliphatic, a C₂-C₁₀ aliphatic heterocycle, a C₆-C₂₀ aromatic and a C₂-C₂₀ heteroaromatic;

wherein any R⁵ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

In other embodiments phosphine oxide has the formula:

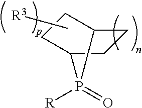

wherein n is 1 to 4; p is 0 to 14;

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R³ is selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

In some embodiments the phosphine oxide has the formula:

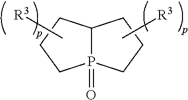

p is 0 to 4;

R³ is selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

In some embodiments the phosphine oxide is selected from the group consisting of:

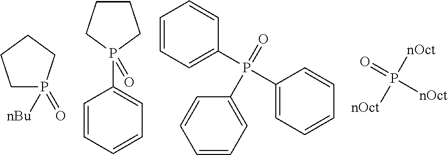

In the first aspect of the invention the acid additive has the formula:

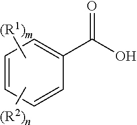

wherein m is from 1 to 5; n is 0-5; and m plus n≦5;

R¹ is an electron withdrawing group, selected from the group consisting of nitro, nitroso, fluoro, difluoromethyl, trifluoromethyl, cyano, a C₁-C₆ sulfone, a C₁-C₆ sulfoxide, a C₁-C₆ primary amide, a C₁-C₆ secondary amide; and

R² is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic; wherein R¹ can be unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ ester, a C₁-C₆ ketone, a C₁-C₆ ketimine, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group.

Preferably, the halo C₁-C₆ alkyl group is selected from the group consisting of: —CF₃, —CHF₂, —CH₂F and —CF₂CF₃.

In some embodiments the acid additive is a nitrobenzoic acid; for example the additive component can be selected from the group consisting of o-nitrobenzoic acid, m-nitrobenzoic acid, and p-nitrobenzoic acid; preferably the additive component is p-nitrobenzoic acid.

In other embodiments the acid additive is trifluoromethyl benzoic acid, a bis(trifluoromethyl)benzoic acid, or a tris(trifluoromethyl)benzoic acid; for example the additive component can be selected from the group consisting of o-trifluorobenzoic acid, m-trifluorobenzoic acid, p-trifluorobenzoic acid, 2,4-bis(trifluoromethyl)benzoic acid, and 2,4,6-tris(trifluoromethyl)benzoic acid.

In some embodiments the phosphine oxide is selected from the group consisting of:

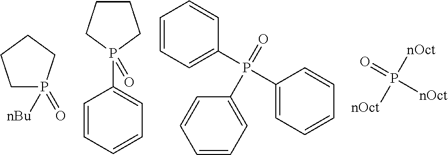

and the acid additive is a nitrobenzoic acid selected from the group consisting of: o-nitrobenzoic acid, m-nitrobenzoic acid, and p-nitrobenzoic acid.

Advantageously, the method of the invention enables the reduction of cyclic phosphine oxides to phosphines at room temperature and enables the reduction of acyclic phosphine oxides to phosphines to occur at elevated temperature, which was not heretofore possible. Furthermore, good E/Z selectivities are obtained, typically >70:30, and oftentimes as high as >95:5. This represents a marked improvement over selectivities reported previously in the catalytic Wittig reaction; particularly in view of the fact that these selectivities are achieved without phosphine mediated isomerisation.

In a second aspect, the present invention provides a method for performing a catalytic Wittig reaction comprising the steps of:
(i) providing a phosphine oxide precatalyst;
(ii) reducing the phosphine oxide precatalyst to produce a phosphine;
(iii) forming a semi-stabilised or non-stabilised phosphonium ylide precursor by reacting the phosphine with a primary or secondary organohalide;
(iv) generating a semi-stabilised or non-stabilised phosphonium ylide from the semi-stabilised or non-stabilised phosphonium ylide precursor; and
(v) reacting the semi-stabilised or non-stabilised phosphonium ylide with a carbonyl containing compound; for example an aldehyde, a ketone or an ester;
   to form an olefin and a phosphine oxide which re-enters the catalytic cycle.

In some embodiments the phosphine oxide has the formula:

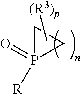

wherein n is 1 to 4; p is 0 to 10;

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

Preferably, the halo C₁-C₆ alkyl group is selected from the group consisting of: —CF₃, —CHF₂, —CH₂F and —CF₂CF₃.

In some embodiments the acid the phosphine oxide precatalyst has the formula:

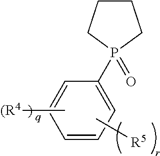

wherein q is 0 to 5; r is 1 to 5;

R⁴ is selected from the group consisting of selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R⁴ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R⁵ is selected from the group consisting of selected from the group consisting of hydrogen, halogen, nitro, nitroso, halogen, cyano, —C(O)O—C₁-C₆ alkyl, a C₁-C₆ sulfone, a C₁-C₆ sulfoxide, a C₁-C₆ primary amide, a C₁-C₆ secondary amide, a C₁-C₁₂ aliphatic, a C₃-C₁₀ cycloaliphatic, a C₂-C₁₀ aliphatic heterocycle, a C₆-C₂₀ aromatic and a C₂-C₂₀ heteroaromatic;

wherein any R⁵ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

Preferably, the halo C₁-C₆ alkyl group is selected from the group consisting of: —CF₃, —CHF₂, —CH₂F and —CF₂CF₃.

In some embodiments the phosphine oxide has the formula:

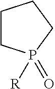

wherein R is C₁-C₁₂ aliphatic; for example R can be C₁-C₁₂ alkyl; preferably R is selected from the group consisting of methyl, ethyl, propyl, iso-propyl, butyl, sec-butyl, tert-butyl, pentyl, hexyl, heptyl, octyl, nonyl and decyl

In some embodiments the phosphine oxide is selected from the group consisting of:

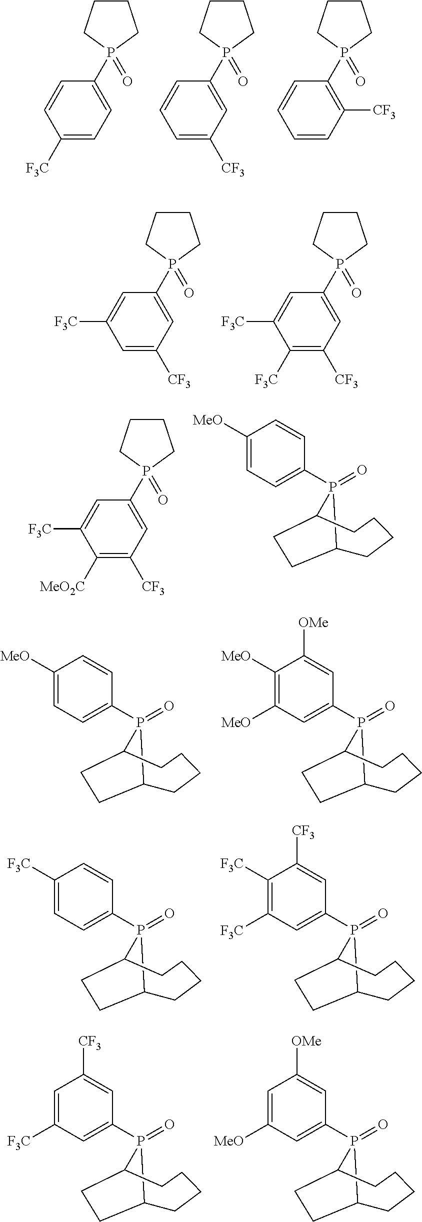

In some embodiments of the second aspect of the invention the semi-stabilised or non-stabilised phosphonium ylid is formed by deprotonation of the semi-stabilised or non-stabilised phosphonium ylid precursor using a masked carbonate base which decomposes to produce an alkoxide base, for example sodium tert-butyl carbonate or potassium tert-butyl carbonate.

In both the first aspect and the second aspect of the invention the phosphine oxide is reduced using an organosilane reducing agent.

Preferably, the olefin formed from the method of the first aspect of the invention or the method of the second aspect of the invention is formed with an E/Z selectivity of >60:40, preferably with an E/Z selectivity of >80:20, more preferably with an E/Z selectivity of >95:5.

In yet a still further third aspect, the present invention provides compounds having the formula:

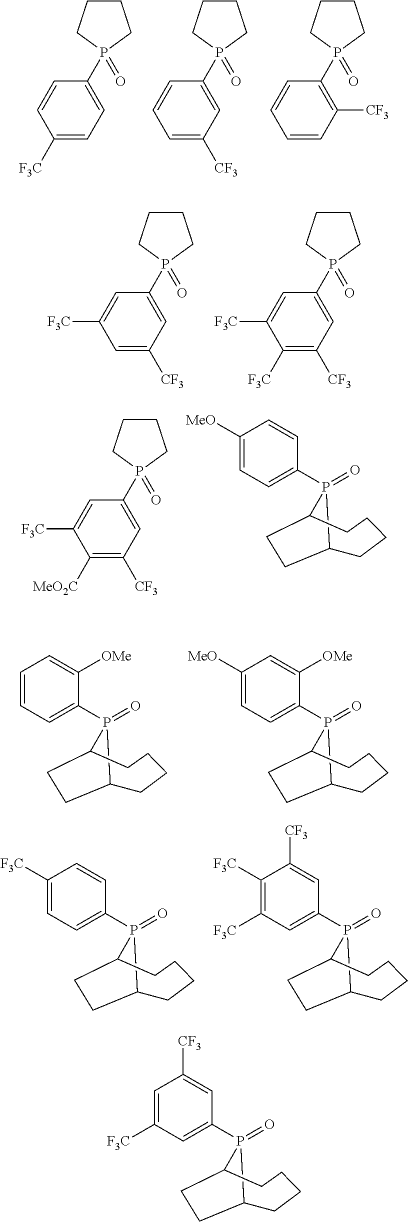

Advantageously, the second aspect of the invention enables the formation of olefins from semi-stabilised and non-stabilised phosphonium ylides, in a one-pot catalytic Wittig reaction.

Advantageously, the above compounds can be used in the method of both the first aspect and second aspect of the invention.

Advantageously, both the first and second aspects of the invention involve the use of sub-stoichiometric quantities of phosphine oxide.

In one aspect, the present invention provides a method for performing a catalytic Wittig reaction comprising the steps of:
(i) providing a phosphine oxide precatalyst;
(ii) reducing the phosphine oxide precatalyst to produce a phosphine;
(iii) forming a phosphonium ylide precursor by reacting the phosphine with a primary or secondary organohalide;
(iv) generating a phosphonium ylide from the phosphonium ylide precursor; and
(v) reacting the phosphonium ylide with a carbonyl containing compound to form an olefin and a phosphine oxide which re-enters the catalytic cycle.

In one aspect, the present invention provides a method for performing a catalytic Wittig reaction comprising the steps of:
(i) providing a phosphine oxide precatalyst;
(ii) reducing the phosphine oxide precatalyst to produce a phosphine;
(iii) forming a phosphonium ylide precursor by reacting the phosphine with a primary or secondary organohalide;
(iv) generating a phosphonium ylide from the phosphonium ylide precursor; and
(v) reacting the phosphonium ylide with a carbonyl containing compound for example an aldehyde, ketone or ester to form an olefin and a phosphine oxide which re-enters the catalytic cycle.

In yet another aspect, the present invention provides a method for performing a catalytic Wittig reaction comprising the steps of:
(i) providing a phosphine oxide precatalyst;
(ii) reducing the phosphine oxide precatalyst to produce a phosphine;
(iii) forming a phosphonium ylide precursor by reacting the phosphine with a primary or secondary organohalide;
(iv) generating a phosphonium ylide from the phosphonium ylide precursor; and
(v) reacting the phosphonium ylide with a carbonyl containing compound for example an aldehyde, ketone or ester to form an olefin and a phosphine oxide which re-enters the catalytic cycle; wherein the olefin formed comprises the carbon which formed the carbonyl group of the carbonyl containing compound.

Suitably, the phosphine oxide precatalyst has the formula:

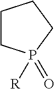

Preferably, R is C₁-C₁₂ aliphatic; for example R can be C₁-C₁₂ alkyl. More preferably R is selected from the group consisting of methyl, ethyl, propyl, iso-propyl, butyl, sec-butyl, tert-butyl, pentyl, hexyl, heptyl, octyl, nonyl and decyl.

In some embodiments the phosphine oxide precatalyst has the formula:

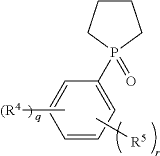

In some embodiments R⁴ is CF₃. In other embodiments R⁵ is CF₃. In other embodiments at least one of R⁴ is CF₃. In other embodiments at least one of R⁵ is CF₃. In other embodiments at least one, or both of R⁴ and R⁵ are CF₃. In still further embodiments at least one of R⁵ is a —C(O)O—C₁-C₆ alkyl group.

In still further embodiments the phosphine oxide precatalyst has the formula:

In yet another embodiment the phosphine oxide precatalyst has the formula:

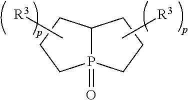

p is 0 to 4;

R³ is selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

Suitably, the phosphine oxide precatalyst is selected from the group consisting of:

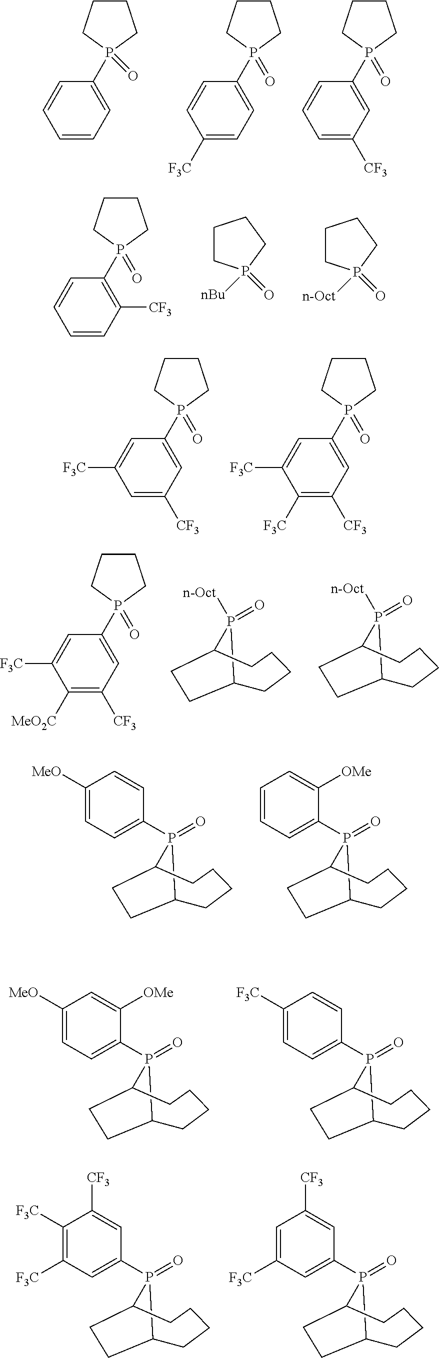

In another embodiment the phosphine oxide precatalyst is reduced using an organosilane.

Suitably, the organosilane has the formula:

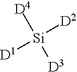

wherein D1 is hydrogen;

D², D³ and D⁴ are the same or different and are independently selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any of D², D³ and D⁴ can be unsubstituted or substituted with a C₁-C₆ alkyl, or a C₁-C₆ alkoxy.

Suitably, the organosilane is selected from the group consisting of phenylsilane, trifluoromethylphenyl silane, methoxyphenylsilane, diphenylsilane, trimethoxysilane and poly(methylhydrosiloxane). Preferably, the organosilane is selected from the group consisting of phenylsilane, 4-trifluoromethylphenyl silane, 4-methoxyphenylsilane and trimethoxysilane.

In yet another aspect, the present invention provides a method for performing a catalytic Wittig reaction comprising the steps of:
(i) providing a phosphine oxide precatalyst;
(ii) reducing the phosphine oxide precatalyst to produce a phosphine, using an organosilane, in the presence of an additive component;
(iii) forming a phosphonium ylide precursor by reacting the phosphine with a primary or secondary organohalide;
(iv) generating a phosphonium ylide from the phosphonium ylide precursor; and
   reacting the phosphonium ylide with a carbonyl containing compound for example an aldehyde, ketone or ester to form an olefin and a phosphine oxide which re-enters the catalytic cycle; wherein the olefin formed comprises the carbon which formed the carbonyl group of the carbonyl containing compound.

In yet a further embodiment the additive component is an aryl carboxylic acid having the formula:

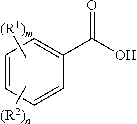

wherein m is from 1 to 5; n is 0-5; and m plus n≦5;

R¹ is an electron withdrawing group, selected from the group consisting of nitro, nitroso, fluoro, difluoromethyl, trifluoromethyl, cyano, a C₁-C₆ sulfone, a C₁-C₆ sulfoxide, a C₁-C₆ primary amide, a C₁-C₆ secondary amide; and

R² is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic; wherein R¹ can be unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ ester, a C₁-C₆ ketone, a C₁-C₆ ketimine, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group.

In one embodiment the additive component is a nitrobenzoic acid; for example the additive component can be selected from the group consisting of o-nitrobenzoic acid, m-nitrobenzoic acid, and p-nitrobenzoic acid; preferably the additive component is p-nitrobenzoic acid.

In another embodiment the additive component is a trifluoromethyl benzoic acid, a bis(trifluoromethyl)benzoic acid, or a tris(trifluoromethyl)benzoic acid; for example the additive component can be selected from the group consisting of o-trifluorobenzoic acid, m-trifluorobenzoic acid, p-trifluorobenzoic acid, 2,4-bis(trifluoromethyl)benzoic acid, and 2,4,6-tris(trifluoromethyl)benzoic acid.

In another aspect the present invention provides a method for performing a catalytic Wittig reaction comprises the steps of:
(i) providing a phosphine oxide precatalyst;
(ii) reducing the phosphine oxide precatalyst to produce a phosphine in the presence of an additive component;
(iii) forming a phosphonium ylide precursor by reacting the phosphine with a primary or secondary organohalide;
(iv) generating a phosphonium ylide from the phosphonium ylide precursor; and
(v) reacting the phosphonium ylide with a an aldehyde, ketone or ester to form an olefin and a phosphine oxide which re-enters the catalytic cycle.

In another aspect, the present invention provides a method for performing a catalytic Wittig reaction comprising the steps of:
(i) providing a phosphine oxide precatalyst;
(ii) reducing the phosphine oxide precatalyst with an organosilane to produce a phosphine in the presence of an additive component;
(iii) forming a phosphonium ylide precursor by reacting the phosphine with a primary or secondary organohalide;
(iv) generating a phosphonium ylide from the phosphonium ylide precursor; and
(v) reacting the phosphonium ylide with an aldehyde, ketone or ester to form an olefin and a phosphine oxide which re-enters the catalytic cycle.

In another aspect the present invention provides a method for performing a catalytic Wittig reaction comprises the steps of:
(i) providing a phosphine;
(ii) forming a phosphonium ylide precursor by reacting the phosphine with a primary or secondary organohalide;
(iii) generating a phosphonium ylide from the phosphonium ylide precursor;
(iv) reacting the phosphonium ylide with a carbonyl containing compound selected from the group consisting of an aldehyde, ketone or ester to form an olefin and a phosphine oxide; wherein the olefin formed comprises the carbon which formed the carbonyl group of the carbonyl containing compound; and
(v) reducing the phosphine oxide to produce a phosphine, using an organosilane, in the presence of an acid additive component, wherein the acid additive component is an aryl carboxylic acid; and the phosphine re-enters the catalytic cycle.

In one embodiment, the phosphine oxide is present in sub-stoichiometric quantities, preferably in an amount of from about 0.001 mol % to about 50 mol %, for example from an amount within the range of from 0.01 mol % to about 25 mol %; preferably from an amount within the range of from about 0.5 mol % to about 20 mol %; more preferably from an amount within the range of from 4 mol % to about 20 mol %.

Another aspect of the invention provides compounds having the formula

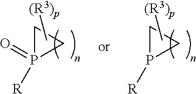

wherein n is 1 to 4; p is 0 to 10;

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

The compounds of the invention can have the formula:

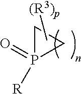

wherein n is 3 or 4; p is 0 to 10;

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein when p is 0 and n is 3; R=methyl, ethyl, propyl, butyl, phenyl are excluded.

The compounds of the invention can have the formula:

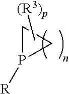

wherein n is 3 or 4; p is 0 to 10;

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;

R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;

wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein when p is 0 and n is 3; R=methyl, ethyl, propyl, butyl, phenyl, tolyl and mesityl are excluded.

For example R can be selected from the group consisting of:

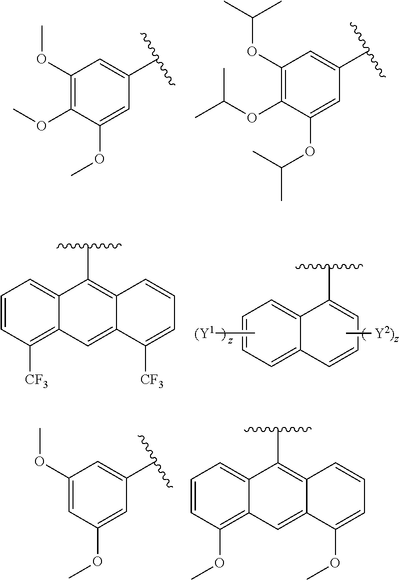

wherein z is 0 to 4;
Y¹ and Y² are the same or different and are independently selected from the group consisting of hydrogen, a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

The compounds of the invention can have the formula:

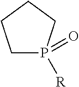

wherein R is selected from the group consisting of C₅-C₂₀ alkyl, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein R is not phenyl.

The compounds of the invention can have the formula:

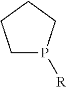

wherein R is selected from the group consisting of C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein R is not phenyl, tolyl or mesityl.

A compound having the formula selected from the group consisting of:

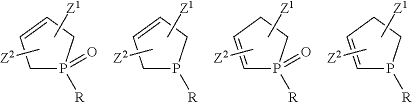

wherein Z¹ and Z² are independently selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic; or together Z¹ and Z² form a ring system, comprising from 2 C atoms to 20 C atoms;
wherein any of Z¹, Z² or said ring system;
are unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein R is not methyl, ethyl, propyl, butyl, phenyl, tolyl or mesityl.

For example R can be selected from the group consisting of:

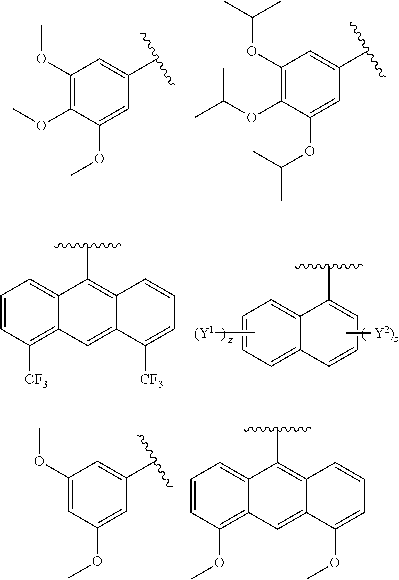

wherein z is 0 to 4;
Y¹ and Y² are the same or different and are independently selected from the group consisting of hydrogen, a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl.

The compounds can also have the formula selected from the group consisting of:

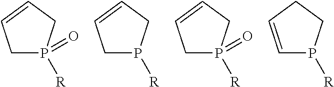

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein R is not methyl, ethyl, propyl, butyl, phenyl, tolyl or mesityl.

The compounds can also have the formula:

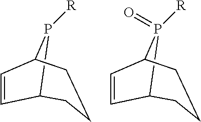

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein, R is not methyl, ethyl, or phenyl.

The compounds can have the formula

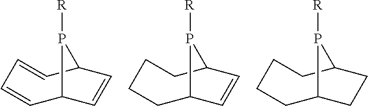

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein, R is not methyl, ethyl, or phenyl.

The compounds can have the formula

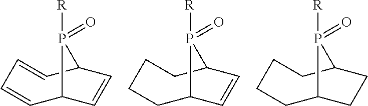

R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl;
wherein, R is not methyl, ethyl, isopropyl or phenyl.

The present invention also provides a method for performing a catalytic Wittig reaction comprising the use of a compound as described above.

The present invention also provides a method for performing a catalytic Wittig reaction comprising the use of a compound as claimed in the invention.

As used herein, the term “Cₓ-C_{y} alkyl” embraces Cₓ-C_{y} unbranched alkyl, Cₓ-C_{y} unbranched alkyl and combinations thereof.

As used herein, the term “Cₓ-C_{y} aliphatic” refers to linear, branched, saturated and unsaturated hydrocarbon chains comprising Cₓ-C_{y} carbon atoms (and includes Cₓ-C_{y} alkyl, Cₓ-C_{y} alkenyl and Cₓ-C_{y} alkynyl.

As used herein, the term Cₓ-C_{y} cycloaliphatic refers to unfused, fused, spirocyclic, polycyclic, saturated and unsaturated hydrocarbon rings comprising Cₓ-C_{y} carbon atoms (and includes Cₓ-C_{y} cycloalkyl, Cₓ-C_{y} cycloalyenyl and Cₓ-C_{y} cycloalkenyl). The carbon atoms of the hydrocarbon ring may optionally be replaced with at least one of O or S at least one or more times.

As used herein, the term aromatic refers to an aromatic carbocyclic structure in which the carbon atoms of the aromatic ring may optionally be substituted one or more times with at least one of a cyano group, a nitro group, a halogen, a C₁-C₁₀ ether, a C₁-C₁₀ thioether, a C₁-C₁₀ ester, C₁-C₁₀ ketone, C₁-C₁₀ ketimine, C₁-C₁₀ sulfone, C₁-C₁₀ sulfoxide, a C₁-C₁₀ primary amide or a C₁-C₂₀ secondary amide.

As used herein, the term heterocycle refers to cyclic compounds having as ring members atoms of at least two different elements.

As used herein, the term heteroaromatic refers to an aromatic heterocyclic structure having as ring members atoms of at least two different elements. The carbon atoms of the heteroaromatic ring may optionally be substituted one or more times with at least one of a cyano group, a nitro group, a halogen, a C₁-C₁₀ ether, a C₁-C₁₀ thioether, a C₁-C₁₀ ester, C₁-C₁₀ ketone, C₁-C₁₀ ketimine, C₁-C₁₀ sulfone, C₁-C₁₀ sulfoxide, a C₁-C₁₀ primary amide or a C₁-C₂₀ secondary amide.

As used herein Cₓ-C_{y}, for example C₁-C₁₂ includes the C₁, C₂, C₃, C₄, C₅, C₆, C₇, C₈, C₉, C₁₀, C₁₁ and C₁₂.

Where suitable, it will be appreciated that all optional and/or preferred features of one embodiment of the invention may be combined with optional and/or preferred features of another/other embodiment(s) of the invention.

### BRIEF DESCRIPTION OF THE DRAWINGS

Embodiments of the invention will be described, by way of example only, with reference to the accompanying drawings in which:

FIG. 1 illustrates the conditions for a carboxylic acid enhanced phosphine oxide reduction.

FIG. 2 FIG. 2 illustrates the results of carboxylic acid enhanced phosphine oxide reduction using various reactants and under various conditions (as further explained in FIG. 1).

FIG. 3 illustrates the conditions for optimization of the catalytic Wittig reaction with primary bromides.

FIG. 4 illustrates the results of optimization of the catalytic Wittig reaction with primary bromides using various reactants and under various conditions (as further explained in FIG. 3).

FIG. 5 illustrates the conditions for optimization of the catalytic Wittig reaction with secondary bromides.

FIG. 6 illustrates the results of optimization of the catalytic Wittig reaction with secondary bromides using various reactants and under various conditions (as further explained in FIG. 5).

FIG. 7 illustrates the scheme for and results of room temperature catalytic Wittig reactions using 1-(n-butyl)phospholane-1-oxide (phosphine oxide 2) as the catalyst.

FIG. 8 illustrates the scheme for and results of room temperature catalytic Wittig reactions employing trioctylphosphine oxide (phosphine oxide 3) as the catalyst.

FIG. 9 illustrates the scheme for and results of room temperature catalytic Wittig reactions employing the phosphine oxide 4 (triphenylphosphine oxide) as the catalyst.

FIG. 10 illustrates the traditional classification of ylides. For semi-stabilised ylides; when R2=aryl and said aryl group comprises an electron withdrawing group (EWG) substituent, such compounds behave in a manner similar to stabilised ylides. This type of ylide is not classified as a semi-stabilised ylid in the context of this application.

For example, ylides having the formula:

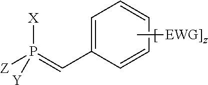

Wherein X, Y and Z are selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected, from the group consisting of hydrogen and C₁-C₆ alkyl; and
wherein the EWG is for example selected from the group consisting of at least one of —C(O)OR′, —C(O)NR′R′, —C(O)R, nitro, nitroso, halo C₁-C₆ alkyl, CF₃, CHF₂, —OC(O)NR′R′, R′ is independently selected, from the group consisting of hydrogen and C₁-C₆ alkyl;
are not considered semi-stabilised in the context of this application.

FIG. 11 shows the key concepts in the CWR for semi-stabilised and non-stabilised ylides.

FIG. 13 shows representative examples of precatalysts with utility in the method of the invention.

FIG. 14 illustrates the optimisation of reaction conditions for the method of the invention, wherein semi-stabilized ylides are generated in the CWR.

FIG. 15 illustrates representative examples of the method of the invention, wherein semi-stabilized ylides are generated in the CWR.

FIG. 16 illustrates the optimisation of the reaction conditions for the method of the invention, wherein non-stabilized ylides are generated in the CWR.

FIG. 17 illustrates representative examples of the method of the invention, wherein non-stabilized ylides are generated in the CWR.

FIG. 18 shows acid enhanced reduction of 1 at RT.

FIG. 19 shows the correlation between conversion and pKₐ for acid enhanced reduction of 1.

FIG. 20 shows a Hammett plot for acid enhanced reduction of 1.

FIG. 21 shows acid enhanced reduction of 3.

FIG. 22 shows the correlation between conversion and pKₐ for acid enhanced reduction of 3.

FIG. 23 shows a Hammett plot for acid enhanced reduction of 3.

FIG. 24 shows acid enhanced reduction of 4.

FIG. 25 shows the correlation between conversion and pKₐ for acid enhanced reduction of 4.

FIG. 26 shows a Hammett plot for acid enhanced reduction of 4.

FIG. 27 shows a room temperature solvent study.

FIG. 28 shows a solvent study for acyclic phosphine oxide 3.

FIG. 29 shows ³¹P nuclei observed during the CWR with a secondary bromide.

FIG. 30 shows a solvent study using A2

FIG. 31 shows phosphine oxide screening using ylide tuning.

FIG. 32 shows a solvent study using DIPEA.

FIG. 33 shows representative examples of CWR using ketone substrates.

### DETAILED DESCRIPTION

The present invention in the first aspect provides a method to increase the rate of reduction of phosphine oxide. In a preferred embodiment, the reduction of phosphine oxide is performed during a synthesis involving a carbon-carbon double bond. In a more preferred embodiment, the reduction of phosphine oxide is performed during a catalytic Wittig reaction. An increase in the rate of reduction of phosphine is achieved by inclusion of an acid additive. In a preferred embodiment the acid additive is a protic acid. In a more preferred embodiment, the acid additive is an aryl carboxylic acid. Accordingly, in one embodiment, the invention is a method for increased rate of reduction of phosphine oxide during a catalytic Wittig reaction.

Although the invention is described herein as applicable in particular to a catalytic Wittig reaction, other reactions to which this is potentially applicable are the Mitsunobu, Appel and Staudinger reactions.

Aryl carboxylic acids were examined as phosphine oxide reduction aids. In order to ease integration into the final catalytic Wittig reaction, reductions were performed in the presence of base (iPr₂NEt) and mimicked a theoretical 10 mol % catalyst loading based on the future aldehyde. Employing the same reasoning the silane would represent 1.4 equiv. This rationale led to the final conditions as depicted in FIG. 1 and as follows: phosphine oxide (0.1 mmol), 4-substituted benzoic acid (0.1 mmol), iPr₂NEt (1.4 mmol), silane (1.4 mmol), 0.3 M in requisite solvent. As used herein phosphine oxide 1 is 1-phenylphospholane-1-oxide; phosphine oxide 2 is 1-(n-butyl)phospholane-1-oxide; phosphine oxide 3 is trioctylphosphine oxide; and phosphine oxide 4 is triphenylphosphine oxide.

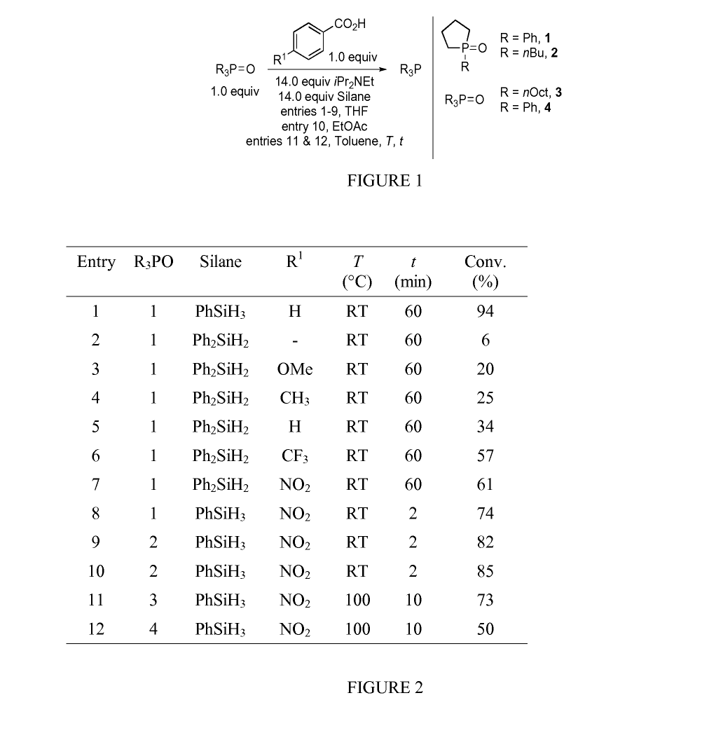

The results were striking and are shown FIG. 2. Addition of an equimolar amount of an aryl carboxylic acid notably enhanced phosphine oxide reduction. Indeed, the reduction of phosphine oxide 1 was almost complete in just 60 minutes at room temperature (see FIG. 2, entry 1). In these experiments, conversion was determined by ³¹P NMR spectral analysis, using triphenylphosphine oxide as a calibrant except for entry 12.

FIG. 2 illustrates the results of using aryl carboxylic acids varying in pKₐ. Diphenylsilane replaced phenylsilane because the lower reactivity of this silane would offer greater resolution in terms of reactivity differences between acids. The effect of the pKₐ of the acid was significant, 4-nitrobenzoic acid, which has the lowest pKₐ (˜3.4 in water, ˜9.1 in DMSO), yielded the greatest enhancement in reduction (FIG. 2, entries 3-7). A control reaction performed with no carboxylic acid additive yielded just 6% conversion (FIG. 2, entry 2). Moreover, reduction employing phenylsilane and 4-nitrobenzoic acid achieved a high conversion at room temperature in just 2 minutes (FIG. 2, entries 8-10). Though the rates observed for reduction of cyclic phosphine oxides 1 and 2 were impressive, and achieved at room temperature, a barrier remained for reduction of acyclic phosphine oxides. However, we observed that acyclic phosphine oxides 3 and 4 were reduced with reasonable yield in just 10 minutes at 100° C. (FIG. 2, entries 11 and 12). Further enhancement in reduction of triphenylphosphine oxide (phosphine oxide 4) was accomplished by substitution of phenylsilane with 4-(trifluoromethyl)phenylsilane, which yielded an increase from 50% to 81% yield (results not shown).

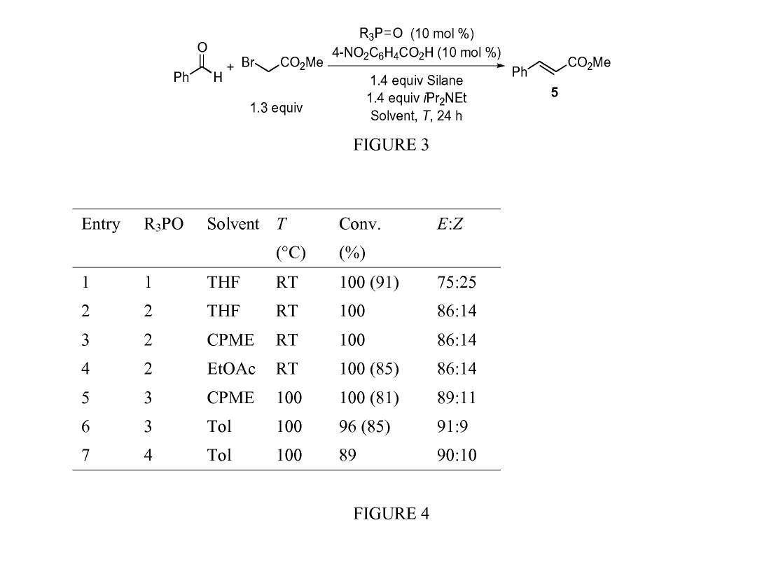

The use of the above disclosed method for increasing the reduction of phosphine oxides was used in catalytic Wittig reactions. FIG. 3 shows the basic reaction and conditions for the conversion of benzaldehyde into methyl cinnamate; further details are as follows benzaldehyde (1.0 mmol), organohalide (1.3 mmol), phosphine oxide (0.1 mmol), 4-nitrobenzoic acid (0.1 mmol), iPr₂NEt (1.4 mmol), silane (1.4 mmol; entries 1-6, phenylsilane; entry 7, 4-(trifluoromethyl)phenylsilane), 3.0 M in requisite solvent.

FIG. 4 illustrates the results. Conversion was determined from ¹H NMR spectroscopy and isolated yields are shown in parentheses. The E:Z ratio was determined by ¹H NMR spectroscopy of the unpurified reaction mixture. A repeat of entry 4 without acid additive gave a selectivity of 86:14, E:Z.

The acid enhanced reduction strategy was effectively adopted into the catalytic Wittig reaction resulting in a room temperature catalytic Wittig reaction with complete conversion of the aldehyde (FIG. 4, entries 1 and 2). To the best of our knowledge this is the first time a catalytic Wittig reaction has been achieved at room temperature.

Alkyl cyclic phosphine oxide (phosphine oxide 2) led to higher E-selectivity and was adopted from this point.

A brief solvent study was performed focused on green solvents that would offer the possibility of implementation in process scale applications. In this regard cyclopentyl methyl ether (CPME) and ethyl acetate (EtOAc) were effective solvents and worked equally well without distillation (FIG. 4, entries 3 and 4). Olefinations involving acyclic phosphine oxides also proceeded smoothly at 100° C. and with high conversions and yield (FIG. 4, entries 6 and 7). This is the first time an acyclic phosphine oxide has been utilized as a catalyst in the catalytic Wittig reaction and the use of phosphine oxides 3 and 4 resulted in high kinetic diastereocontrol.

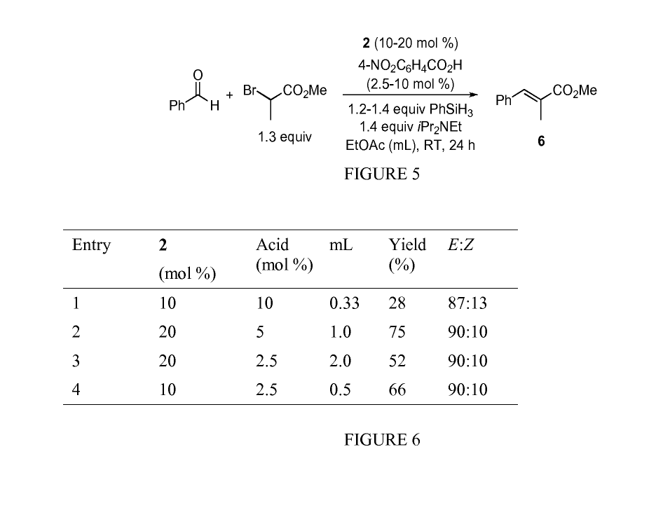

Next the room temperature catalytic Wittig reaction was successfully applied to the production of tri-substituted olefins, as methyl 2-methyl-3-phenylprop-2-enoate was synthesized in good yield at room temperature with slow addition of aldehyde (See FIGS. 5 and 6). Other conditions were as follows: benzaldehyde (1.0 mmol), organohalide (1.3 mmol), phosphine oxide (0.1-0.2 mmol), 4-nitrobenzoic acid (0.025-0.1 mmol), iPr₂NEt (1.4 mmol), phenylsilane (1.2-1.4 mmol), X mL EtOAc. The yield shown is the isolated yield. The E:Z ratio was determined by ¹H NMR spectroscopy of the unpurified reaction mixture. In entry 2 the aldehyde was added in 4 portions every 3 h. In entry 3, 17.5 mol % tetrabutylammonium tetrafluoroborate was added. For entry 4, the aldehyde was added in 10 portions every 1.5 h.

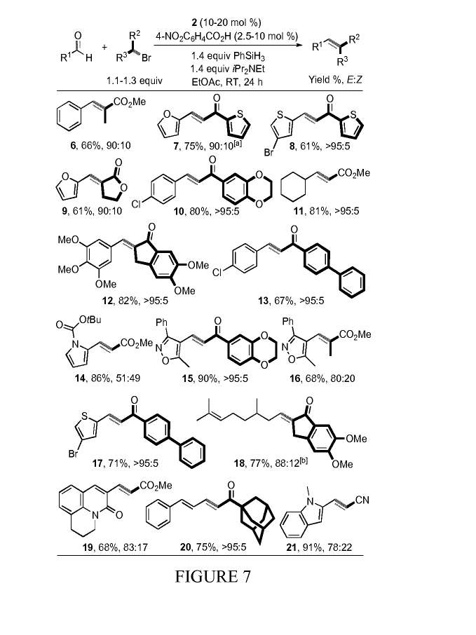

Following optimization of the cyclic phosphine oxide catalyzed room temperature catalytic Wittig reaction and acyclic phosphine oxide catalyzed high temperature catalytic Wittig reactions, substrate studies were performed (FIGS. 7-9). To the best of our knowledge this is the first time a catalytic Wittig reaction has been achieved with acyclic phosphine oxides.

FIG. 7 illustrates room temperature catalytic Wittig reactions. Phosphine oxide 2 was used as the catalyst. For each product the compound number, isolated yield, and E:Z ratio, determined by ¹H NMR spectroscopy of the unpurified reaction mixture, is given. The reactions were performed in duplicate. For compound 7 designated by [a], only the E-diastereomer was isolated. Compound 18 (designated by [b]), the yield was 72% (4.46 g, 88:12, E:Z) when performed on a 19.1 mmol scale.

Notable results were the synthesis of compounds 7, 8, 9, 14, 15, 16, 19, and 21 that demonstrate the employment of heterocyclic aldehydes and/or organobromides. 12 also has significance for its structural similarities to resveratrol and derivatives, which have anti-cancer properties, demonstrating the medicinal chemistry applications of this methodology. In all cases, except 14, good E-diastereoselectivity was achieved. The use of a 1,2-oxazole carboxaldehyde, producing 15 and 16 was noteworthy as these heterocycles are often employed in medicinal chemistry.

The mild nature of the protocol was demonstrated by the toleration of the tert-butyloxycarbonyl (BOC) protecting group yielding compound 14. Erosion of diastereoselectivity in this case most likely results from the BOC group stabilizing the formation of the cis-oxaphosphetane. The reasonable E-selectivity in the synthesis of 21 is interesting as the use of bromoacetonitrile led to poor selectivity (66:34, E:Z) in our previous protocol (references supplied above).

During the course of the room temperature substrate study various factors became apparent that would ensure acceptable yields. First, the reduction of the phosphine oxide to phosphine even at room temperature may not always be rate limiting. Indeed, for secondary organohalides the resting state of the catalyst was often found to be predominantly phosphine and not oxide. This points, in these cases, to the formation of the phosphonium salt or the actual Wittig reaction being rate limiting. Second, at room temperature the solubility of the phosphonium salt often became a factor. For example in the synthesis of 12 and 18, both a phase transfer catalyst (tetrabutylammonium tetrafluoroborate) and additional solvent were required to achieve optimal yields. During the standard room temperature catalytic Wittig reaction the generation of diisopropylethylammonium 4-nitrobenzoate is possible and may aid in solubilization of the phosphonium salt. Hence, the addition of 4-nitrobenzoic acid may produce a dual effect of both enhancing reduction of the phosphine oxide and aiding in the solubility of the produced phosphonium salt. Third, in the case of catalytic Wittig reactions where the reduction of the phosphine oxide was not rate limiting the amount of carboxylic acid additive should be decreased, or reduction of the aldehyde can occur.

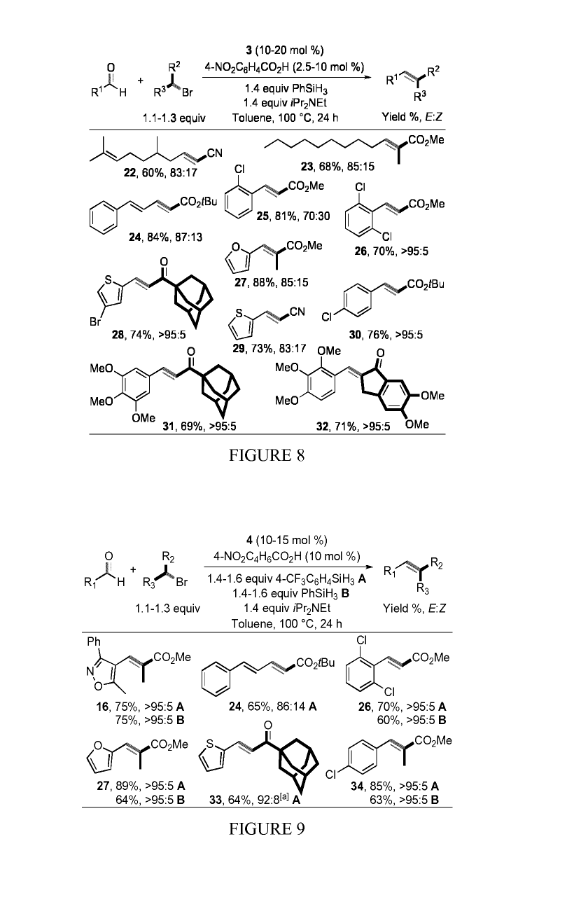

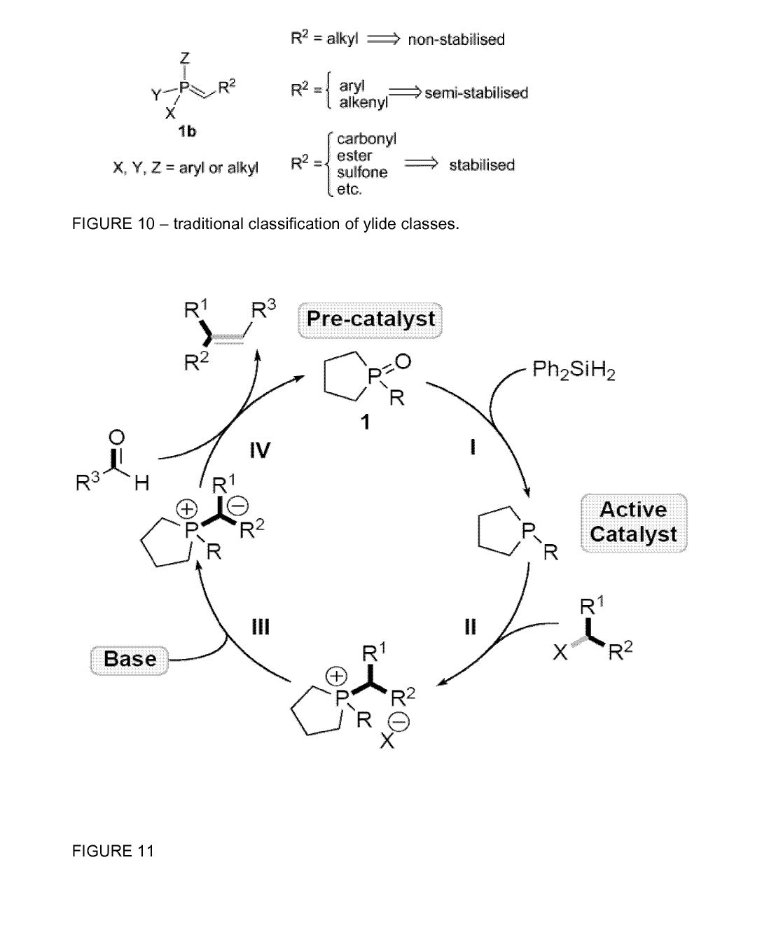

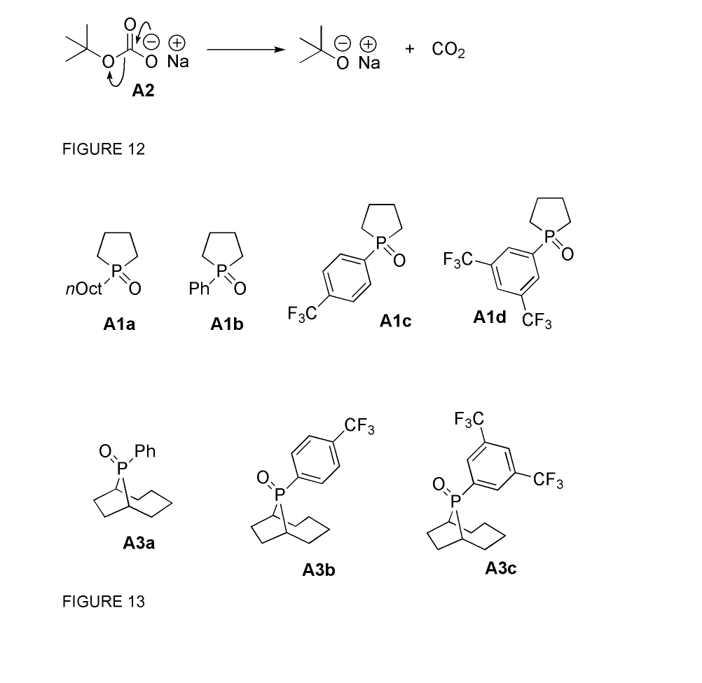

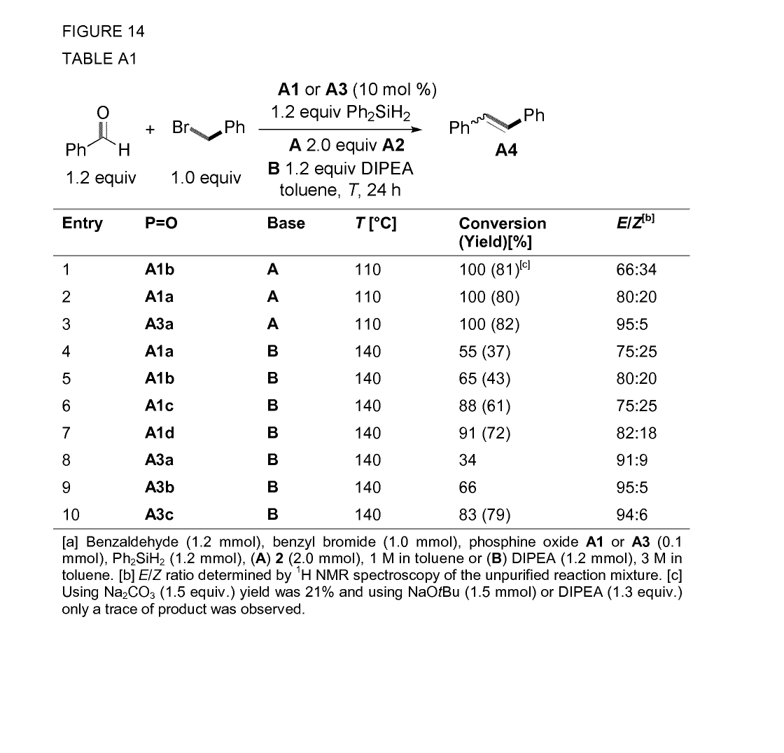

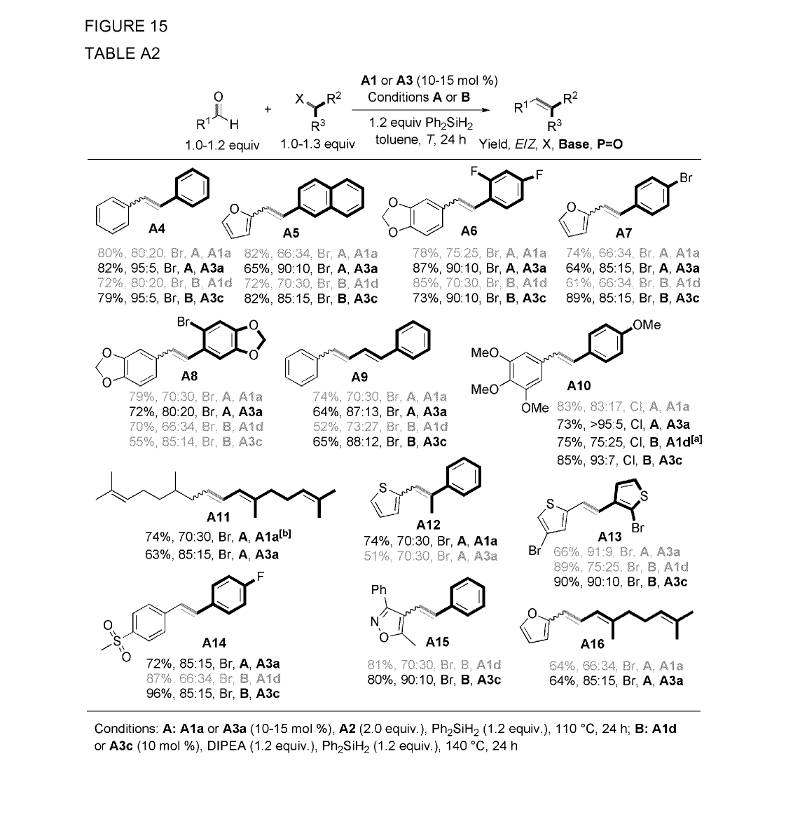

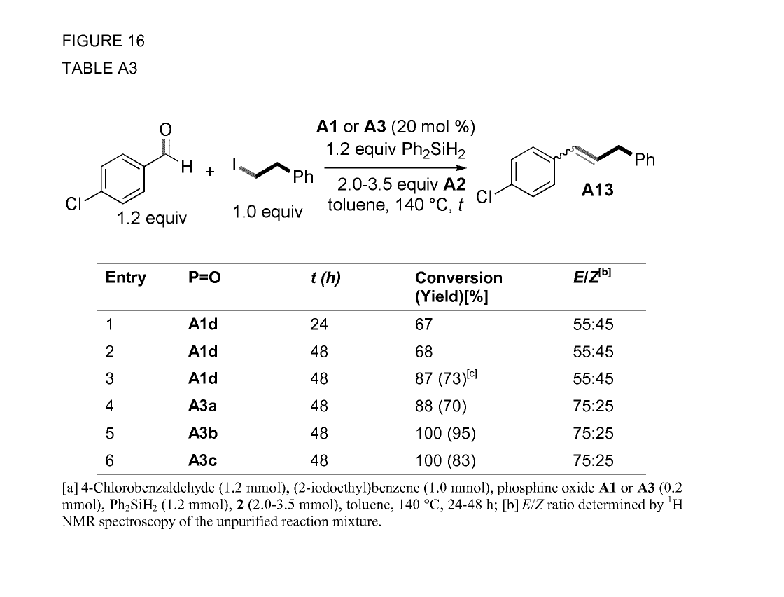

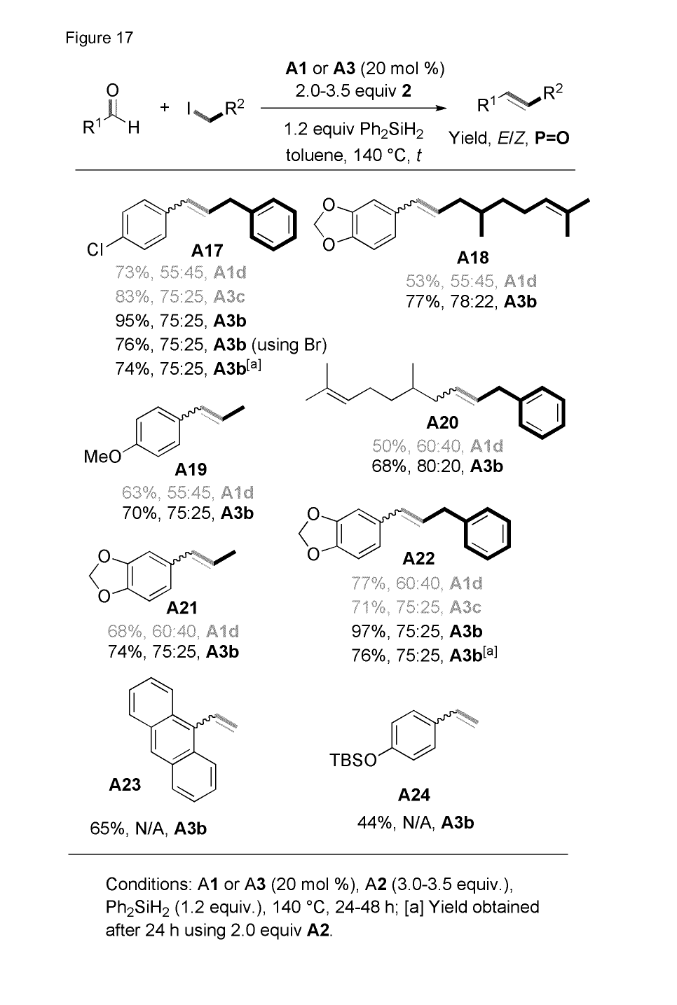

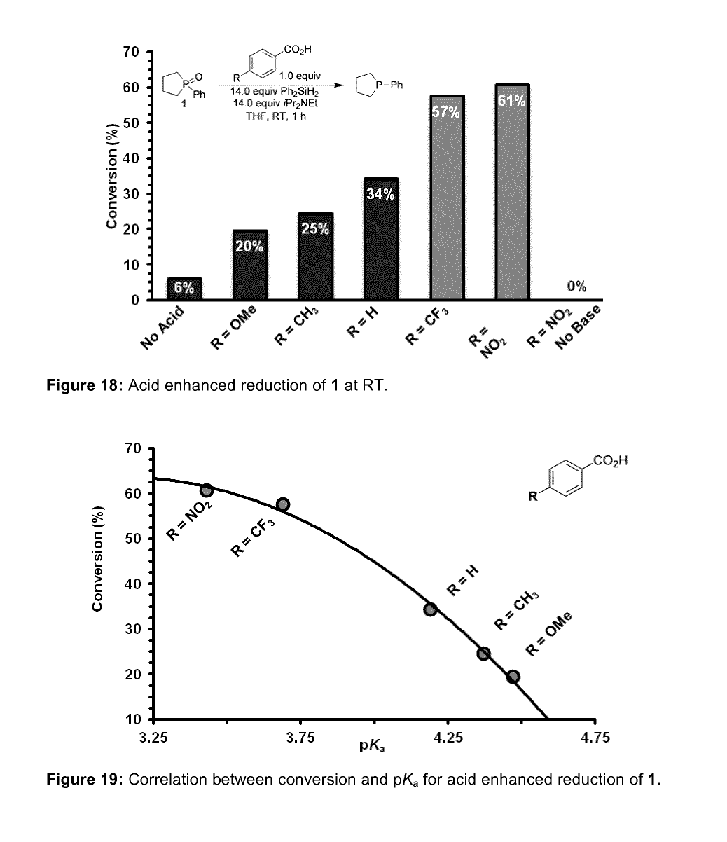

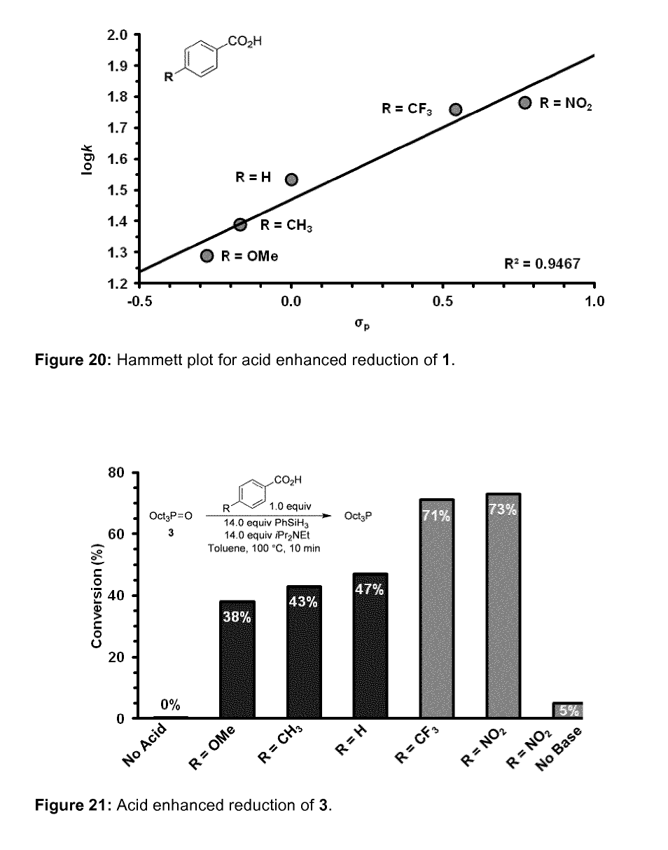

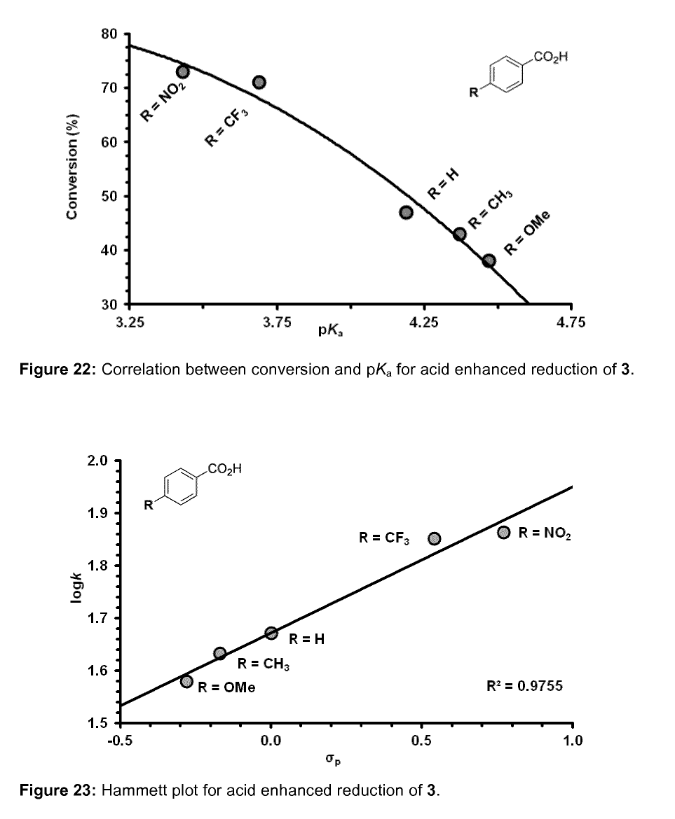

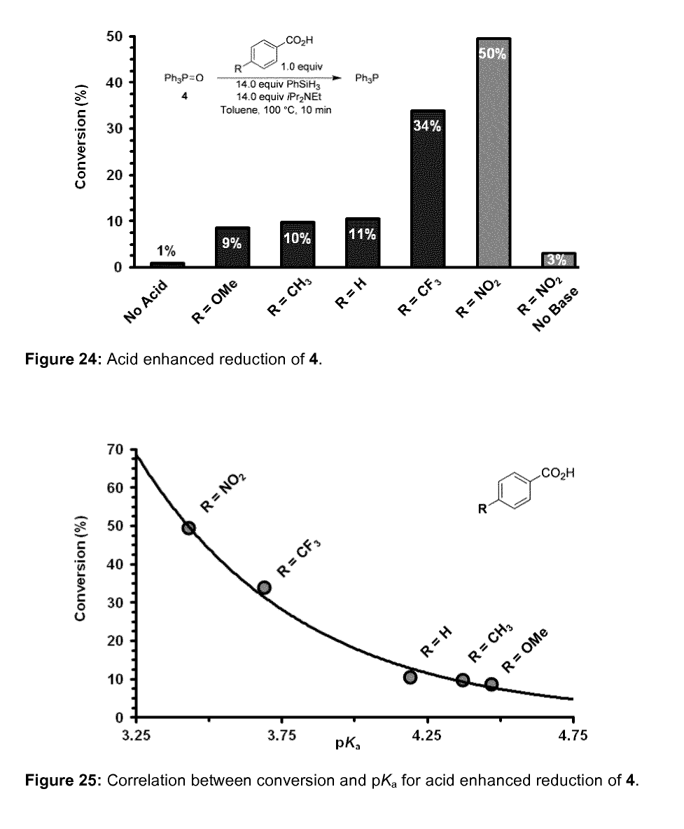

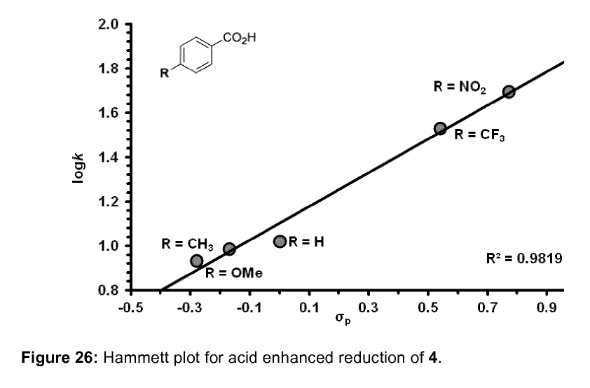

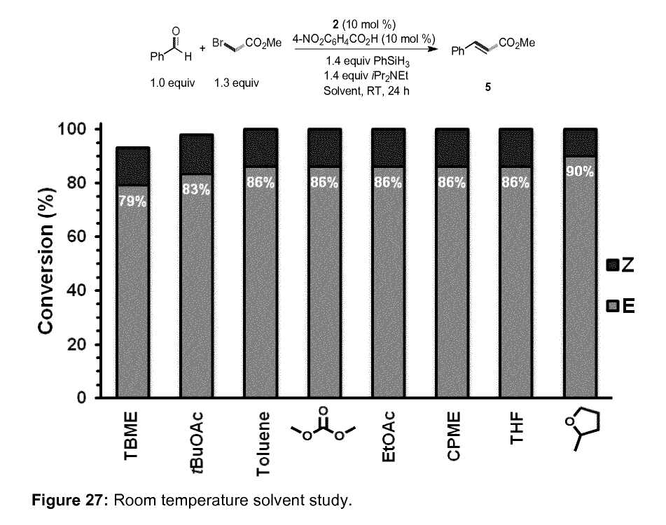

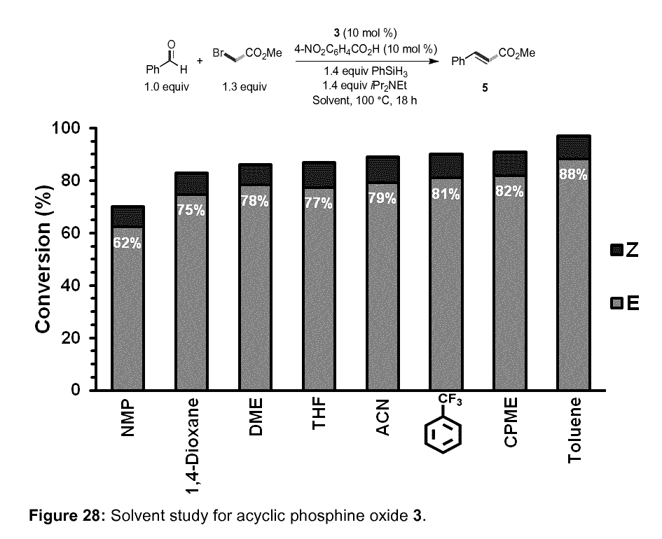

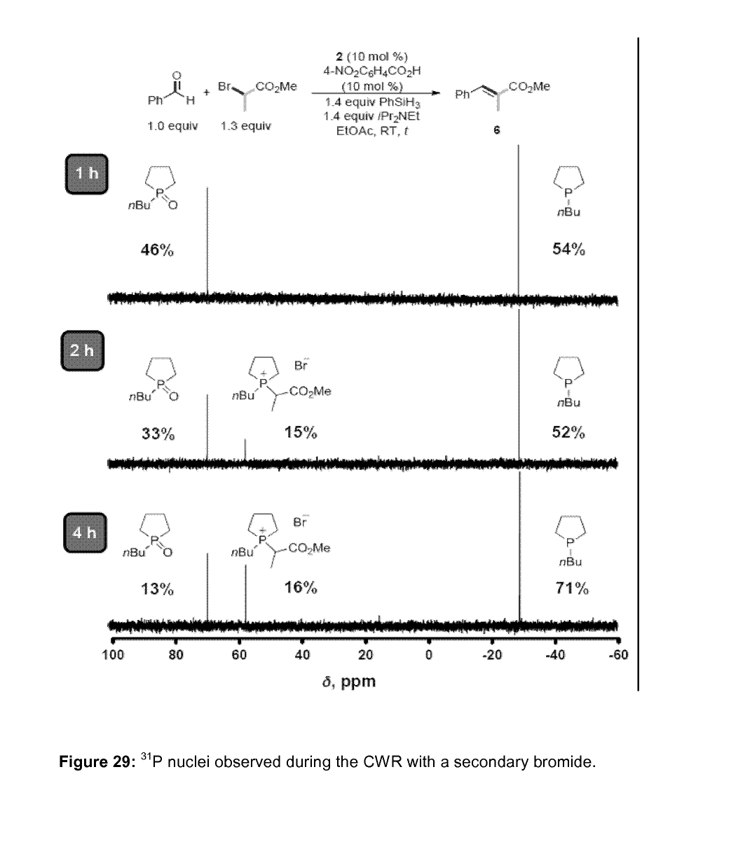

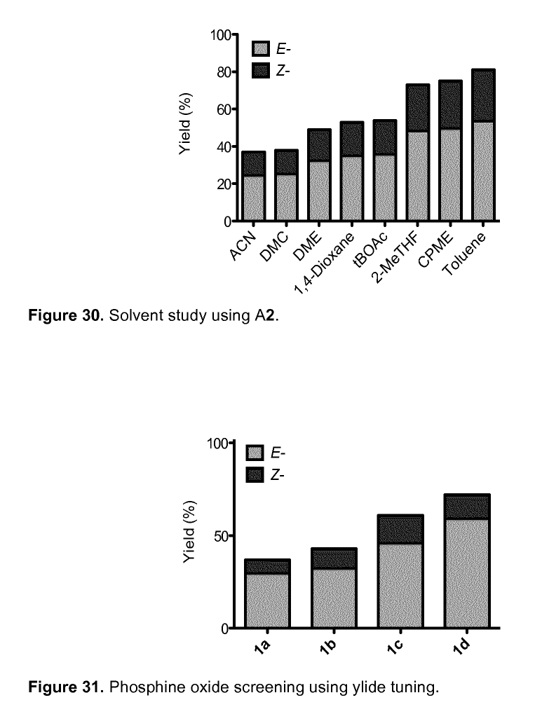

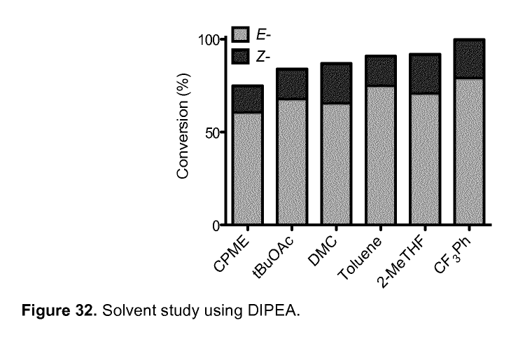

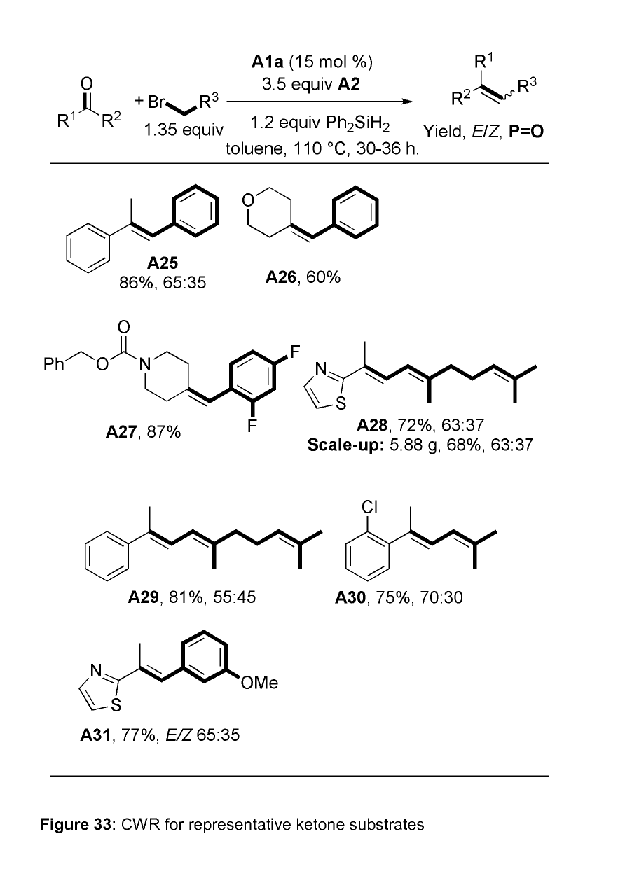

Similarly, the utilization of trioctylphosphine oxide (phosphine oxide)3 and triphenylphosphine oxide (phosphine oxide 4) was equally effective (FIGS. 8 and 9). For each product the compound number, isolated yield, and E:Z ratio, determined by ¹H NMR spectroscopy of the unpurified reaction mixture are given. The reactions were performed in duplicate. In FIG. 9, for compound 33 only the E-diastereomer was isolated.

These results again show that heterocyclic aldehydes were well tolerated. Noteworthy results involving catalysis by phosphine oxide 3 (FIG. 8) include the synthesis of 22, 27, 29, and 32. Again the use of bromoacetonitrile resulted in good selectivity as 22 and 29 were produced with a ratio of 83:17, E:Z. Significantly the synthesis of 22 in our previous protocol proceeded with a selectivity of 66:34, E:Z. When phosphine oxide 4 was employed as a catalyst with 4-(trifluoromethyl)phenylsilane the same generality was maintained in terms of aldehydes and organobromides (FIG. 9). Of note is that compound 27 was produced with total E-diastereoselectivity employing 4 whereas use of 3 produced small amounts of the Z-product (compare 27 in FIGS. 8 and 9). The results shown in FIGS. 7-9 taken as a whole bring a significant degree of synthetic flexibility to the catalytic Wittig reaction; reactions can be performed at room temperature with cyclic phosphine oxides or at higher temperature with acyclic phosphine oxides.

The employment of 2.5 to 10 mol % of 4-nitrobenzoic acid with phenylsilane led to the development of a room temperature catalytic Wittig reaction. Furthermore, these enhanced reduction conditions also facilitated the use of acyclic phosphine oxides as catalysts. Indeed, triphenylphosphine oxide for the first time is a viable olefination catalyst. A series of di- and tri-substituted alkenes were produced in moderate to high yield with good to excellent E-selectivity, utilizing heteroaryl, aryl, and alkyl aldehydes and organobromides. The room temperature catalytic Wittig reaction protocol was also demonstrated on scale, 4.46 g of 18 was produced (72% yield) with 20 mol % loading of 2. The utilization of process-friendly solvents coupled with both room temperature and high temperature conditions delivers the synthetic flexibility that should promote wider adoption of the methodology.

In a second aspect, the present invention provides a method for performing a catalytic Wittig reaction comprising the steps of:
(i) providing a phosphine oxide precatalyst;
(ii) reducing the phosphine oxide precatalyst to produce a phosphine;
(iii) forming a semi-stabilised or non-stabilised phosphonium ylide precursor by reacting the phosphine with a primary or secondary organohalide;
(iv) generating a semi-stabilised or non-stabilised phosphonium ylide from the semi-stabilised or non-stabilised phosphonium ylide precursor; and
(v) reacting the semi-stabilised or non-stabilised phosphonium ylide with a carbonyl containing compound; for example an aldehyde, a ketone or an ester;
   to form an olefin and a phosphine oxide which re-enters the catalytic cycle.

Fundamentally, the key barrier to the utilization of semi-stabilized and non-stabilised ylides classes in the CWR is selective deprotonation of the phosphonium salt requisite for ylide generation (FIG. 11, III). The success of this critical deprotonation hinges on the choice of base, which must be of sufficient power to remove the ylide-forming proton of the phosphonium salt (pKₐ (DMSO) 17-18 for semi-stabilized, 22-25 for non-stabilized), yet mild enough to be compatible with the wider CWR. An additional challenge for non-stabilized ylides is to ensure a viable rate of phosphonium salt formation (FIG. 11, II).

To balance the need for a stronger base, while avoiding unwanted side reactions, we hypothesized that a masked base, such as carbonate A2, could be used to slowly release NaOtBu in situ (FIG. 12).

However, as the pKa of the ylide-forming proton for non-stabilized ylides is 22-25, it is unlikely that A2 alone would achieve a viable rate of deprotonation necessary to employ this ylide class in the CWR. Therefore we considered a second approach, in which we would lower the pKₐ of the ylide-forming proton to facilitate use of this base. Central to this strategy is the concept that introduction of EWGs on the phenyl ring of the pre-catalyst would lead to withdrawal of electron-density from phosphorus hence lowering the pKₐ of the ylide-forming proton.

However, this removal of electron density from phosphorus may come at a cost; 1) lower nucleophilicity of the phosphine that will likely impact upon the rate of phosphonium salt formation (FIG. 11, II), and 2) the rate of phosphine oxide reduction (FIG. 11, I). Consequently, to compensate for the retarded nucleophilicity of the phosphine and possibly the ylide, the reaction temperature will need to be increased to rebalance the relative rates of the catalytic cycle (FIG. 11, I-IV). Hence, the success of ylide-tuning relies on the identification of a pre-catalyst which achieves the desired electron-withdrawing effect, while maintaining ease of reduction and a viable rate of phosphonium salt formation. Phosphine oxides A1a-d (FIG. 13) were prepared in which electron-density at the phosphorus center was varied by introduction of electron withdrawing or electron donating substituents.

FIG. 14 (Table A1) illustrates optimisation studies for the synthesis of stilbene via the method of the invention. We began our studies by examining the synthesis of stilbene A4 (FIG. 14) and, as expected, base A2 was suitable for use in the CWR. However, at this time it is unclear if A2 generates NaOtBu in situ or if another reaction pathway is involved. Gratifyingly, ylide-tuning was clearly demonstrated in the use of the mild base DIPEA (entries 4-9, FIG. 14), albeit at the anticipated elevated temperature. To the best of our knowledge, this is the mildest base used for Wittig reactions employing semi-stabilized ylides.

To demonstrate the utility of the new CWR protocols, a substrate study was undertaken (FIG. 15, Table A2). The results showed that the CWR utilizing semi-stabilized ylides can tolerate a variety of aryl, heteroaryl and aliphatic aldehydes and organohalides. A notable result is the synthesis of resveratrol analog A10, which has been demonstrated to have more potent anti-cancer activity than resveratrol. Use of allylic halides was problematic, due to reaction with the base, however portion-wise addition of the halide using A2 as the base overcame this difficulty. Significantly, the use of both primary and secondary halides was possible, thus allowing preparation of tri-substituted olefin A12. The protocols performed well on scale, as A11 was prepared on a 27 mmol scale (6.42 g, 84%) using A1a and A2, while A10 was prepared on a 23 mmol scale (5.78 g, 77%) using A1d and DIPEA.

The method also extends to the CWR involving non-stabilized ylides. Pleasingly, the combination of masked base A2 and ylide-tuning provided access to this ylide class. FIG. 16 (Table A3) shows the optimisation of the CWR conditions for the synthesis of representative compound A13. Moderate to good yields can be achieved in 48 h using 20 mol % of A1d at 140° C. (13-18, FIG. 17).

The E/Z ratio for reactions employing semi-stabilized ylides ranged from 66:34 to 80:20, while reactions involving non-stabilized ylides were relatively non-selective. Varying the 1-P substituent provided limited control of the E/Z selectivity, best results were obtained using A1a where an E/Z ratio of 80:20 was achieved for stilbene A4. Just as the phosphine structure could be tuned to facilitate easier ylide formation, the pre-catalyst can be altered to increase the E/Z selectivity.

Compound A3a possesses a 5-membered cyclic structure, which is vital to ensure a sufficient rate of phosphine oxide reduction in the standard CWR. Pleasingly, the combination of A2 and A3a functioned superbly in the CWR, with stilbene selectively prepared in high yield (entry 3, FIG. 14).

A significant increase in E-selectivity was observed for the substrates in FIG. 15; however, no improvement was observed when using secondary halides (A12, FIG. 15). Similar to A1d, addition of EWGs should ease ylide formation, enabling the use of a mild base or non-stabilized ylides while maintaining the high E-selectivity associated with A3a. As expected, A3c performed well in conjunction with DIPEA for reactions of semi-stabilized ylides.

A significant increase in the E/Z selectivity was observed for all substrates, and in several cases a significant increase in yield compared to using A1d was also noted. The use of A3a-c was also examined in the CWR of non-stabilized ylides. Interestingly, A3b proved the optimum pre-catalyst for these substrates (entry 5, FIG. 16). This highlights the importance of finding a balance between lowering the pKₐ of the phosphonium salt while maintaining a sufficient rate of phosphonium salt formation. Using A3b in the CWR of non-stabilized ylides not only provided an increase in E-selectivity, but also a dramatic increase in yield. Compounds A13 and A15 were prepared in good yield in 24 h.

It will be appreciated by persons having skill in the art, that the methods of the invention will work equally well if the reduced phosphine is used in the method instead of the phosphine oxide precatalyst, as during the reaction cycle, the phosphine oxide is formed from the phosphine. Hence the invention also provides for the methods previously described, wherein a reduced phosphine is used as a starting material instead of the phosphine oxide.

Furthermore, the reduced form of the phosphine oxides as claimed in the invention, are provided for.

Modifications and variations of the present invention will be apparent to those skilled in the art from the forgoing detailed description. All modifications and variations are intended to be encompassed by the following claims. All publications, patents, and patent applications cited herein are hereby incorporated by reference in their entirety.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

### GENERAL EXPERIMENTAL

All reagents were purchased from commercial sources and were used without further purification, unless otherwise stated. Benzaldehyde was distilled before use and handled under an inert atmosphere. Commercial dry solvents were purchased from Sigma Aldrich and Acros Chemicals and handled under argon. Toluene was freshly distilled from calcium hydride and handled under argon. Tetrahydrofuran (THF) was freshly distilled from sodium/benzophenone and handled under argon. Deuterated solvents were purchased from Fluorochem. Thin Layer Chromatography (TLC) was performed on Merck TLC silica gel w/UV 254 aluminum-backed plates, and spots were visualized using UV light (254 nm), potassium permanganate, or phosphomolybdic acid stains. Column chromatography purifications were carried out using the flash technique on DAVISIL LC60A (35-70 μm). NMR spectra were recorded on Bruker Avance 400 and Bruker Avance Ultrashield 600 spectrometers. The chemical shifts (δ) for ¹H and ¹³C are given in parts per million (ppm) and referenced to the residual proton signal of the deuterated solvent (CHCl₃ at δ 7.26 ppm, 77.16 ppm, respectively); coupling constants are expressed in hertz (Hz). The chemical shifts (δ) for ³¹P are given in parts per million (ppm) and referenced to triphenylphosphine oxide (at δ 23.0 ppm). The following abbreviations are used: s=singlet, d=doublet, t=triplet, m=multiplet, dd=doublet of doublets, dt=doublet of triplets, dq=doublet of quartets, td=triplet of doublets, tq=triplet of quartets, q=quartet, qt=quartet of triplets, qn=quintet and br.=broad. Melting points were recorded on a Stuart Scientific SMP1 melting point apparatus and are uncorrected. High-resolution mass spectrometry (HRMS) was obtained on a Waters Micromass LCT Classic mass spectrometer in ESI+ mode. All experiments were conducted under an atmosphere of dry argon or nitrogen unless otherwise noted, using Schlenk technique.¹ E and Z refer to the stereochemistry of the olefin bond formed during the reaction.

### Synthetic Procedures—the First Aspect of the Invention

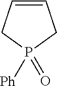 [SMILES: O=P1(c2ccccc2)CC=CC1]

1-Phenyl-3-phospholene-1-oxide: A flame-dried sealed tube was charged with 2,6-di-tert-butyl-4-methylphenol (110 mg, 0.5 mmol, 0.005 mol %) under nitrogen. 1,3-Butadiene (14.0 mL, 0.3 mol, 3.0 equiv.) was introduced by condensation at −78° C. in a liquid nitrogen/acetone bath, after which P,P-dichlorophenylphosphine (13.6 mL, 0.1 mol, 1.0 equiv.) was added. The tube was sealed and allowed to stand in darkness at RT for 15 days. After removal of excess 1,3-butadiene, ice water (30 mL) was added to the remaining red-brown viscous oil, which was stirred vigorously until residues dissolved fully. The solution was extracted in dichloromethane (3×30 mL) and the combined organic layers were neutralized using sodium carbonate (effervescence observed). The resultant solution was filtered, dried with magnesium sulfate, filtered and the solvent removed in vacuo to give a yellow-orange oil. Purification by dry flash column chromatography (methanol in dichloromethane, gradient 4-8%) yielded 1-phenyl-3-phospholene-1-oxide as a pale green solid (5.2 g, 30%). ¹H and ³¹P NMR spectra are consistent with literature.

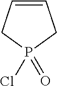

1-Chloro-3-phospholene-1-oxide: A flame-dried sealed tube (100 mL ChemGlass CG-1880-25 or 125 mL AceGlass 8648-96) equipped with a stir-bar was charged with 2,6-di-tert-butyl-4-methylphenol (55 mg, 0.25 mmol, 0.005 mol %) under nitrogen. 1,3-Butadiene (6.8 mL, 0.15 mol, 3.0 equiv.) was introduced by condensation at −78° C. in a liquid nitrogen/acetone bath, after which phosphorus trichloride (4.4 mL, 0.05 mol, 1.0 equiv.) and tris(2-chloroethyl)phosphite (6.0 mL, 0.03 mol, 0.6 equiv.) were introduced via syringe. The tube was sealed under nitrogen using a front-sealing bushing (back sealing bushings are unsuitable, as contact with hot reaction vapors causes swelling, resulting in loss of seal). The solution was stirred at 105° C. for 48 hours. A blast shield was placed around the reaction vessel for the duration of the reaction. A cloudy yellow solution resulted, which was filtered via needle cannula. 1,2-Dichloroethane was removed in vacuo and the resultant pale yellow solid was shown to consist of 1-chloro-3-phospholene-1-oxide and 1-hydroxyphosphol-3-ene (90:10). ¹H and ³¹P NMR spectra are consistent with literature. Product was used without further purification.

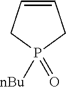

1-(n-Butyl)-3-phospholene-1-oxide: A 50 mL round-bottom flask equipped with a stir-bar and reflux condenser was charged with magnesium (0.43 g, 18.0 mmol, 1.2 equiv.), then flame-dried in vacuo. Iodine (one crystal) and tetrahydrofuran (1.0 mL) were introduced. A solution of 1-bromobutane (1.6 mL, 15.0 mmol, 1.0 equiv.) in tetrahydrofuran (14 mL) was added dropwise until the brown color dissipated and the reaction was initiated by heating. The remaining halide solution was added slowly, maintaining reflux, and the resultant solution was stirred at reflux for a further 2 h. To a portion of this Grignard reagent (12.2 mL, 12.0 mmol, 1.0 equiv.) at 0° C. was added 1-chloro-3-phospholene-1-oxide solution dropwise (1.66 g, 12.0 mmol, 1.0 equiv. Introduction of THF (10 mL) to crude 1-chloro-3-phospholene-1-oxide led to precipitation of the 1-hydroxyphosphol-3-ene by-product. 1-Chloro-3-phospholene-1-oxide solution was obtained following needle cannulation¹). The resultant solution was allowed to warm to RT and stirred for 16 hours, resulting in a yellow-brown solution. The reaction mixture was quenched with water and the aqueous layer was extracted with dichloromethane (3×20 mL). The combined organic layers were dried over magnesium sulfate, filtered and solvent removed in vacuo to give a yellow oil. Purification by flash column chromatography (methanol in dichloromethane, gradient 1-3%) to give 1-(n-butyl)-3-phospholene-1-oxide as a yellow oil (1.05 g, 55%). ¹H NMR (400 MHz, CDCl₃) δ: 0.92 (t, J=7.0 Hz, 3H), 1.38-1.48 (m, 2H), 1.56-1.66 (m, 2H), 1.81-1.88 (m, 2H), 2.39-2.57 (m, 4H), 5.85 (d, J=27.3 Hz, 2H); ¹³C NMR (100 MHz, CDCl₃) δ: 13.7, 24.1 (d, J_{CP}=5.8 Hz), 24.2 (d, J_{CP}=16.0 Hz), 29.6 (d, J_{CP}=62.6 Hz), 31.3 (d, J_{CP}=64.0 Hz), 127.4 (d, J_{CP}=10.9 Hz); ³¹P NMR (162 MHz, CDCl₃) δ: 67.3; HRMS [M+H]⁺: m/z calcd. 159.0939. found 159.0938.

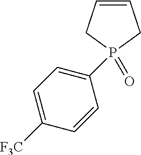 [SMILES: O=P1(c2ccc(C(F)(F)F)cc2)CC=CC1]

1-(4-(Trifluoromethyl)phenyl)-3-phospholene-1-oxide was prepared according to the general procedure from the reaction of magnesium turnings (0.72 g, 36.0 mmol, 1.2 equiv.), 4-bromobenzotrifluoride (4.2 mL, 30.0 mmol, 1.0 equiv., 1 M in THF) and 1-chloro-3-phospholene-1-oxide (3.60 g, 26.3 mmol, 1.0 equiv.). Purification by flash column chromatography (methanol/dichloromethane, gradient 0.5-1.0%) gave 1-(4-(trifluoromethyl)phenyl)-3-phospholene-1-oxide as a white solid (3.21 g, 49%). ¹H NMR (400 MHz, CDCl₃) δ: 2.64-2.88 (m, 4H), 6.02 (d, J=30.0 Hz, 2H), 7.69 (dd, J=8.0, 1.6 Hz, 2H), 7.85 (dd, J=11.2, 8.8 Hz, 2H); ¹³C NMR (100 MHz, CDCl₃) δ: 33.9 (d, J_{CP}=67.6 Hz), 123.6 (q, J_{CF}=272.1 Hz), 125.6 (dq, J_{CF}=4.4 Hz, J_{CP}=11.6 Hz), 128.0 (d, J_{CP}=11.7 Hz), 130.2 (d, J_{CP}=10.2 Hz), 133.9 (qd, J_{CP}=2.9 Hz, J_{CF}=32.8 Hz), 138.4 (d, J_{CP}=88.0 Hz); ³¹P NMR (162 MHz, CDCl₃) δ: 55.3; ¹⁹F NMR (376 MHz, CDCl₃) δ: −63.3; HRMS [M+H]⁺ m/z calcd. 247.0500. found 247.0493.

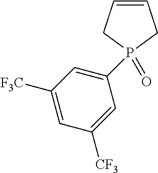 [SMILES: O=P1(c2cc(C(F)(F)F)cc(C(F)(F)F)c2)CC=CC1]

1-(3,5-Bis(trifluoromethyl)phenyl)-3-phospholene-1-oxide was prepared according to the general procedure from the reaction of magnesium turnings (0.69 g, 28.8 mmol, 1.2 equiv.), 1,3-bis(trifluoromethyl)-5-bromobenzene (4.1 mL, 24.0 mmol, 1.0 equiv., 0.5 M in THF) and 1-chloro-3-phospholene-1-oxide (3.00 g, 21.9 mmol, 1.0 equiv.). Purification by flash column chromatography (methanol/dichloromethane, gradient 0.5-1.0%) gave 1-(3,5-bis(trifluoromethyl)phenyl)-3-phospholene-1-oxide as a white solid (3.51 g, 51%). ¹H NMR (400 MHz, CDCl₃) δ: 2.35-1.52 (m, 4H), 5.71 (d, J=30.0 Hz, 2H), 7.60 (s, 1H), 7.82 (d, J=10.8 Hz, 2H); ¹³C NMR (100 MHz, CDCl₃) δ: 32.8 (d, J_{CP}=68.4 Hz), 122.2 (q, J_{CF}=271.3 Hz), 124.9 (m), 127.3 (d, J_{CP}=11.6 Hz), 129.3 (br. dd, J_{CF}=2.9 Hz, J_{CP}=9.4 Hz), 131.4 (qd, J_{CP}=10.9 Hz, J_{CF}=33.5 Hz), 137.2 (d, J_{CP}=86.6 Hz); ³¹P NMR (162 MHz, CDCl₃) δ: 53.9; ¹⁹F NMR (376 MHz, CDCl₃) δ: −63.8; HRMS [M+H]⁺ m/z calcd. 315.0373. found 315.0384.

General procedure for hydrogenation of phospholene-1-oxides: Pd/C (10% w/w, 4-10 mol %) was transferred to a 200 mL round-bottom flask containing a magnetic stir-bar and sealed under nitrogen. Dichloromethane was added, followed by 3-phospholene-1-oxide dissolved in methanol (0.35 M). The vessel was purged with hydrogen using a balloon and silicon oil bubbler. The bubbler was removed and the mixture was stirred under hydrogen at room temperature for 48 h. The crude mixture was filtered through a plug of Celite® and the filtrate treated with activated charcoal to remove any residual dissolved palladium. After stirring for 1 h the solution was filtered through Celite® and solvent removed in vacuo.

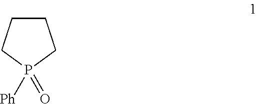 [SMILES: O=P1(c2ccccc2)CCCC1]

001-Phenylphospholane-1-oxide (1) was obtained in accordance with the general procedure, from the reaction of 1-phenyl-2-phospholene-1-oxide (1.79 g, 10.0 mmol, 1.0 equiv.) with an excess of H₂ using 10% Pd/C (1.10 g, 0.10 mmol, 10 mol %) in a methanol/dichloromethane solution (30:2 mL) at room temperature for 48 h. 1 was obtained as a pale yellow viscous oil (1.80 g, 99%). ¹H and ³¹P NMR spectra are consistent with literature.

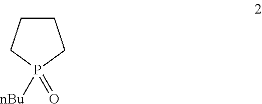

001-(n-Butyl)phospholane-1-oxide⁵ (2) was obtained in accordance with the general procedure, from the reaction of 1-(n-butyl)-2-phospholene-1-oxide (0.60 g, 3.8 mmol, 1.0 equiv.) with an excess of H₂ using 10% Pd/C (0.31 g, 0.4 mmol, 10 mol %) in a methanol/dichloromethane solution (9:1 mL) at room temperature for 48 h. 2 was obtained as a yellow oil (0.58 g, 96%). ¹H NMR (400 MHz, CDCl₃) δ: 0.93 (t, J=7.4 Hz, 3H), 1.45 (m, 2H), 1.58-1.84 (m, 10H), 1.93-2.07 (m, 2H); ¹³C NMR (100 MHz, CDCl₃) δ: 13.7, 24.2 (d, J_{CP}=13.8 Hz), 24.3 (d, J_{CP}=4.4 Hz), 24.6 (d, J_{CP}=8 Hz), 27.0 (d, J_{CP}=64.7 Hz), 30.6 (d, J_{CP}=61.8 Hz); ³¹P NMR (162 MHz, CDCl₃) δ: 69.0; HRMS [M+H]⁺: m/z calcd. 161.1095. found 161.1093.

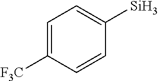

4-(Trifluoromethyl)phenylsilane: A 250 mL 2-neck-round-bottom flask equipped with a stir-bar and reflux condenser was charged with magnesium (3.09 g, 12.5 mmol, 1.1 equiv.), then flame-dried in vacuo. Iodine (one crystal) and dry diethyl ether (2 mL) were introduced. A solution of 1-bromo-4-(trifluoromethyl)benzene (25.5 g, 11.3 mmol, 1.0 equiv.) in diethyl ether (70 mL) was added dropwise until the brown color dissipated and the reaction was initiated by heating. The remaining halide solution was added slowly, maintaining reflux, and the resultant solution was stirred at RT for a further 1 h. Resultant dark brown solution of Grignard reagent (77.0 mL, 10.3 mmol) was added dropwise to a solution of silicon tetrachloride (47.0 mL, 41.2 mmol, 4.0 equiv.) in diethyl ether (90 mL). The resultant solution was refluxed at 50° C. for 72 h. Reaction solution was cooled and filtered rapidly, then added dropwise to a solution of lithium aluminum hydride (16.5 g, 41.2 mol, 4.0 equiv.) in diethyl ether (130 mL) over 3 h. The resultant solution was refluxed at 50° C. for a further 48 h. The reaction was cooled and quenched by slow addition of an acid/water solution (conc. HCl/water, 10:75 mL), followed by extraction of the organic layer. The organic layer was dried over magnesium sulfate and product purified by vacuum distillation (house vacuum, 42-72° C.) to yield 4-(trifluoromethyl)phenylsilane as a colorless liquid (4.12 g, 21%). ¹H NMR spectrum is consistent with the literature.

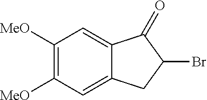 [SMILES: COc1cc2c(cc1OC)C(=O)C(Br)C2]

2-Bromo-5,6-dimethoxy-1-indanone: A stirring solution of 5,6-dimethoxy-1-indanone (20.0 g, 104.6 mmol, 1.0 equiv.) in an ethyl acetate/chloroform solution (50:50, 600 mL) was heated to reflux. Copper (II) bromide (46.7 g, 209.2 mmol, 2.0 equiv.) was added in three portions (28.0 g, 14.0 g, 4.7 g) and the mixture was stirred vigorously. Each portion was added after the black copper(II) bromide changed to white copper(I) bromide. Following the final addition, the reaction solution was refluxed for a further 3 h. The resultant mixture was filtered through a plug of Celite®, decolorized with activated charcoal and filtered again. The solvent was removed in vacuo and the crude product was recrystallized from methanol to yield 2-bromo-5,6-dimethoxy-1-indanone as an off-white solid (22.4 g, 79%). ¹H NMR (400 MHz, CDCl₃) δ: 3.27 (dd, J=18.0, 2.8 Hz, 1H), 3.70 (dd, J=18.0, 7.2 Hz, 1H), 3.86 (s, 3H), 3.93 (s, 3H), 4.59 (dd, J=7.2, 2.8 Hz, 1H), 6.80 (s, 1H), 7.15 (s, 1H); ¹³C NMR (100 MHz, CDCl₃) δ: 37.7, 44.7, 56.2, 56.4, 105.0, 107.2, 126.3, 146.7, 150.0, 156.6, 198.2.

### Optimization Studies.

General procedure for acid optimization studies: In air, a 1-dram vial equipped with a stir-bar was charged with phosphine oxide (0.1 mmol, 1.0 equiv.) and 4-substituted benzoic acid (0.1 mmol, 1.0 equiv.). The vial was then sealed with a septum and purged with argon. Solvent (0.33 mL*) and base (1.4 mmol, 14.0 equiv.) were introduced via syringe, and the solution was stirred for 1 min. Silane (1.4 mmol, 14.0 equiv.) was introduced and the septum was replaced with a PTFE-lined screw cap under an inert atmosphere, and the reaction was stirred at reaction temperature. A portion of the crude solution (0.4 mL) was added to CDCl₃ (0.3 mL) and conversion of phosphine oxide to phosphine determined from ³¹P NMR spectroscopy.

RT acid optimization study: In accordance with the general procedure, phosphine oxide 1 (18 mg, 0.1 mmol, 1.0 equiv.) was reacted with diphenylsilane (263 μL, 1.4 mmol, 14.0 equiv.) using 4-substituted benzoic acid (0.1 mmol, 1.0 equiv.) and DIPEA (244 μL, 1.4 mmol, 14.0 equiv.) for 1 h at RT. *For the entry with no base, the general procedure was followed and additional THF (0.24 mL) added in lieu of base. (FIGS. 18-20)

Trioctylphosphine oxide acid optimization study: In accordance with the general procedure, trioctylphosphine oxide 3 (39 mg, 0.1 mmol, 1.0 equiv.) was reacted with phenylsilane (172 μL, 1.4 mmol, 14.0 equiv.) using 4-substituted benzoic acid (0.1 mmol, 1.0 equiv.) and DIPEA (244 μL, 1.4 mmol, 14.0 equiv.) in toluene (0.33 mL*) for 10 min at 100° C. *For the entry with no base, the general procedure was followed and additional toluene (0.24 mL) added in lieu of base. (FIGS. 21-23)

Triphenylphosphine oxide acid optimization study: In accordance with the general procedure, triphenylphosphine oxide 4 (28 mg, 0.10 mmol, 1.0 equiv.) was reacted with phenylsilane (172 μL, 1.4 mmol, 14.0 equiv.) using 4-substituted benzoic acid (0.1 mmol, 1.0 equiv.) and DIPEA (244 μL, 1.4 mmol, 14.0 equiv.) in toluene (0.33 mL*) for 10 min at 100° C. *For the entry with no base, the general procedure was followed and additional toluene (0.24 mL) added in lieu of base. (FIGS. 24-26)

General procedure for room temperature solvent optimization studies: In air, a 1-dram vial equipped with a stir-bar was charged with phosphine oxide 2 (16 mg, 0.1 mmol, 10 mol %) and 4-nitrobenzoic acid (17 mg, 0.1 mmol, 10 mol %). The vial was then sealed with a septum and purged with argon. Solvent (0.33 mL), benzaldehyde (102 μL, 1.0 mmol, 1.0 equiv.), methyl bromoacetate (123 μL, 1.3 mmol, 1.3 equiv.) and DIPEA (244 μL, 1.4 mmol, 1.4 equiv.) were introduced and the solution was stirred for 1 min. Phenylsilane (172 μL, 1.4 mmol, 1.4 equiv.) was introduced and the septum was replaced with a PTFE-lined screw cap under an inert atmosphere. The reaction was stirred at RT for 24 h. ¹H NMR spectroscopy of the crude reaction mixtures was used to determine conversion and E/Z ratio of products. (FIG. 27)

General procedure for trioctylphosphine oxide solvent optimization studies: In air, a 1-dram vial equipped with a stir-bar was charged with trioctylphosphine oxide 3 (39 mg, 0.1 mmol, 10 mol %) and 4-nitrobenzoic acid (17 mg, 0.1 mmol, 10 mol %). The vial was then sealed with a septum and purged with argon. Solvent (0.33 mL), benzaldehyde (102 μL, 1.0 mmol, 1.0 equiv.), methyl bromoacetate (123 μL, 1.3 mmol, 1.3 equiv.) and DIPEA (244 μL, 1.4 mmol, 1.4 equiv.) were introduced and the solution was stirred for 1 min. Phenylsilane (172 μL, 1.4 mmol, 1.4 equiv.) was introduced and the septum was replaced with a PTFE-lined screw cap under an inert atmosphere. The reaction was stirred at 100° C. for 18 h. ¹H NMR spectroscopy of the crude reaction mixtures was used to determine yield of 5 and E/Z ratio of products. (FIG. 28)

General procedure for optimization of the CWR with primary bromides: In air, a 1-dram vial equipped with a stir-bar was charged with phosphine oxide (0.1 mmol, 10 mol %) and, if required, 4-nitrobenzoic acid (17 mg, 0.1 mmol, 10 mol %). The vial was then sealed with a septum and purged with argon. Solvent (0.33 mL), benzaldehyde (102 μL, 1.0 mmol, 1.0 equiv.), methyl bromoacetate (123 μL, 1.3 mmol, 1.3 equiv.) and DIPEA (244 μL, 1.4 mmol, 1.4 equiv.) were introduced and the solution was stirred for 1 min. Silane (1.4 mmol, 1.4 equiv.) was introduced and the septum was replaced with a PTFE-lined screw cap under an inert atmosphere.

TABLE S1
Optimization of the CWR with primary bromides.

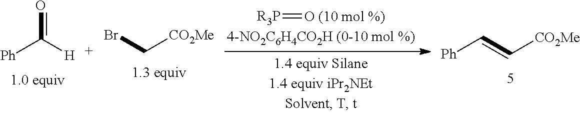

| R₃P═O | Silane | Acid | Solvent | T (° C.) | t (h) | Conv (%)^{[a]} | E/Z^{[b]} |
|---|---|---|---|---|---|---|---|
| None | PhSiH₃ | 4-NO₂ | THF | RT | 24 | 0% | — |
| 1 | Ph₂SiH₂ | — | THF | RT | 24 | 6% | 75:25 |
| 1 | Ph₂SiH₂ | 4-NO₂ | THF | RT | 24 | 7% | 75:25 |
| 1 | PhSiH₃ | — | THF | RT | 24 | 36% | 75:25 |
| 1 | PhSiH₃ | 4-NO₂ | THF | RT | 24 | 100% (91%) | 75:25 |
| 1 | PhSiH₃ | 4-NO₂ | THF | RT | 3 | 65% | 75:25 |
| 1 | None | 4-NO₂ | EtOAc | RT | 24 | 0% | — |
| 1 | None | — | EtOAc | RT | 24 | 0% | — |
| 2 | PhSiH₃ | — | EtOAc | RT | 24 | 56% | 85:15 |
| 2 | PhSiH₃ | — | EtOAc | RT | 3 | 18% | 84:16 |
| 2 | PhSiH₃ | 4-NO₂ | EtOAc | RT | 24 | 100% (85%) | 88:12 |
| 2 | PhSiH₃ | 4-NO₂ | EtOAc | RT | 3 | 67% | 86:14 |
| 3 | Ph₂SiH₂ | — | Toluene | 100 | 24 | 27% | 92:8 |
| 3 | Ph₂SiH₂ | 4-NO₂ | Toluene | 100 | 24 | 31% | 94:6 |
| 3 | PhSiH₃ | — | Toluene | 100 | 24 | 81% | 91:9 |
| 3 | PhSiH₃ | — | Toluene | 100 | 4 | 27% | 90:10 |
| 3 | PhSiH₃ | 4-NO₂ | Toluene | 100 | 24 | 95% (85%) | 90:10 |
| 3 | PhSiH₃ | 4-NO₂ | Toluene | 100 | 4 | 43% | 90:10 |
| 4 | PhSiH₃ | — | Toluene | 100 | 24 | 43% | 90:10 |
| 4 | PhSiH₃ | 4-NO₂ | Toluene | 100 | 24 | 67% (52%) | 94:6 |
| 4 | PhSiH₃ | 4-NO₂ | Toluene | 100 | 6 | 22% | 92:8 |
| 4 | 4-CF₃C₆H₄SiH₃ | 4-NO₂ | Toluene | 100 | 24 | 84% (57%) | 92:8 |
| 4 | 4-CF₃C₆H₄SiH₃ | 4-NO₂ | Toluene | 100 | 6 | 51% | 92:8 |

^{[a]}Isolated yields in parentheses.
^{[b]}E/Z ratio determined by ¹H NMR spectroscopy.

The reaction temperature and duration were varied as specified in Table S1. ¹H NMR spectroscopy of the crude reaction mixtures was used to determine conversion to 5 and E/Z ratio of products. Further purification of selected examples was carried out by flash column chromatography.

General procedure for optimization of the CWR with secondary bromides: In air, a 1-dram vial equipped with a stir-bar was charged with phosphine oxide (0.1-0.2 mmol, 10-20 mol %), 4-nitrobenzoic acid (0.025-0.1 mmol, 2.5-10 mol %) and tetrabutylammonium tetrafluoroborate (PTC; 58 mg, 17.5 mol %), if required. The vial was then sealed with a septum and purged with argon. Ethyl acetate (0.33-2.00 mL), methyl 2-bromopropionate (145 μL, 1.3 mmol, 1.3 equiv.) and DIPEA (244 μL, 1.4 mmol, 1.4 equiv.) were introduced and the solution was stirred for 1 min. The frequency of addition of benzaldehyde (102 μL, 1.0 mmol, 1.0 equiv.) and phenylsilane (1.2-1.4 mmol, 1.2-1.4 equiv.) was varied as specified in Table S2.

TABLE S2
Optimization of the CWR with secondary bromides.

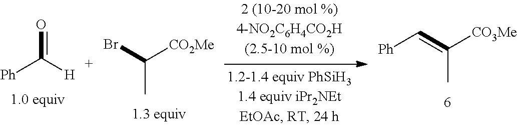

| | 2 | Acid | PTC | | | | | |
|---|---|---|---|---|---|---|---|---|
| | (mol | (mol | (mol | EtOAc | Silane | | | |
| Entry | %) | %) | %) | (mL) | (equiv.) | Yield Conditions | (%)^{[a]} | E/Z ^{[b]} |
| 1 | 10 | 10 | — | 0.33 | 1.4 | Aldehyde & silane added at | 28 | 87:13 |
| | | | | | | start | | |
| 2 | 20 | 2.5 | 17.5 | 2.00 | 1.4 | Aldehyde & silane added at | 52 | 90:10 |
| | | | | | | start | | |
| 3 | 20 | 5 | — | 0.33 | 1.4 | Portionwise addition of | 65 | 90:10 |
| | | | | | | aldehyde & silane, 4 | | |
| | | | | | | portions at 3 h intervals | | |
| 4^{[c]} | 20 | 5 | — | 1.00 | 1.2 | Portionwise addition of | 75 | 90:10 |
| | | | | | | aldehyde, 0.2 eq. at 3 h | | |
| | | | | | | intervals | | |
| 5^{[c]} | 10 | 2.5 | — | 0.50 | 1.2 | Portionwise addition of | 66 | 90:10 |
| | | | | | | aldehyde, 0.1 eq. at 1.5 h | | |
| | | | | | | intervals | | |

^{[a]}Isolated yields. Purification carried out by flash column chromatography.
^{[b]}E/Z ratio determined by ¹H NMR spectroscopy.
^{[c]}For portionwise addition of benzaldehyde, the other reagents were stirred together at RT for 30 min prior to introduction of the first portion of aldehyde.

To identify the resting state of the catalyst during the CWR using a secondary bromide: In air, a 1-dram vial equipped with a stir-bar was charged with phosphine oxide 2 (16 mg, 0.1 mmol, 10 mol %) and 4-nitrobenzoic acid (17 mg, 0.1 mmol, 10 mol %), then sealed with a septum and purged with argon. Ethyl acetate (2.00 mL), methyl 2-bromopropionate (145 μL, 1.3 mmol, 1.3 equiv.) and DIPEA (244 μL, 1.4 mmol, 1.4 equiv.) were introduced and the solution was stirred for 1 min. Phenylsilane (172 μL, 1.4 mmol, 1.4 equiv.) was introduced and the reaction was stirred at RT for 4 h, samples (0.2 mL) were taken at 1, 2 and 4 h for analysis by ³¹P NMR spectroscopy (FIG. 29 S12).

All ³¹P signals were verified independently via the synthesis of authentic samples of 2, the phosphine derived from 2 and the phosphonium salt formed from the phosphine of 2 and methyl 2-bromopropionate. The chemical shifts are 69.0 ppm, −29.1 ppm and 57.1 ppm, respectively (calibrated to triphenylphosphine oxide).

### Catalytic Wittig Olefination Procedures.

### General Procedure 1—RT: Preparation of Compounds 6-21 Via a Room Temperature Catalytic Wittig Reaction.

In air, a 1-dram vial equipped with a stir-bar was charged with phosphine oxide 2 (0.10-0.20 mmol, 10-20 mol %) and 4-nitrobenzoic acid (0.025-0.10 mmol, 2.5-10 mol %). Any other solid reagents were also added at this point, in the following quantities: aldehyde (1.0 mmol, 1.0 equiv.), organohalide (1.1-1.3 mmol, 1.1-1.3 equiv.) or tetrabutylammonium tetrafluoroborate (0.075-0.175 mmol, 7.5-17.5 mol %), if required. The vial was then sealed with a septum and purged with argon. Solvent (0.33-2.0 mL) and liquid reagents were introduced in the following quantities: aldehyde (1.0 mmol, 1.0 equiv.), organohalide (1.3 mmol, 1.3 equiv.) and base (1.4 mmol, 1.4 equiv.), and the solution was stirred for 1 min. Silane (1.2-1.4 mmol, 1.2-1.4 equiv.) was introduced and the septum was replaced with a PTFE-lined screw cap under an inert atmosphere¹, and the reaction was heated at 27±1° C. for 24 h. The crude reaction mixture was concentrated in vacuo, and purified via flash column chromatography.

### General Procedure 2—Trioctylphosphine Oxide: Preparation of Compounds 22-32 Utilizing an Acyclic Phosphine Oxide in a Catalytic Wittig Reaction.

In air, a 1-dram vial equipped with a stir-bar was charged with trioctylphosphine oxide 3 (0.10-0.20 mmol, 10-20 mol %) and 4-nitrobenzoic acid (0.025-0.10 mmol, 2.5-10 mol %). Any other solid reagents were also added at this point, in the following quantities: aldehyde (1.0 mmol, 1.0 equiv.), organohalide (1.1-1.3 mmol, 1.1-1.3 equiv.) or phase transfer catalyst (0.175 mmol, 17.5 mol %), if required. The vial was then sealed with a septum and purged with argon. Solvent (0.33-2.0 mL) and liquid reagents were introduced in the following quantities: aldehyde (1.0 mmol, 1.0 equiv.), organohalide (1.3 mmol, 1.3 equiv.) and base (1.4 mmol, 1.4 equiv.), and the solution was stirred for 1 min. Silane (1.4 mmol, 1.4 equiv.) was introduced and the septum was replaced with a PTFE-lined screw cap under an inert atmosphere¹, and the reaction was heated at 100±1° C. for 24 h. The crude reaction mixture was concentrated in vacuo, and purified via flash column chromatography.

### General Procedure 3—Triphenylphosphine Oxide: Preparation of Compounds 16, 24, 26-27 and 33-34 Utilizing Triphenylphosphine Oxide in a Catalytic Wittig Reaction.

In air, a 1-dram vial equipped with a stir-bar was charged with triphenylphosphine oxide 4 (0.10 mmol, 10 mol %) and 4-nitrobenzoic acid (0.10 mmol, 10 mol %). Any other solid reagents were also added at this point, in the following quantities: aldehyde (1.0 mmol, 1.0 equiv.), organohalide (1.1-1.3 mmol, 1.1-1.3 equiv.). The vial was then sealed with a septum and purged with argon. Solvent (0.33 mL) and liquid reagents were introduced in the following quantities: aldehyde (1.0 mmol, 1.0 equiv.), organohalide (1.3 mmol, 1.3 equiv.) and base (1.4 mmol, 1.4 equiv.), and the solution was stirred for 1 min. Silane (1.4-1.6 mmol, 1.4-1.6 equiv.) was introduced and the septum was replaced with a PTFE-lined screw cap under an inert atmosphere¹, and the reaction was heated at 100±1° C. for 24 h. The crude reaction mixture was concentrated in vacuo, and purified via flash column chromatography.

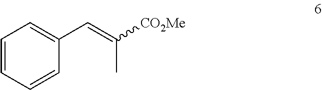

Methyl 2-methyl-3-phenylprop-2-enoate (6) was obtained in accordance with general procedure 1 from the reaction of benzaldehyde (102 μL, 1.0 mmol, 1.0 equiv.), methyl 2-bromopropionate (145 μL, 1.3 mmol, 1.3 equiv.), phenylsilane (147 μL, 1.2 mmol, 1.2 equiv.) and DIPEA (244 μL, 1.4 mmol, 1.4 equiv.) using 2 (16 mg, 10 mol %) and 4-nitrobenzoic acid (4 mg, 2.5 mol %) in ethyl acetate (0.50 mL). The reaction solution, excluding aldehyde, was stirred at RT for 30 minutes prior to addition of the aldehyde in 10 portions over 13.5 h (10×0.1 equiv. at 1.5 h intervals). The vial was then sealed and reaction stirred at RT for a further 10.5 h. The crude product was purified via flash column chromatography (5% diethyl ether in hexane, R_{f}=0.33) to afford 6 as a colorless oil (134 mg, 66%, inseparable mixture of E- and Z-6, E/Z 90:10). E-6: ¹H NMR (400 MHz, CDCl₃) δ: 2.13 (d, J=1.6 Hz, 3H), 3.81 (s, 3H), 7.24-7.39 (m, 5H), 7.70 (br. s, 1H); Z-6: ¹H NMR (400 MHz, CDCl₃) δ: 2.10 (d, J=1.6 Hz, 3H), 2.64 (s, 3H), 6.70 (br. s, 1H), 7.24-7.39 (m, 5H).

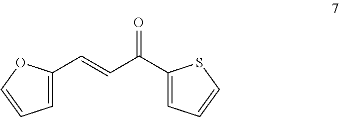 [SMILES: O=C(/C=C/c1ccco1)c1cccs1]

3-(2-Furyl)-1-(2-thienyl)prop-2-en-1-one (7) was obtained in accordance with general procedure 1 from the reaction of furfural (83 μL, 1.0 mmol, 1.0 equiv.), 2-bromo-1-(2-thienyl)-1-ethanone (266 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (32 mg, 20 mol %) and 4-nitrobenzoic acid (17 mg, 10 mol %) in ethyl acetate (0.33 mL) at RT for 24 h. The crude product was purified via flash column chromatography (hexane/diethyl ether, 75:25, R_{f}=0.33) to afford 7 as a yellow oil (153 mg, 75%, E/Z 90:10 in crude, >95:5 isolated). ¹H NMR (400 MHz, CDCl₃) δ: 6.52 (dd, J=3.3, 1.8 Hz, 1H), 6.72 (d, J=3.3 Hz, 1H), 7.17 (dd, J=4.8, 4.0 Hz, 1H), 7.33 (d, J=15.2 Hz, 1H), 7.53 (br. s, 1H), 7.60 (d, J=15.1 Hz, 1H), 7.67 (d, J=4.8 Hz, 1H), 7.85 (d, J=3.8 Hz, 1H).

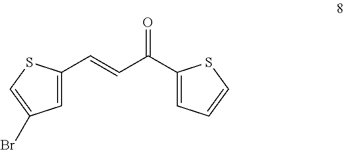 [SMILES: O=C(/C=C/c1cc(Br)cs1)c1cccs1]

(2E)-3-(4-bromo-2-thienyl)-1-(2-thienyl)prop-2-en-1-one (8) was obtained in accordance with general procedure 1 from the reaction of 4-bromo-2-thiophenecarboxaldehyde (191 mg, 1.0 mmol, 1.0 equiv.), 2-bromo-1-(2-thienyl)-1-ethanone (266 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (pentane/benzene, 60:40, R_{f}=0.26) to afford 8 as a brown solid (179 mg, 61%, E/Z>95:5). ¹H NMR (400 MHz, CDCl₃) δ: 7.08 (dd, J=5.2, 3.6 Hz, 1H), 7.10 (d, J=15.6 Hz, 1H), 7.16 (br. d, J=2.0 Hz, 1H), 7.20 (br. s, 1H), 7.59 (dd, J=5.2, 1.2 Hz, 1H), 7.73 (dd, J=3.6 Hz, 1.2, 1H), 7.74 (d, J=15.2 Hz, 1H); ¹³C NMR (100 MHz, CDCl₃) δ: 111.3, 121.5, 125.7, 128.5, 132.1, 133.5, 134.4, 135.0, 140.9, 145.3, 181.3; mp 125-128° C.; HRMS [M+H]⁺: m/z calcd. 298.9200. found 298.9185.

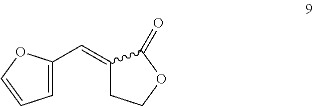 [SMILES: O=C1OCCC1=Cc1ccco1]

3-(2-Furylmethylidene)dihydrofuran-2(3H)-one (9) was obtained in accordance with general procedure 1 from the reaction of furfural (83 μL, 1.0 mmol, 1.0 equiv.), α-bromo-γ-butyrolactone (120 μL, 1.3 mmol, 1.3 equiv.), phenylsilane (172 μL, 1.4 mmol, 1.4 equiv.) and DIPEA (244 μL, 1.4 mmol, 1.4 equiv.) using 2 (32 mg, 20 mol %), 4-nitrobenzoic acid (4 mg, 2.5 mol %) and tetrabutylammonium tetrafluoroborate (58 mg, 17.5 mol %) in ethyl acetate (2.00 mL) at RT for 24 h. The crude product was purified via flash column chromatography (ethyl acetate/pentane, 88:12, R_{f}=0.33) to afford 9 as a yellow oil (198 mg, 61%, E/Z 90:10). E-9: ¹H NMR (400 MHz, CDCl₃) δ: 3.18 (td, J=7.6, 2.8 Hz, 2H), 4.36 (t, J=7.6 Hz, 2H), 6.45 (dd, J=3.2, 1.6 Hz, 1H), 6.73 (d, J=3.2 Hz, 1H), 7.22 (t, J=2.8 Hz, 1H), 7.50 (br. s, 1H); Z-9: ¹H NMR (400 MHz, CDCl₃) δ: 3.11 (td, J=7.4, 2.4 Hz, 2H), 4.40 (t, J=7.4 Hz, 2H), 6.52 (dd, J=3.6, 2.0 Hz, 1H), 6.87 (t, J=2.4 Hz, 1H), 7.46 (d, J=0.8 Hz, 1H), 7.85 (d, J=3.6 Hz, 1H).

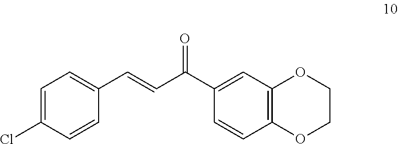 [SMILES: O=C(/C=C/c1ccc(Cl)cc1)c1ccc2c(c1)OCCO2]

(2E)-3-(4-Chlorophenyl)-1-(2,3-dihydro-1,4-benzodioxin-6-yl)prop-2-en-1-one (10) was obtained in accordance with general procedure 1 from the reaction of 4-chlorobenzaldehyde (141 mg, 1.0 mmol, 1.0 equiv.), 2-bromo-1-(2,3-dihydro-1,4-benzodioxin-6-yl)ethanone (320 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (pentane/benzene, 80:20, R_{f}=0.20) to afford 10 as a white solid (241 mg, 80%, E/Z>95:5). ¹H NMR (400 MHz, CDCl₃) δ: 4.29-4.35 (m, 4H), 6.95-6.97 (m, 1H), 7.39 (dt, J=9.1, 1.8 Hz, 2H), 7.49 (d, J=15.6 Hz, 1H), 7.55-7.60 (m, 4H), 7.75 (d, J=15.6 Hz, 1H); ¹³C NMR (100 MHz, CDCl₃) δ: 64.3, 64.9, 117.5, 118.2, 122.3, 122.8, 129.3, 129.7, 131.9, 133.6, 136.3, 142.7, 143.6, 148.2, 188.4; mp 175-176° C.; HRMS [M+H]⁺: m/z calcd. 301.0631. found 301.0634.

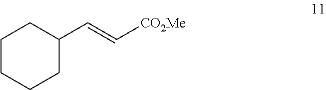 [SMILES: COC(=O)/C=C/C1CCCCC1]

Methyl (2E)-3-cyclohexylprop-2-enoate (11) was obtained in accordance with general procedure 1 from the reaction of cyclohexanecarboxaldehyde (121 μL, 1.0 mmol, 1.0 equiv.), methyl bromoacetate (123 μL, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (1% ethyl acetate in pentane, R_{f}=0.31) to afford 11 as a colorless oil (136 mg, 81%, E/Z>95:5). ¹H NMR (400 MHz, CDCl₃) δ: 1.07-1.32 (m, 6H), 1.63-1.75 (m, 4H), 2.07-2.15 (m, 1H), 3.71 (s, 3H), 5.75 (dd, J=15.6 Hz, 1.2, 1H), 6.90 (dd, J=16.0, 6.8 Hz, 1H).

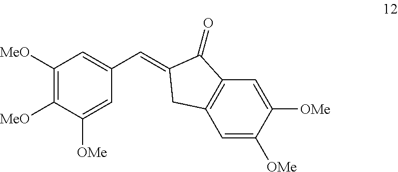 [SMILES: COc1cc2c(cc1OC)C(=O)/C(=C/c1cc(OC)c(OC)c(OC)c1)C2]

(E)-5,6-Dimethoxy-2-(3,4,5-trimethoxybenzylidene)-2,3-dihydro-1H-inden-1-one (12) was obtained in accordance with general procedure 1 from the reaction of 3,4,5-trimethoxybenzaldehyde (196 mg, 1.0 mmol, 1.0 equiv.), 2-bromo-5,6-dimethoxy-2,3-dihydro-1H-inden-1-one (351 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (32 mg, 20 mol %), tetrabutylammonium tetrafluoroborate (58 mg, 17.5 mol %) and 4-nitrobenzoic acid (4 mg, 2.5 mol %) in ethyl acetate (2.00 mL) at RT for h. The crude product was purified via flash column chromatography (benzene/diethyl ether, 50:50, R_{f}=0.29) to afford 12 as a pale yellow solid (305 mg, 82%, E/Z>95:5). ¹H NMR (400 MHz, CDCl₃) δ: 3.90 (s, 3H), 3.90-3.95 (m, 11H), 3.99 (s, 3H), 6.86 (s, 2H), 6.98 (s, 1H), 7.31 (s, 1H), 7.48 (br. s, 1H); ¹³C NMR (100 MHz, CDCl₃) δ: 32.0, 56.2, 56.4, 61.1, 105.1, 107.3, 107.9, 131.1, 132.7, 134.5, 139.5, 144.7, 149.7, 153.4, 155.4, 193.1; mp 207-208° C.; HRMS [M+H]⁺: m/z calcd. 371.1495. found 371.1502.

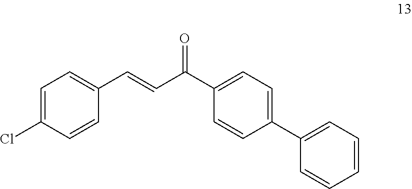 [SMILES: O=C(/C=C/c1ccc(Cl)cc1)c1ccc(-c2ccccc2)cc1]

(2E)-1-(Biphenyl-4-yl)-3-(4-chlorophenyl)prop-2-en-1-one (13) was obtained in accordance with general procedure 1 from the reaction of 4-chlorobenzaldehyde (141 mg, 1.0 mmol, 1.0 equiv.), 2-bromo-4′-phenylacetophenone (357 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (hexane/benzene, 60:40, R_{f}=0.20) to afford 13 as a white solid (195 mg, 67%, E/Z>95:5). ¹H NMR (400 MHz, CDCl₃) δ: 7.39-7.43 (m, 3H), 7.43-7.51 (m, 2H), 7.56 (d, J=15.6 Hz, 1H), 7.60 (d, J=8.5 Hz, 2H), 7.66 (d, J=7.2 Hz, 2H), 7.74 (d, J=8.4 Hz, 2H), 7.79 (d, J=15.6 Hz, 1H), 8.11 (d, J=8.0 Hz, 2H); ¹³C NMR (100 MHz, CDCl₃) δ: 122.4, 127.4, 127.5, 129.1, 129.3, 129.4, 129.8, 133.5, 136.6, 136.8, 140.0, 143.4, 145.8. Although this compound is known in the literature¹¹, the ¹H NMR data presented previously was interpreted differently to the data detailed herein.

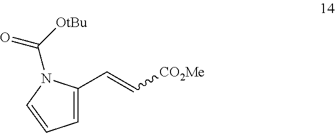 [SMILES: COC(=O)C=Cc1cccn1C(=O)OC(C)(C)C]

tert-Butyl 2-(3-methoxy-3-oxoprop-1-en-1-yl)-1H-pyrrole-1-carboxylate (14) was obtained in accordance with general procedure 1 from the reaction of tert-butyl 2-formyl-1H-pyrrole-1-carboxylate (195 mg, 1.0 mmol, 1.0 equiv.), methyl bromoacetate (123 μL, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (benzene/diethyl ether, 80:20, E-14: R_{f}=0.33, Z-14: R_{f}=0.31) to afford both E- and Z-14 as brown oils (170 mg, 86%, E/Z 51:49). E-14: ¹H NMR (400 MHz, CDCl₃) δ: 1.62 (s, 9H), 3.76 (s, 3H), 6.20 (t, J=3.2 Hz, 1H), 6.21 (d, J=16.0 Hz, 1H), 6.69 (br. d, J=3.2 Hz, 1H), 7.38 (dd, J=3.6, 2.0 Hz, 1H), 8.30 (d, J=16.0 Hz, 1H); Z-14: ¹H NMR (400 MHz, CDCl₃) δ: 1.59 (s, 9H), 3.71 (s, 3H), 5.78 (d, J=12.8 Hz, 1H), 6.23 (dd, J=6.8, 3.6 Hz, 1H), 7.24 (br. d, J=3.6 Hz, 1H), 7.32 (dd, J=3.2, 1.6 Hz, 1H), 7.48 (d, J=13.2 Hz, 1H); ¹³C NMR (125 MHz, CDCl₃) δ: 17.7, 19.4, 25.4, 25.7, 32.0, 36.6, 40.8, 100.7, 117.5, 124.1, 131.8, 155.1. Spectral data for E-14 is consistent with literature data, Z-14 not previously reported.

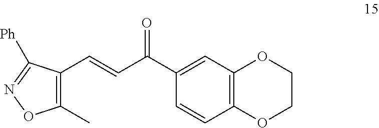 [SMILES: Cc1onc(-c2ccccc2)c1/C=C/C(=O)c1ccc2c(c1)OCCO2]

(2E)-1-(2,3-Dihydro-1,4-benzodioxin-6-yl)-3-(5-methyl-3-phenyl-1,2-oxazol-4-yl)prop-2-en-1-one (15) was obtained in accordance with general procedure 1 from the reaction of 5-methyl-3-phenylisoxazole-4-carboxaldehyde (187 mg, 1.0 mmol, 1.0 equiv.), 2-bromo-1-(2,3-dihydro-1,4-benzodioxin-6-yl)ethanone (320 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (2% diethyl ether in benzene, R_{f}=0.25) to afford 15 as a white solid (312 mg, 90%, E/Z>95:5). ¹H NMR (400 MHz, CDCl₃) δ: 2.66 (s, 3H), 4.26-4.32 (m, 4H), 6.88 (d, J=8.4 Hz, 1H), 7.05 (d, J=15.6 Hz, 1H), 7.33 (dd, J=8.0, 2.0 Hz, 1H), 7.39 (d, J=2.0 Hz, 1H), 7.51-7.54 (m, 3H), 7.58-7.62 (m, 2H), 7.59 (d, J=15.6 Hz, 1H); ¹³C NMR (100 MHz, CDCl₃) δ: 12.7, 64.2, 64.8, 111.8, 117.4, 118.0, 122.6, 123.3, 128.9, 128.9, 129.1, 130.1, 131.5, 131.6, 143.6, 148.2, 162.2, 170.1, 187.7; mp 186-187° C.; HRMS [M+H]⁺: m/z calcd. 348.1236. found 348.1227.

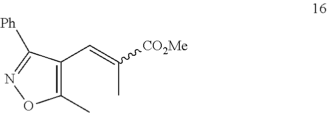 [SMILES: COC(=O)C(C)=Cc1c(-c2ccccc2)noc1C]

Methyl 2-methyl-3-(5-methyl-3-phenyl-1,2-oxazol-4-yl)prop-2-enoate (16) was obtained in accordance with general procedure 1 from the reaction of 5-methyl-3-phenylisoxazole-4-carboxaldehyde (187 mg, 1.0 mmol, 1.0 equiv.) and methyl 2-bromopropionate (145 μL, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (1% diethyl ether in benzene, E-16: R_{f}=0.30, Z-16: R_{f}=0.17) to afford both E-16 as a yellow solid and Z-16 as a yellow oil (175 mg, 68%, E/Z 80:20). E-16: ¹H NMR (400 MHz, CDCl₃) δ: 1.79 (d, J=1.6 Hz, 3H), 2.38 (d, J=0.4 Hz, 3H), 3.81 (s, 3H), 7.36 (br. s, 1H), 7.42-7.45 (m, 3H), 7.61-7.66 (m, 2H); ¹³C NMR (100 MHz, CDCl₃) δ: 12.5, 14.9, 52.3, 110.7, 128.0, 128.0, 128.9, 129.2, 129.9, 132.2, 161.4, 167.2, 168.0; mp 93-95° C.; Z-16: ¹H NMR (400 MHz, CDCl₃) δ: 2.11 (d, J=1.6 Hz, 3H), 2.33 (s, 3H), 3.52 (s, 3H), 6.47 (br. s, 1H), 7.35-7.50 (m, 3H), 7.60-7.70 (m, 2H); ¹³C NMR (100 MHz, CDCl₃) δ: 12.1, 21.3, 51.9, 111.3, 125.4, 128.0, 128.8, 129.6, 129.7, 133.3, 161.2, 167.2, 168.0; HRMS [M+H]⁺: m/z calcd. 258.1130. found 258.1129. Z-16 was isolated for characterization purposes, however less than 20 mg were obtained, thus grease is evident in both ¹H and ¹³C spectra.

16 was obtained in accordance with general procedure 3 from the reaction of 5-methyl-3-phenylisoxazole-4-carboxaldehyde (187 mg, 1.0 mmol, 1.0 equiv.) and methyl 2-bromopropionate (145 μL, 1.3 mmol, 1.3 equiv.), 4-(trifluoromethyl)phenylsilane (251 μL, 1.6 mmol, 1.6 equiv.) and DIPEA (244 μL, 1.4 mmol, 1.4 equiv.) using triphenylphosphine oxide 4 (28 mg, 10 mol %) and 4-nitrobenzoic acid (17 mg, 10 mol %) in toluene (0.33 mL) at 100° C. for 24 h. The crude product was purified via flash column chromatography (1% diethyl ether in benzene, E-16: R_{f}=0.30, Z-16: R_{f}=0.17) to afford both E-16 as a yellow solid and Z-16 as a yellow oil (194 mg, 75%, E/Z 90:10). When this reaction was carried out using phenylsilane (197 μL, 1.6 mmol, 1.6 equiv.), 16 was obtained in 75% yield (195 mg, E/Z 90:10).

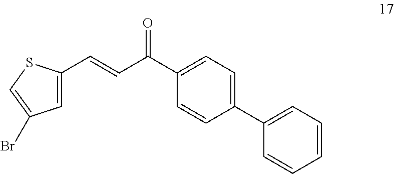 [SMILES: O=C(/C=C/c1cc(Br)cs1)c1ccc(-c2ccccc2)cc1]

(2E)-1-(Biphenyl-4-yl)-3-(4-bromo-2-thienyl)prop-2-en-1-one (17) was obtained in accordance with general procedure 1 from the reaction of 4-bromo-2-thiophenecarboxaldehyde (191 mg, 1.0 mmol, 1.0 equiv.), 2-bromo-4′-phenylacetophenone (357 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (24 mg, 15 mol %) and 4-nitrobenzoic acid (12 mg, 7.5 mol %) in ethyl acetate (0.33 mL) at RT for 24 h. The crude product was purified via flash column chromatography (benzene/pentane, 70:30, R_{f}=0.33) to afford 17 as a green solid (264 mg, 71%, E/Z>95:5). ¹H NMR (400 MHz, CDCl₃) δ: 7.29 (d, J=10.8 Hz, 2H), 7.39 (d, J=15.6 Hz, 1H), 7.39-7.43 (m, 1H), 7.47-7.51 (m, 2H), 7.65 (d, J=7.2 Hz, 2H), 7.73 (d, J=8.0 Hz, 2H), 7.86 (d, J=15.2 Hz, 1H), 8.08 (d, J=8.4 Hz, 2H); ¹³C NMR (100 MHz, CDCl₃) δ: 111.3, 121.7, 125.6, 127.4, 127.5, 128.4, 129.1, 129.2, 133.4, 135.7, 136.6, 139.9, 141.2, 145.9, 189.0; mp 167-170° C.; HRMS [M+H]⁺: m/z calcd. 368.9949. found 368.9957.

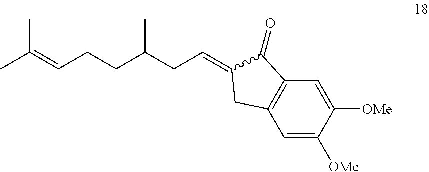 [SMILES: COc1cc2c(cc1OC)C(=O)C(=CCC(C)CCC=C(C)C)C2]

5,6-Dimethoxy-2-(3,7-dimethyloct-6-enylidene)-2,3-dihydro-1H-inden-1-one (18) was obtained in accordance with general procedure 1 from the reaction of (±)-citronellal (180 μL, 1.0 mmol, 1.0 equiv.), 2-bromo-5,6-dimethoxy-2,3-dihydro-1H-inden-1-one (351 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (32 mg, 20 mol %), 4-nitrobenzoic acid (4 mg, 2.5 mol %) and tetrabutylammonium tetrafluoroborate (58 mg, 17.5 mol %) in ethyl acetate (2.00 mL) at RT for 24 h. The crude product was purified via flash column chromatography (pentane/ethyl acetate, 85:15, E-18: R_{f}=0.32, Z-18: R_{f}=0.36) to afford both E- and Z-18 as yellow and colorless oils, respectively, (253 mg, 77%, E/Z 88:12). E-18: ¹H NMR (400 MHz, CDCl₃) δ: 0.81 (d, J=6.8 Hz, 3H), 1.03-1.12 (m, 1H), 1.22-1.31 (m, 1H), 1.46 (s, 3H), 1.53 (s, 3H), 1.53-1.61 (m, 1H), 1.78-1.92 (m, 2H), 1.92-2.17 (m, 2H), 3.36 (s, 2H), 3.76 (s, 3H), 3.81 (s, 3H), 4.93 (br. t, J=7.2 Hz, 1H), 6.64 (br. t, J=7.6 Hz, 1H), 6.74 (s, 1H), 7.10 (s, 1H); ¹³C NMR (100 MHz, CDCl₃) δ: 17.4, 19.5, 25.4, 25.5, 29.6, 32.4, 36.6, 36.9, 55.8, 55.9, 104.6, 107.0, 124.2, 131.1, 131.6135.0, 137.4, 144.3, 149.1, 154.9, 191.7; Z-18: ¹H NMR (400 MHz, CDCl₃) δ: 0.93 (d, J=6.8 Hz, 3H), 1.18-1.27 (m, 1H), 1.35-1.44 (m, 1H), 1.57 (s, 3H), 1.60-1.68 (m, 1H), 1.65 (s, 3H), 1.92-2.07 (m, 2H), 2.79-2.92 (m, 2H), 3.56 (s, 2H), 3.90 (s, 3H), 3.94 (s, 3H), 5.08 (br. t, J=6.8 Hz, 1H), 6.19 (br. t, J=8.0 Hz, 1H), 6.84 (s, 1H), 7.21 (s, 1H); ¹³C NMR (100 MHz, CDCl₃) δ: 17.7, 19.7, 25.7, 25.8, 32.9, 33.5, 34.7, 36.9, 56.1, 56.3, 104.7, 107.0, 124.8, 131.2, 133.5, 135.4, 141.0, 144.3, 149.4, 155.0, 193.6; HRMS [M+H]⁺: m/z calcd. 329.2117. found 329.2126.

18 was obtained from the reaction of (±)-citronellal (3.6 mL, 19.1 mmol, 1.0 equiv.), 2-bromo-5,6-dimethoxy-2,3-dihydro-1H-inden-1-one (6.67 g, 24.7 mmol, 1.3 equiv.), phenylsilane (3.27 mL, 26.6 mmol, 1.4 equiv.) and DIPEA (4.49 mL, 26.6 mmol, 1.4 equiv.) using 2 (608 mg, 3.8 mmol, 20 mol %), 4-nitrobenzoic acid (79 mg, 2.5 mol %) and tetrabutylammonium tetrafluoroborate (1.09 g, 17.5 mol %) in ethyl acetate (38.0 mL). The reaction was prepared in a 150 mL pressure vessel under an inert atmosphere and run at RT for 24 h to afford the title compound (4.46 g, 72%, E/Z 86:14).

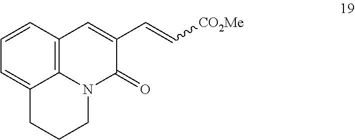 [SMILES: COC(=O)C=Cc1cc2cccc3c2n(c1=O)CCC3]

Methyl 3-(5-oxo-2,3-dihydro-1H,5H-pyido[3,2,1-ij]quinolin-6-yl)prop-2-enoate (19) was obtained in accordance with general procedure 1 from the reaction of 5-oxo-2,3-dihydro-1H,5H-pyrido[3,2,1-ij]quinoline-6-carbaldehyde (213 mg, 1.0 mmol, 1.0 equiv.), methyl bromoacetate (123 μL, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (benzene/ethyl acetate, 85:15, R_{f}=0.33) to afford E- and Z-19 as yellow solids (183 mg, 68%, E/Z 83:17, Z-19 inseparable from E-19). E-19: ¹H NMR (400 MHz, CDCl₃) δ: 2.13 (qn, J=6.0 Hz, 2H), 2.97 (t, J=6.0 Hz, 2H), 3.79 (s, 3H), 4.22 (t, J=6.0 Hz, 2H), 7.12 (d, J=15.6 Hz, 1H), 7.14 (dd, J=7.6, 7.6 Hz, 1H), 7.34 (d, J=7.2 Hz, 1H), 7.44 (d, J=7.2 Hz, 1H), 7.77 (d, J=16.0 Hz, 1H), 7.88 (s, 1H); ¹³C NMR (100 MHz, CDCl₃) δ: 20.8, 27.5, 42.7, 51.8, 119.9, 121.5, 122.3, 125.0, 125.5, 127.5, 131.0, 136.8, 139.7, 140.2, 160.5, 168.1; mp 179-186° C.; Z-19: ¹H NMR (400 MHz, CDCl₃) δ: 2.08-2.15 (m, masked by E-19, 2H), 2.95-2.98 (m, masked by E-19, 2H), 3.72 (s, 3H), 4.17-4.22 (m, masked by E-19, 2H), 6.09 (d, J=12.9 Hz, 1H), 7.12-7.15 (m, masked by E-19, 1H), 7.27 (d, J=12.9 Hz, 1H), 7.28-7.34 (m, masked by E-19, 1H), 7.45 (d, J=7.6 Hz, 1H), 8.45 (s, 1H); ¹³C NMR (100 MHz, CDCl₃) δ: 20.7 (masked by E-19), 27.4, 42.7, 51.5, 119.8, 120.7, 122.0, 124.7, 125.3, 127.7, 130.5, 136.8, 138.9, 140.1, 161.0, 168.0; HRMS [M+H]⁺: m/z calcd. 270.1130. found 270.1142.

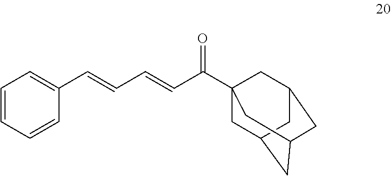 [SMILES: O=C(/C=C/C=C/c1ccccc1)C12CC3CC(CC(C3)C1)C2]

(2E,4E)-5-Phenyl-1-(adamant-1-yl)penta-2,4-dien-1-one (20) was obtained in accordance with general procedure 1 from the reaction of trans-cinnamaldehyde (126 μL, 1.0 mmol, 1.0 equiv.), 1-(1-adamantyl)-2-bromoethanone (334 mg, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for 24 h. The crude product was purified via flash column chromatography (pentane/benzene, 70:30, R_{f}=0.31) to afford 20 as a white solid (220 mg, 75%, E/Z>95:5). ¹H NMR (400 MHz, CDCl₃) δ: 1.69-1.79 (m, 6H), 1.84-1.85 (m, 5H), 2.07 (br. s, 4H), 6.71 (d, J=14.8 Hz, 1H), 6.88-6.97 (m, 2H), 7.28-7.38 (m, 3H), 7.41-7.47 (m, 3H); ¹³C NMR (100 MHz, CDCl₃) δ: 28.1, 36.7, 38.2, 45.4, 124.0, 127.1, 127.3, 128.9, 129.1, 136.4, 141.1, 142.9, 204.3; mp 83-86° C.; HRMS [M+H]⁺: m/z calcd. 293.1905. found 293.1910.

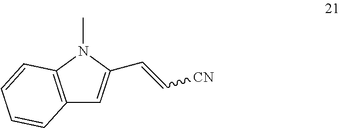

3-(1-Methyl-1H-indol-2-yl)prop-2-enenitrile (21) was obtained in accordance with general procedure 1 from the reaction of 1-methylindole-2-carboxaldehyde (164 mg, 1.0 mmol, 1.0 equiv.), bromoacetonitrile (91 μL, 1.3 mmol, 1.3 equiv.), phenylsilane (172 μL, 1.4 mmol, 1.4 equiv.) and DIPEA (244 μL, 1.4 mmol, 1.4 equiv.) using 2 (16 mg, 10 mol %) and 4-nitrobenzoic acid (17 mg, 10 mol %) in ethyl acetate (0.33 mL) at RT for h. The crude product was purified via flash column chromatography (benzene/pentane, 60:40, R_{f}=0.22) to afford 21 as an orange solid (166 mg, 91%, inseparable mixture, E/Z 78:22). E-21: ¹H NMR (400 MHz, CDCl₃) δ: 3.67 (s, 3H), 5.76 (d, J=16.4 Hz, 1H), 6.87 (s, 1H), 7.01-7.05 (m, 1H), 7.17-7.22 (m, 2H), 7.35 (d, J=16.4 Hz, 1H), 7.51 (d, J=8.0 Hz, 1H); ¹³C NMR (100 MHz, CDCl₃) δ: 30.1, 95.5, 104.0, 109.9, 118.7, 121.0, 121.7, 124.5, 127.3, 134.0, 138.4, 139.3; Z-21: ¹H NMR (400 MHz, CDCl₃) δ: 3.65 (s, 3H), 5.29 (d, J=12.0 Hz, 1H), 7.01-7.05 (m, 1H), 7.11 (d, J=12.0 Hz, 1H), 7.17-7.22 (m, 2H), 7.56 (s, 1H), 7.57 (d, J=8.0 Hz, 1H); ¹³C NMR (100 MHz, CDCl₃) δ: 27.7, 93.5, 106.4, 109.7, 118.0, 120.8, 122.3, 124.7, 127.4, 133.0, 135.7, 138.3; mp 87-94° C.; HRMS [M+H]⁺: m/z calcd. 183.0922. found 183.0916.

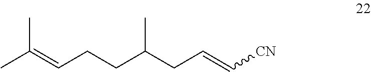

5,6-Dimethyldeca-2,8-dienenitrile (22) was obtained in accordance with general procedure 2 from the reaction of (±)-citronellal (180 μL, 1.0 mmol, 1.0 equiv.), bromoacetonitrile (91 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (pentane/benzene, 75:25, R_{f}=0.33) to afford an isomeric mixture of E- and Z-22 as a colorless oil (106 mg, 60%, E/Z 83:17). E-22: ¹H NMR (400 MHz, CDCl₃) δ: 0.88 (d, J=6.6 Hz, 3H), 1.13-1.34 (m, 2H), 1.58 (s, 3H), 1.66 (s, 3H), 1.89-2.07 (m, 3H), 2.19-2.24 (m, 1H), 5.05 ppm (t, J=6.9 Hz, 1H), 5.30 (d, J=16.3 Hz, 1H), 6.67 (dt, J=16.3, 7.8 Hz, 1H); Z-22: ¹H NMR (400 MHz, CDCl₃) δ: 0.93 (d, J=6.9 Hz, 3H), 1.19-1.26 (m, 1H), 1.32-1.39 (m, 1H), 1.60 (s, 3H), 1.67 (s, 3H), 1.93-2.06 (m, 2H), 2.26-2.32 (m, 1H), 2.39-2.45 (m, 1H), 5.07 (t, J=7.1 Hz, 1H), 5.34 (d, J=11.0 Hz, 1H), 6.48 (dt, J=11.0, 7.6 Hz, 1H).

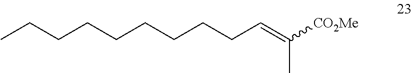 [SMILES: CCCCCCCCCC=C(C)C(=O)OC]

Methyl 2-methyldodec-2-enoate¹⁵ (23) was obtained in accordance with general procedure 2 from the reaction of decanal (200 μL, 1.0 mmol, 1.0 equiv.), methyl 2-bromopropionate (145 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (hexane/benzene, 75:25, R_{f}=0.33) to afford both E- and Z-23 as colorless oils (154 mg, 68%, E/Z 85:15). E-23: ¹H NMR (400 MHz, CDCl₃) δ: 0.87 (t, J=6.8 Hz, 3H), 1.26-1.31 (m, 12H), 1.42 (qn, J=7.2 Hz, 2H), 1.82 (br. d, J=1.6 Hz, 3H), 2.15 (qd, J=7.6, 0.8 Hz, 2H), 3.73 (s, 3H), 6.76 (tq, J=7.6, 1.2 Hz, 1H); Z-23: ¹H NMR (400 MHz, CDCl₃): δ 0.87 (t, J=6.8 Hz, 3H), 1.25-1.30 (m, 12H), 1.38 (qn, J=6.8 Hz, 2H), 1.88 (br. d, J=1.6 Hz, 3H), 2.43 (qd, J=7.2, 1.2 Hz, 2H), 3.72 (s, 3H), 5.93 (tq, J=7.2, 1.6 Hz, 1H).

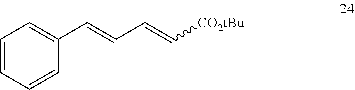 [SMILES: CC(C)(C)OC(=O)C=C/C=C/c1ccccc1]

tert-Butyl 5-phenylpenta-2,4-dieneoate¹⁶ (24) was obtained in accordance with general procedure 2 from the reaction of trans-cinnamaldehyde (126 μL, 1.0 mmol, 1.0 equiv.), tert-butyl bromoacetate (192 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (pentane/benzene, 60:40, R_{f}=0.33) to afford 24 as a colorless, viscous oil (195 mg, 84%, E/Z 87:13, Z-24 inseparable from E-24). E-24: ¹H NMR (400 MHz, CDCl₃) δ: 1.52 (s, 9H), 5.93 (d, J=15.2 Hz, 1H), 6.81-6.90 (m, 2H), 7.28-7.38 (m, 4H), 7.45-7.47 (m, 2H); Z-24: ¹H NMR (400 MHz, CDCl₃) δ: 1.53 (s, 9H), 5.65 (d, J=11.6 Hz, 1H), 6.67 (t, J=11.4 Hz, 1H), 6.79 (d, J=15.6 Hz, 1H), 7.28-7.34 (m, 3H), 7.52 (d, J=7.6 Hz, 2H), 8.13 (dd, J=11.4, 15.7 Hz, 1H).

24 was obtained in accordance with general procedure 3 from the reaction of trans-cinnamaldehyde (126 μL, 1.0 mmol, 1.0 equiv.), tert-butyl bromoacetate (192 μL, 1.3 mmol, 1.3 equiv.), 4-(trifluoromethyl)phenylsilane (220 μL, 1.4 mmol, 1.4 equiv.) and DIPEA (244 μL, 1.4 mmol, 1.4 equiv.) using triphenylphosphine oxide 4 (28 mg, 10 mol %) and 4-nitrobenzoic acid (17 mg, 10 mol %) in toluene (0.33 mL) at 100° C. for 24 h. The crude product was purified via flash column chromatography (pentane/benzene, 60:40, R_{f}=0.33) to afford 24 as a colorless, viscous oil (149 mg, 65%, E/Z 86:14).

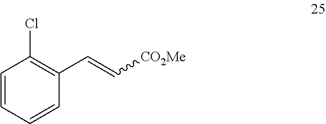 [SMILES: COC(=O)C=Cc1ccccc1Cl]

Methyl 3-(2-chlorophenyl)prop-2-enoate (25) was obtained in accordance with general procedure 2 from the reaction of 2-chlorobenzaldehyde (110 μL, 1.0 mmol, 1.0 equiv.), methyl bromoacetate (130 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (benzene/hexane, 50:50, R_{f}=0.30) to afford a mixture of E- and Z-25 as a colorless liquid (159 mg, 81%, E/Z 70:30). E-25: ¹H NMR (400 MHz, CDCl₃) δ: 3.82 (s, 3H), 6.43 (d, J=16.0 Hz, 1H), 7.25-7.33 (m, 2H), 7.41 (dd, J=7.2, 1.6 Hz, 1H), 7.61 (dd, J=7.3, 2.0 Hz, 1H), 8.10 (d, J=16.0 Hz, 1H); Z-25: ¹H NMR (400 MHz, CDCl₃) δ: 3.66 (s, 3H), 6.09 (d, J=12.4 Hz, 1H), 7.15 (d, J=12.4 Hz, 1H), 7.21-7.31 (m, 2H), 7.38 (dd, J=7.2, 2.0 Hz, 1H), 7.50 (dd, J=7.2, 2.0 Hz, 1H).

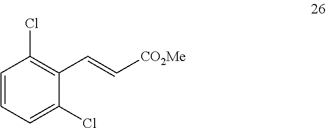 [SMILES: COC(=O)/C=C/c1c(Cl)cccc1Cl]

Methyl (2E)-3-(2,6-dichlorophenyl)prop-2-enoate (26) was obtained in accordance with general procedure 2 from the reaction of 2,6-dichlorobenzaldehyde (175 mg, 1.0 mmol, 1.0 equiv.), methyl bromoacetate (130 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (pentane/benzene, 75:25, R_{f}=0.33) to afford 26 as a white solid (161 mg, 70%, E/Z>95:5). ¹H NMR (400 MHz, CDCl₃) δ: 3.81 (s, 3H), 6.57 (d, J=16.4 Hz, 1H), 7.16 (t, J=8.1 Hz, 1H), 7.32 (d, J=8.1 Hz, 2H), 7.76 (d, J=16.4 Hz, 1H).

26 was obtained in accordance with general procedure 3 from the reaction of 2,6-dichlorobenzaldehyde (175 mg, 1.0 mmol, 1.0 equiv.), methyl bromoacetate (130 μL, 1.3 mmol, 1.3 equiv.), 4-(trifluoromethyl)phenylsilane (220 μL, 1.4 mmol, 1.4 equiv.) and DIPEA (244 μL, 1.4 mmol, 1.4 equiv.) using triphenylphosphine oxide 4 (28 mg, 10 mol %) and 4-nitrobenzoic acid (17 mg, 10 mol %) in toluene (0.33 mL) at 100° C. for 24 h. The crude product was purified via flash column chromatography (pentane/benzene, 75:25, R_{f}=0.33) to afford 26 as a white solid (162 mg, 70%, E/Z>95:5). When this reaction was carried out using phenylsilane (172 μL, 1.4 mmol, 1.4 equiv.) 26 was obtained in 60% yield (139 mg, E/Z>95:5).

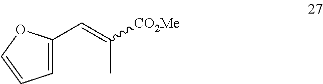

Methyl 3-(2-furyl)-2-methylprop-2-enoate (27) was obtained in accordance with general procedure 2 from the reaction of furfural (83 μL, 1.0 mmol, 1.0 equiv.), methyl bromopropionate (145 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (benzene/pentane, 50:50, R_{f}=0.33) to afford 27 as a yellow oil (146 mg, 88%, inseparable mixture, E/Z 85:15). E-27: ¹H NMR (400 MHz, CDCl₃) δ: 2.20 (s, 3H), 3.76 (s, 3H), 6.45 (dd, J=3.4, 1.8 Hz, 1H), 6.57 (d, J=3.6 Hz, 1H), 7.42 (br. s, 1H), 7.49 (d, J=1.2 Hz, 1H); Z-27: ¹H NMR (400 MHz, CDCl₃) δ: 2.05 (d, J=0.8 Hz, 3H), 3.77 (s, 3H), 6.38 (dd, J=3.6, 1.8 Hz, 1H), 6.49 (br. s, 1H), 6.90 (d, J=3.6 Hz, 1H), 7.35 (d, J=1.2 Hz, 1H).

E-27 was obtained in accordance with general procedure 3 from the reaction of furfural (83 μL, 1.0 mmol, 1.0 equiv.), methyl bromopropionate (145 μL, 1.3 mmol, 1.3 equiv.), 4-(trifluoromethyl)phenylsilane (220 μL, 1.4 mmol, 1.4 equiv.) and DIPEA (244 μL, 1.4 mmol, 1.4 equiv.) using triphenylphosphine oxide 4 (28 mg, 10 mol %) and 4-nitrobenzoic acid (17 mg, 10 mol %) in toluene (0.33 mL) at 100° C. for 24 h. The crude product was purified via flash column chromatography (benzene/pentane, 50:50, R_{f}=0.33) to afford 27 as a yellow oil (148 mg, 89%, E/Z>95:5). ¹H NMR (400 MHz, CDCl₃) δ: 2.20 (s, 3H), 3.76 (s, 3H), 6.45 (dd, J=3.4, 1.8 Hz, 1H), 6.57 (d, J=3.6 Hz, 1H), 7.42 (br. s, 1H), 7.49 (d, J=1.2 Hz, 1H). When this reaction was carried out using phenylsilane (172 μL, 1.4 mmol, 1.4 equiv.), 27 was obtained in 64% yield (106 mg, E/Z>95:5).

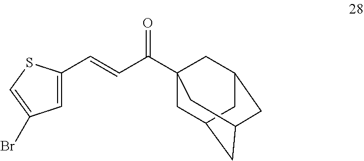 [SMILES: O=C(/C=C/c1cc(Br)cs1)C12CC3CC(CC(C3)C1)C2]

(2E)-3-(4-bromo-2-thienyl)-1-(adamant-1-yl)prop-2-en-1-one (28) was obtained in accordance with general procedure 2 from the reaction of 4-bromo-2-thiophenecarboxaldehyde (191 mg, 1.0 mmol, 1.0 equiv.), 1-(1-adamantyl)-2-bromoethanone (283 mg, 1.1 mmol, 1.1 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (benzene/pentane, 30:70, R_{f}=0.33) to afford 28 as a white solid (260 mg, 74%, E/Z>95:5). ¹H NMR (400 MHz, CDCl₃) δ: 1.70-1.79 (m, 6H), 1.84-1.85 (m, 6H), 2.08 (br. s, 3H), 6.92 (d, J=15.6 Hz, 1H), 7.19 (s, 1H), 7.24 (s, 1H), 7.65 (d, J=15.4 Hz, 1H); ¹³C NMR (100 MHz, CDCl₃) δ: 28.0, 36.7, 38.1, 45.6, 111.1, 120.4, 124.4, 132.8, 134.0, 141.4, 203.3; mp 93-96° C.; HRMS [M+H]⁺: m/z calcd. 351.0418. found 351.0421.

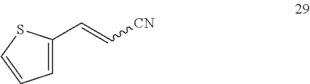

3-(2-Thienyl)prop-2-enenitrile (29) was obtained in accordance with general procedure 2 from the reaction of 2-thiophenecarboxaldehyde (93 μL, 1.0 mmol, 1.0 equiv.), bromoacetonitrile (91 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (pentane/benzene, 75:25, R_{f}=0.33) to afford an isomeric mixture of E- and Z-29 as a yellow oil (99 mg, 73%, E/Z 83:17). E-29: ¹H NMR (400 MHz, CDCl₃) δ: 5.63 (d, J=16.2 Hz, 1H), 7.07 (dd, J=5.0, 3.8 Hz, 1H), 7.24 (d, J=3.6 Hz, 1H), 7.41 (d, J=5.0 Hz, 1H), 7.46 (d, J=16.4 Hz, 1H); Z-29: ¹H NMR (400 MHz, CDCl₃) δ: 5.26 (d, J=11.6 Hz, 1H), 7.11 (dd, J=3.5, 4.8 Hz, 1H), 7.25 (d, J=11.6 Hz, 1H), 7.53 (d, J=5.1 Hz, 1H), 7.55 (d, J=3.6 Hz, 1H).

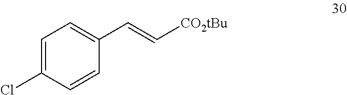 [SMILES: CC(C)(C)OC(=O)/C=C/c1ccc(Cl)cc1]

tert-Butyl 3-(4-chlorophenyl)prop-2-enoate (30) was obtained in accordance with general procedure 2 from the reaction of 4-chlorobenzaldehyde (145 mg, 1.0 mmol, 1.0 equiv.), tert-butyl bromoacetate (195 μL, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (39 mg, 10 mol %) and 4-nitrobenzoic acid (17 mg, 10 mol %) in toluene (0.33 mL) at 100° C. for 24 h. The crude product was purified via flash column chromatography (1% diethyl ether in pentane, R_{f}=0.28) to afford 30 as a white solid (182 mg, 76%, E/Z>95:5). ¹H NMR (400 MHz, CDCl₃) δ: 1.53 (s, 9H), 6.33 (d, J=16.0 Hz, 1H), 7.33 (d, J=8.4 Hz, 2H), 7.43 (d, J=8.4 Hz, 2H), 7.52 (d, J=16.0 Hz, 1H).

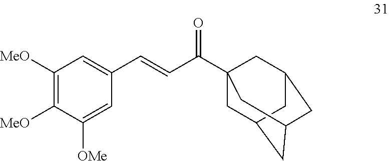 [SMILES: COc1cc(/C=C/C(=O)C23CC4CC(CC(C4)C2)C3)cc(OC)c1OC]

(2E)-1-(Adamant-1-yl)-3-(3,4,5-trimethoxyphenyl)prop-2-en-1-one (31) was obtained in accordance with general procedure 2 from the reaction of 3,4,5-trimethoxybenzaldehyde (200 mg, 1.0 mmol, 1.0 equiv.), 1-(1-adamantyl)-2-bromoethanone (291 mg, 1.1 mmol, 1.1 equiv.), phenylsilane (172 μL, 1.4 mmol, 1.4 equiv.) and DIPEA (244 μL, 1.4 mmol, 1.4 equiv.) using trioctylphosphine oxide 3 (77 mg, 20 mol %) and 4-nitrobenzoic acid (17 mg, 10 mol %) in toluene (0.33 mL) at 100° C. for 24 h. The crude product was purified via flash column chromatography (5% diethyl ether in benzene, R_{f}=0.25) to afford 31 as a white solid (246 mg, 69%, E/Z>95:5). ¹H NMR (400 MHz, CDCl₃) δ: 1.72-1.80 (m, 6H), 1.88-1.89 (m, 6H), 2.09 (br. s, 3H), 3.88 (s, 3H,), 3.91 (s, 6H), 6.78 (s, 2H), 7.02 (d, J=15.6 Hz, 1H), 7.58 (d, J=15.6 Hz, 1H); ¹³C NMR (100 MHz, CDCl₃) δ: 28.1, 36.7, 38.2, 45.6, 6.3, 61.1, 105.5, 119.6, 130.7, 140.1, 143.2, 153.5, 203.8; mp 139-142° C.; HRMS [M+H]⁺: m/z calcd. 357.2066. found 357.2075.

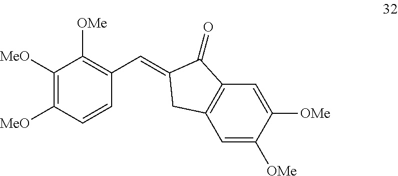 [SMILES: COc1cc2c(cc1OC)C(=O)/C(=C/c1ccc(OC)c(OC)c1OC)C2]

(2E)-5,6-Dimethoxy-2-(2,3,4-trimethoxybenzylidene)-2,3-dihydro-1H-inden-1-one (32) was obtained in accordance with general procedure 2 from the reaction of 2,3,4-trimethoxybenzaldehyde (196 mg, 1.0 mmol, 1.0 equiv.), 2-bromo-5,6-dimethoxy-2,3-dihydro-1H-inden-1-one (351 mg, 1.3 mmol, 1.3 equiv.), phenylsilane (172 μL, 1.4 mmol, 1.4 equiv.) and DIPEA (244 μL, 1.4 mmol, 1.4 equiv.) using trioctylphosphine oxide 3 (77 mg, 20 mol %), 4-nitrobenzoic acid (4 mg, 2.5 mol %) and tetrabutylammonium tetrafluoroborate (58 mg, 17.5 mol %) in toluene (2.00 mL) at 100° C. for 24 h. The crude product was purified via flash column chromatography (diethyl ether/benzene, 50:50, R_{f}=0.29) to afford 32 as a yellow solid (263 mg, 71%, E/Z>95:5). ¹H NMR (400 MHz, CDCl₃) δ: 3.84 (d, J=1.2 Hz, 2H), 3.88 (s, 3H), 3.90 (s, 3H), 3.92 (s, 3H), 3.93 (s, 3H), 3.96 (s, 3H), 6.72 (d, J=8.8 Hz, 1H), 6.93 (s, 1H), 7.31 (s, 1H), 7.37 (d, J=8.8 Hz, 1H), 7.88 (t, J=1.6 Hz, 1H); ¹³C NMR (100 MHz, CDCl₃) δ: 32.3, 56.2, 56.3, 56.4, 61.1, 62.0, 105.2 107.2, 107.4, 122.9, 124.7, 126.8, 131.5, 134.4, 142.6, 144.8, 149.6, 154.4, 155.1, 155.2, 193.2; mp 176-177° C.; HRMS [M+H]⁺: m/z calcd. 371.1495. found 371.1508.

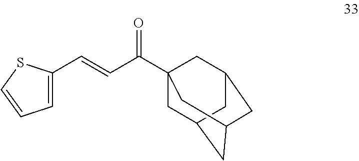 [SMILES: O=C(/C=C/c1cccs1)C12CC3CC(CC(C3)C1)C2]

3-(2-Thienyl)-1-(adamant-1-yl)prop-2-en-1-one (33) was obtained in accordance with general procedure 3 from the reaction of 2-thiophenecarboxaldehyde (95 μL, 1.0 mmol, 1.0 equiv.), 1-(1-adamantyl)-2-bromoethanone (283 mg, 1.1 mmol, 1.1 equiv.), 4-(trifluoromethyl)phenylsilane (220 μL, 1.4 mmol, 1.4 equiv.) and DIPEA (244 μL, 1.4 mmol, 1.4 equiv.) using triphenylphosphine oxide 4 (28 mg, 10 mol %) and 4-nitrobenzoic acid (17 mg, 10 mol %) in toluene (0.33 mL) at 100° C. for 24 h. The crude product was purified via flash column chromatography (benzene/pentane, 50:50, R_{f}=0.33) to afford 33 as a white solid (174 mg, 64%, E/Z 92:8 in crude, only E-33 isolated). ¹H NMR (400 MHz, CDCl₃) δ: 1.71-1.79 (m, 6H), 1.87 (br. s, 6H), 2.08 (br. s, 3H), 6.92 (d, J=15.2 Hz, 1H), 7.04 (dd, J=4.8, 3.6 Hz, 1H), 7.28 (d, J=3.6 Hz, 1H), 7.35 (d, J=5.2 Hz, 1H), 7.78 (d, J=15.6 Hz, 1H); ¹³C NMR (100 MHz, CDCl₃) δ: 28.0, 36.6, 38.1, 45.4, 119.3, 128.1, 128.2, 131.6, 135.4, 140.6, 203.6; mp 81-83° C.; HRMS [M+H]⁺: m/z calcd. 273.1313. found 273.1320.

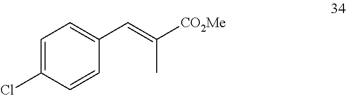

Methyl (2E)-3-(4-chlorophenyl)-2-methylprop-2-enoate (34) was obtained in accordance with general procedure 3 from the reaction of 4-chlorobenzaldehyde (141 mg, 1.0 mmol, 1.0 equiv.), methyl 2-bromopropionate (145 μL, 1.3 mmol, 1.3 equiv.), 4-(trifluoromethyl)phenylsilane (220 μL, 1.4 mmol, 1.4 equiv.) and DIPEA (244 μL, 1.4 mmol, 1.4 equiv.) using triphenylphosphine oxide 4 (28 mg, 10 mol %) and 4-nitrobenzoic acid (17 mg, 10 mol %) in toluene (0.33 mL) at 100° C. for 24 h. The crude product was purified via flash column chromatography (5% ethyl acetate in hexane, 95:5, R_{f}=0.33) to afford 34 as a colorless liquid (179 mg, 85%, E/Z>95:5). ¹H NMR (400 MHz, CDCl₃) δ: 2.08 (d, J=1.5 Hz, 3H), 3.80 (s, 3H), 7.29-7.35 (m, 4H), 7.61 (br. s, 1H). When this reaction was carried out using phenylsilane (172 μL, 1.4 mmol, 1.4 equiv.), 34 was obtained in 63% yield (133 mg, E/Z>95:5).

### Synthetic Procedures—the Second Aspect of the Invention

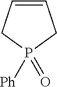 [SMILES: O=P1(c2ccccc2)CC=CC1]

1-Phenyl-3-phospholene-1-oxide: A flame-dried sealed tube was charged with 2,6-di-t-butyl-4-methylphenol (110 mg, 0.5 mmol, 0.5 mol %) under nitrogen. 1,3-Butadiene (14.0 mL, 0.3 mol, 3.0 equiv.) was introduced by condensation at −78° C. in a liquid nitrogen/acetone bath, after which P,P-dichlorophenylphosphine (13.6 mL, 0.1 mol, 1.0 equiv.) was added. The tube was sealed and allowed to stand in darkness at RT for 15 days. After removal of excess 1,3-butadiene, ice water (30 mL) was added to the remaining red-brown viscous oil, which was stirred vigorously until residues dissolved fully. The solution was extracted in dichloromethane (3×30 mL) and the combined organic layers were neutralized using sodium carbonate (effervescence observed). The resultant solution was filtered, dried with magnesium sulfate, filtered and the solvent removed in vacuo to give a yellow-orange oil. Purification by dry flash column chromatography (methanol/dichloromethane, gradient 4-8%) yielded 1-phenyl-3-phospholene-1-oxide as a pale green solid (5.2 g, 30%). ¹H and ³¹P NMR spectra are consistent with literature.

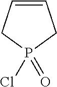

1-Chloro-3-phospholene-1-oxide: A flame-dried sealed tube (100 mL ChemGlass CG-1880-25 or 125 mL AceGlass 8648-96) equipped with a stir-bar was charged with 2,6-di-t-butyl-4-methylphenol (55 mg, 0.25 mmol, 0.5 mol %) under nitrogen. 1,3-Butadiene (6.8 mL, 0.15 mol, 3.0 equiv.) was introduced by condensation at −78° C. in a liquid nitrogen/acetone bath, after which phosphorus trichloride (4.4 mL, 0.05 mol, 1.0 equiv.) and tris(2-chloroethyl)phosphite (6.0 mL, 0.03 mol, 0.6 equiv.) were introduced via syringe. The tube was sealed under nitrogen using a front-sealing bushing (back sealing bushings are unsuitable, as contact with hot reaction vapors causes swelling, resulting in loss of seal). The solution was stirred at 105° C. for 48 hours. A blast shield was placed around the reaction vessel for the duration of the reaction. A cloudy yellow solution resulted, which was filtered via needle cannula. 1,2-Dichloroethane was removed in vacuo and the resultant pale yellow solid was shown to consist of 1-chloro-3-phospholene-1-oxide and 1-hydroxy-3-phospholene-1-oxide (90:10). ¹H and ³¹P NMR spectra are consistent with literature. Product was used without further purification.

General procedure for 3-phospholene-1-oxide preparation: A round-bottom flask equipped with a stir-bar and reflux condenser was charged with magnesium turnings (1.2 equiv.), then flame dried in vacuo. Iodine (one crystal) and THF (1.0 mL) were introduced. A solution of organohalide (1.0 equiv) in THF was added dropwise until the brown color dissipated and the reaction was initiated by heating. The remaining organohalide solution was added slowly, maintaining reflux, and the resultant solution was stirred at reflux for a further 1 h. To a portion of this Grignard reagent (1.0 equiv.) at 0° C. was added 1-chloro-3-phospholene-1-oxide solution dropwise (1.0 equiv., 1 M in THF. Introduction of THF to crude 1-chloro-3-phospholene-1-oxide led to precipitation of the 1-hydroxy-3-phospholene by-product. 1-Chloro-3-phospholene-1-oxide solution was obtained following needle cannulation). The resultant solution was allowed to warm to RT and stirred for 16 h. The reaction mixture was quenched with water and the aqueous layer was extracted with diethyl ether (3×20 mL). The combined organic layers were dried over magnesium sulfate, filtered and solvent removed in vacuo to give the crude 3-phospholene-1-oxide. Purification by flash column chromatography yielded pure 3-phospholene-1-oxide.

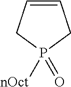

1-n-Octyl-3-phospholene-1-oxide was prepared according to the general procedure from the reaction of magnesium turnings (0.29 g, 12.0 mmol, 1.2 equiv.), 1-bromooctane (1.7 mL, 10.0 mmol, 1.0 equiv., 1 M in THF) and 1-chloro-3-phospholene-1-oxide (0.98 g, 7.2 mmol, 1.0 equiv.). Purification by flash column chromatography (methanol/dichloromethane, gradient 1-3%) gave 1-n-octyl-3-phospholene-1-oxide as a yellow oil (0.93 g, 64%). ¹H NMR (400 MHz, CDCl₃) δ: 0.67 (t, J=7.2 Hz, 3H), 1.06-1.12 (m, 8H), 1.18-1.25 (m, 2H), 1.39-1.49 (m, 2H), 1.62-1.69 (m, 2H), 2.22-2.38 (m, 4H), 5.67 (d, J=27.2 Hz, 2H); ¹³C NMR (100 MHz, CDCl₃) δ: 13.8, 21.6 (d, J_{CP}=3.5 Hz), 22.3, 28.7 (d, J_{CP}=9.4 Hz), 29.4 (d, J_{CP}=62.5 Hz), 30.6, 30.7 (d, J_{CP}=13.1 Hz), 31.3 (d, J_{CP}=23.3 Hz), 127.0 (d, J_{CP}=10.9 Hz); ³¹P NMR (162 MHz, CDCl₃) δ: 68.1; HRMS [M+H]⁺ m/z calcd. 215.1565. found 215.1557.

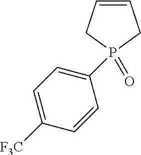 [SMILES: O=P1(c2ccc(C(F)(F)F)cc2)CC=CC1]

1-(4-(Trifluoromethyl)phenyl)-3-phospholene-1-oxide was prepared according to the general procedure from the reaction of magnesium turnings (0.72 g, 36.0 mmol, 1.2 equiv.), 4-bromobenzotrifluoride (4.2 mL, 30.0 mmol, 1.0 equiv., 1 M in THF) and 1-chloro-3-phospholene-1-oxide (3.60 g, 26.3 mmol, 1.0 equiv.). Purification by flash column chromatography (methanol/dichloromethane, gradient 0.5-1.0%) gave 1-(4-(trifluoromethyl)phenyl)-3-phospholene-1-oxide as a white solid (3.21 g, 49%). ¹H NMR (400 MHz, CDCl₃) δ: 2.64-2.88 (m, 4H), 6.02 (d, J=30.0 Hz, 2H), 7.69 (dd, J=8.0, 1.6 Hz, 2H), 7.85 (dd, J=11.2, 8.8 Hz, 2H); ¹³C NMR (100 MHz, CDCl₃) δ: 33.9 (d, J_{CP}=67.6 Hz), 123.6 (q, J_{CF}=272.1 Hz), 125.6 (dq, J_{CF}=4.4 Hz, J_{CP}=11.6 Hz), 128.0 (d, J_{CP}=11.7 Hz), 130.2 (d, J_{CP}=10.2 Hz), 133.9 (qd, J_{CP}=2.9 Hz, J_{CF}=32.8 Hz), 138.4 (d, J_{CP}=88.0 Hz); ³¹P NMR (162 MHz, CDCl₃) δ: 55.3; ¹⁹F NMR (376 MHz, CDCl₃) δ: −63.3; HRMS [M+H]⁺ m/z calcd. 247.0500. found 247.0493.

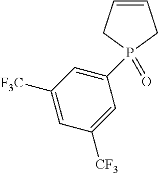 [SMILES: O=P1(c2cc(C(F)(F)F)cc(C(F)(F)F)c2)CC=CC1]

1-(3,5-Bis(trifluoromethyl)phenyl)-3-phospholene-1-oxide was prepared according to the general procedure from the reaction of magnesium turnings (0.69 g, 28.8 mmol, 1.2 equiv.), 1,3-bis(trifluoromethyl)-5-bromobenzene (4.1 mL, 24.0 mmol, 1.0 equiv., 0.5 M in THF) and 1-chloro-3-phospholene-1-oxide (3.00 g, 21.9 mmol, 1.0 equiv.). Purification by flash column chromatography (methanol/dichloromethane, gradient 0.5-1.0%) gave 1-(3,5-bis(trifluoromethyl)phenyl)-3-phospholene-1-oxide as a white solid (3.51 g, 51%). ¹H NMR (400 MHz, CDCl₃) δ: 2.35-1.52 (m, 4H), 5.71 (d, J=30.0 Hz, 2H), 7.60 (s, 1H), 7.82 (d, J=10.8 Hz, 2H); ¹³C NMR (100 MHz, CDCl₃) δ: 32.8 (d, J_{CP}=68.4 Hz), 122.2 (q, J_{CF}=271.3 Hz), 124.9 (m), 127.3 (d, J_{CP}=11.6 Hz), 129.3 (br. dd, J_{CF}=2.9 Hz, J_{CP}=9.4 Hz), 131.4 (qd, J_{CP}=10.9 Hz, J_{CF}=33.5 Hz), 137.2 (d, J_{CP}=86.6 Hz); ³¹P NMR (162 MHz, CDCl₃) δ: 53.9; ¹⁹F NMR (376 MHz, CDCl₃) δ: −63.8; HRMS [M+H]⁺ m/z calcd. 315.0373. found 315.0384.

General procedure for preparation of phospholane-1-oxides via hydrogenation of 3-phospholene-1-oxides: Pd/C (10% w/w, 6-10 mol %) was transferred to a round-bottom flask containing a magnetic stir-bar and sealed under nitrogen. Dichloromethane (trace) was added, followed by 3-phospholene-1-oxide dissolved in methanol (0.35 M). The vessel was purged with hydrogen using a balloon and silicon oil bubbler. The bubbler was removed and the mixture was stirred under hydrogen at room temperature for 24 h. The crude mixture was filtered through a plug of Celite® and solvent removed in vacuo to yield pure 3-phospholane-1-oxide.

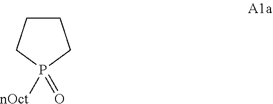

0001-n-Octylphospholane-1-oxide (A1a) was obtained in accordance with the general procedure, from the reaction of 1-n-octyl-3-phospholene-1-oxide (0.93 g, 4.3 mmol, 1.0 equiv.) with an excess of H₂ using Pd/C (10% w/w; 0.42 g, 0.4 mmol, 10 mol %) in a methanol/dichloromethane solution (4:1 mL) at room temperature for 24 h. A1a was obtained as a colorless oil (0.90 g, 97%). ¹H NMR (400 MHz, CDCl₃) δ: 0.69 (t, J=7.2 Hz, 3H), 1.08-1.10 (m, 8H), 1.20-1.27 (m, 2H), 1.42-1.69 (m, 10H), 1.78-1.88 (m, 2H); ¹³C NMR (100 MHz, CDCl₃) δ: 13.8, 21.9 (d, J_{CP}=4.4 Hz), 22.3, 24.3 (d, J_{CP}=8.0 Hz), 26.6 (d, J_{CP}=64.9 Hz), 28.8 (d, J_{CP}=10.9 Hz), 30.6 (d, J_{CP}=61.8 Hz), 30.8 (d, J_{CP}=13.1 Hz), 31.5; ³¹P NMR (162 MHz, CDCl₃) δ: 71.4; HRMS [M+H]⁺ m/z calcd. 217.1721. found 217.1717.

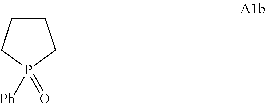 [SMILES: O=P1(c2ccccc2)CCCC1]

1-Phenylphospholane-1-oxide (A1b) was prepared in accordance with the general procedure, from the reaction of 1-phenyl-3-phospholene-1-oxide (1.79 g, 10.0 mmol, 1.0 equiv.) with an excess of H₂ using Pd/C (10% w/w; 1.10 g, 1.0 mmol, 10 mol %) in methanol/dichloromethane solution (30:1 mL) at room temperature for 24 h. A1b was obtained as a pale yellow, viscous oil (1.80 g, 99%). ¹H and ³¹P NMR spectra are consistent with literature.

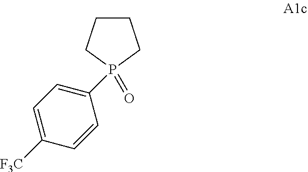 [SMILES: O=P1(c2ccc(C(F)(F)F)cc2)CCCC1]

0001-(4-(Trifluoromethyl)phenyl)phospholane-1-oxide (A1c) was obtained in accordance with the general procedure, from the reaction of 1-(4-(trifluoromethyl)phenyl)-3-phospholene-1-oxide (2.36 g, 9.6 mmol, 1.0 equiv.) with an excess of H₂ using Pd/C (10% w/w; 0.96 g, 0.9 mmol, 9 mol %) in a methanol/dichloromethane solution (11:1 mL) at room temperature for 24 h. A1c was obtained as a white solid (2.21 g, 93%). ¹H NMR (400 MHz, CDCl₃) δ: 1.88-2.22 (m, 8H), 7.88 (dd, J=8.4, 2.0 Hz, 2H), 7.82 (dd, J=10.8, 8.0 Hz, 2H); ¹³C NMR (100 MHz, CDCl₃) δ: 25.3 (d, J_{CP}=8.7 Hz), 29.7 (d, J_{CP}=67.6 Hz), 123.6 (q, J_{CF}=270.8 Hz), 125.5 (dq, J_{CP}=3.6 Hz, J_{CF}=11.6 Hz), 130.5 (d, J_{CP}=10.2 Hz), 133.6 (qd, J_{CP}=3.0 Hz, J_{CF}=29.8 Hz), 138.9 (d, J_{CP}=85.9 Hz); ³¹P NMR (162 MHz, CDCl₃) δ: 57.2; ¹⁹F NMR (376 MHz, CDCl₃) δ: −63.2; mp 59-61° C.; HRMS [M+H]⁺ m/z calcd. 249.0656. found 249.0658.

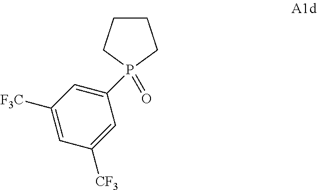 [SMILES: O=P1(c2cc(C(F)(F)F)cc(C(F)(F)F)c2)CCCC1]

0001-(3,5-Bis(trifluoromethyl)phenyl)phospholane-1-oxide (A1d) was obtained in accordance with the general procedure, from the reaction of 1-(3,5-bis(trifluoromethyl)phenyl)-3-phospholene-1-oxide (3.50 g, 11.1 mmol, 1.0 equiv.) with an excess of H₂ using Pd/C (10% w/w; 1.08 g, 1.0 mmol, 10 mol %) in a methanol/dichloromethane solution (30:1 mL) at room temperature for 24 h. A1d was obtained as a yellow solid (3.42 g, 97%). ¹H NMR (400 MHz, CDCl₃) δ: 1.87-2.19 (m, 8H), 7.89 (s, 1H), 8.07 (d, J=10.8 Hz, 2H); ¹³C NMR (100 MHz, CDCl₃) δ: 25.2 (d, J_{CP}=34.8 Hz), 29.6 (d, J_{CP}=68.4 Hz), 122.8 (q, J_{CF}=271.4 Hz), 125.3 (m), 130.1 (dd, J_{CP}=2.9 Hz, J_{CF}=9.5 Hz), 132.1 (qd, J_{CP}=10.9 Hz, J_{CF}=33.4 Hz), 138.1 (d, J_{CP}=83.7 Hz); ³¹P NMR (162 MHz, CDCl₃) δ: 54.98; ¹⁹F NMR (376 MHz, CDCl₃) δ: −63.17; mp 82-85° C.; HRMS [M+H]⁺ m/z calcd. 317.0530. found 317.0530.

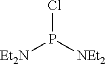

N,N,N′,N′-Tetraethylphosphorodiamidous chloride was prepared by slow addition of a solution of trichlorophosphine (4.4 mL, 0.05 mol in dry hexane (9 mL)) to a stirring solution of diethylamine (20.7 mL, 0.20 mol in dry hexane (100 mL)) at 0° C. A large quantity of white precipitate was formed immediately. The reaction solution was stirred at 0° C. for 30 min, allowed to warm to RT and brought to reflux (70° C.) for 48 h. The reaction vessel was cooled and the solution filtered rapidly through Celite® under a flow of nitrogen and washed with dry hexane. Solvent removed in vacuo to give crude N,N,N′,N′-Tetraethylphosphorodiamidous chloride as a pale yellow viscous liquid (8.85 g, 84%). ³¹P NMR (162 MHz, CDCl₃) δ: 160.1 ppm (consistent with literature). Used without purification.

General procedure for preparation of dichloroarylphospines: A round-bottom flask equipped with a stir-bar and reflux condenser was charged with magnesium turnings (1.1 equiv.), then flame dried in vacuo. Iodine (one crystal) and diethyl ether (1.0 mL) were introduced. A solution of arylbromide (1.0 equiv, 1.0 M) in diethyl ether was added dropwise until the brown color dissipated and the reaction was initiated by heating. The remaining organohalide solution was added slowly, maintaining reflux, and the resultant solution was stirred at RT for a further 1 h yielding a dark brown solution.

The resultant Grignard reagent (1.1 equiv.) was transferred via syringe to a dried flask equipped with stirbar and cooled to 0° C. N,N,N′,N′-Tetraethylphosphoro-diamidous chloride (1.0 equiv.) was added dropwise at 0° C., and the resultant solution was warmed slowly to RT and stirred overnight (16 h). The reaction solution was cooled to −78° C. (acetone/liquid nitrogen bath) and vigorous stirring maintained. Hydrogen chloride solution (2.0 M in diethyl ether; 5.0 equiv) was added slowly. Reaction warmed to RT and stirred at RT overnight (16 h). Solvent removed in vacuo, dry hexane added and the resultant precipitate removed by rapid filtration through Celite® (under a flow of nitrogen). Solvent removed in vacuo to give crude dichloroarylphosphine, which was used without purification.

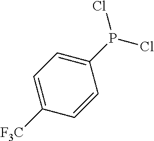 [SMILES: FC(F)(F)c1ccc(P(Cl)Cl)cc1]

4-(Trifluoromethyl)phenylphosphonous dichloride was prepared according to the general procedure using the Grignard reagent formed from reaction of magnesium turnings (1.34 g, 55.0 mmol, 1.1 equiv.) and 4-bromobenzotrifluoride (7.0 mL, 50.0 mmol, 1.1 equiv., 1.0 M in dry diethyl ether). The Grignard reagent (1.0 M solution; 50 mL, 50.0 mmol, 1.1 equiv.) was reacted with N,N,N′,N′-tetraethylphosphorodiamidous chloride (9.90 g, 47.0 mmol, 1.0 equiv.) and the resultant solution treated using hydrogen chloride solution (2.0 M in diethyl ether; 120 mL, 235.0 mmol, 5.0 equiv.). Crude 4-(trifluoromethyl)phenylphosphonous dichloride was obtained as a yellow liquid (9.68 g, 39.0 mmol, 83%), which was used without purification. ¹H NMR (400 MHz, CDCl₃) δ: 7.78 (d, J=8.0 Hz, 2H), 8.03 (t, J=8.0 Hz, 2H); ¹⁹F NMR (376 MHz, CDCl₃) δ: −63.2; ³¹P NMR (162 MHz, CDCl₃) δ: 156.3.

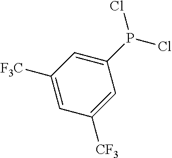 [SMILES: FC(F)(F)c1cc(P(Cl)Cl)cc(C(F)(F)F)c1]

3,5-Bis(trifluoromethyl)phenylphosphonous dichloride was prepared according to the general procedure using the Grignard reagent formed from reaction of magnesium turnings (1.34 g, 55.0 mmol, 1.1 equiv.) and 1,3-bis(trifluoromethyl)-5-bromobenzene (8.6 mL, 50.0 mmol, 1.1 equiv., 0.5 M in dry diethyl ether). The Grignard reagent (0.5 M solution; 100 mL, 50.0 mmol, 1.1 equiv.) was reacted with N,N,N′,N′-tetraethylphosphorodiamidous chloride (9.90 g, 47.0 mmol, 1.0 equiv.) and the resultant solution treated using hydrogen chloride solution (2.0 M in diethyl ether; 120 mL, 235.0 mmol, 5.0 equiv.). Crude 3,5-bis(trifluoromethyl)phenylphosphonous dichloride was obtained as a brown-orange liquid (13.98 g, 44.0 mmol, 94%), which was used without purification. ¹H NMR (400 MHz, CDCl₃) δ: 8.05 (s, 1H), 8.33 (d, J=6.8 Hz, 2H); ¹⁹F NMR (376 MHz, CDCl₃) δ: −63.0; ³¹P NMR (162 MHz, CDCl₃) δ: 151.4.

General procedure for the preparation of 9-aryl-9-phosphabicyclo[4.2.1]nonatriene oxides: To a flame dried round bottom flask with stirbar was added lithium (25% w/w in mineral oil; 2.1 equiv.). Mineral oil removed by successive washes using dry n-pentane (5×10 mL) and dried under a flow of argon. Dry diethyl ether (0.47 M) was added, followed by cyclooctatetraene (1.0 equiv). Stirred at RT overnight (18 h). Resultant suspension transferred via syringe to a stirring solution of dichloroarylphosphine (2.2-2.8 equiv.) in diethyl ether (2.7 M) at 0° C. The resultant suspension was stirred at RT (3-16 h). The reaction was quenched using water and neutralized using saturated sodium carbonate solution. The resultant solution was filtered through Celite® to remove precipitate. Aqueous layer washed using diethyl ether. Combined organic layers dried over magnesium sulfate, filtered and solvent removed in vacuo. Toluene was added and the solution refluxed for 1.5 h.

Solvent removed in vacuo and the crude 9-aryl-9-phosphabicyclo[4.2.1]nonatriene was used without purification in next step.

To a stirring solution of 9-aryl-9-phosphabicyclo[4.2.1]nonatriene (1.0 equiv.) in chloroform (0.5 M) at 0° C. was added hydrogen peroxide (35% w/w; 2.9 equiv.). The resultant biphasic solution was stirred vigorously for 3 h. Additional water was added and the layers separated. The aqueous layer was washed with chloroform and the combined organic layers dried over magnesium sulfate, filtered and dried in vacuo. Purification by column chromatography yielded pure 9-aryl-9-phosphabicyclo[4.2.1]-nonatriene oxide.

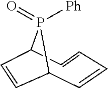 [SMILES: O=P1(c2ccccc2)C2C=CC=CC1C=C2]

9-Phenyl-9-phosphabicyclo[4.2.1]nonatriene oxide was prepared in accordance with the general procedure. Cyclooctatetraene-lithium dianion solution, prepared from the reaction of lithium (25% w/w in mineral oil; 1.7 g, 61.0 mmol, 2.1 equiv.) and cyclooctatetraene (3.3 mL, 29.0 mmol, 1.0 equiv), was added via syringe to a stirring solution of phenyldichlorophosphine (8.9 mL, 63.8 mmol, 2.2 equiv.) in diethyl ether (30 mL) at 0° C. Residues transferred using additional diethyl ether (30 mL). The resulting suspension was stirred at 0° C. for 3 h, quenched using water (16 mL) and neutralized using saturated sodium carbonate solution (40 mL). Following extraction, drying and filtration a yellow liquid was obtained. Toluene (100 mL) was added and the solution refluxed for 1.5 h, during which time the solution turned deep brown in color. Removal of solvent in vacuo gave crude phosphine as a brown oil (6.11 g, 28.8 mmol, 94%). To a stirring solution of crude 9-phenyl-9-phosphabicyclo[4.2.1]nonatriene in chloroform (60 mL) at 0° C. was added hydrogen peroxide solution (30% w/w; 7.2 mL, 72.5 mmol, 2.5 equiv.). The resultant biphasic solution was slowed warmed to RT and stirred overnight (16 h). Additional water (60 mL) was added and the layers separated. The aqueous layer was washed with chloroform (3×70 mL) and the combined organic layers dried over magnesium sulfate, filtered and dried in vacuo to give a yellow solid. Purification by flash column chromatography (methanol/dichloromethane; gradient 0.0-2.0%) gave 9-phenyl-9-phosphabicyclo[4.2.1]nonatriene oxide as a pale yellow solid (3.31 g, 14.5 mmol, 50%). ¹H NMR (400 MHz, CDCl₃) δ: 3.43-3.50 (m, 2H), 5.48-5.54 (m, 2H), 5.82-6.02 (m, 4H), 7.39-7.44 (m, 2H), 7.49-7.54 (m, 1H), 7.71-7.76 (m, 2H); ³¹P NMR (162 MHz, CDCl₃) δ: 41.4.

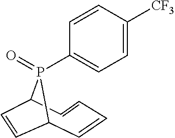 [SMILES: O=P1(c2ccc(C(F)(F)F)cc2)C2C=CC=CC1C=C2]

9-(4-Trifluoromethylphenyl)-9-phosphabicyclo[4.2.1]nonatriene oxide was prepared in accordance with the general procedure. Cyclooctatetraene-lithium dianion solution, prepared from the reaction of lithium (25% w/w in mineral oil; 0.81 g, 29.0 mmol, 2.1 equiv.) and cyclooctatetraene (1.6 mL, 14.0 mmol, 1.0 equiv), was added via syringe to a stirring solution of crude 4-(trifluoromethyl)phenylphosphonous dichloride (9.68 g, 39.0 mmol, 2.2 equiv.) in diethyl ether (15 mL) at 0° C. Residues transferred using additional diethyl ether (15 mL). The resulting pale orange suspension was allowed to warm to RT and stirred for 18 h, cooled to 0° C., quenched using water (8 mL) and neutralized using saturated sodium carbonate solution (20 mL). A large quantity of precipitate formed, and the solution was filtered through Celite® and washed with diethyl ether. Following extraction, drying and filtration a yellow oil was obtained. Toluene (30 mL) was added and the solution refluxed for 1.5 h, during which time the solution turned deep brown in colour. Removal of solvent in vacuo gave crude phosphine as a brown oil (3.68 g, 13.2 mmol, 94%). To a stirring solution of crude 9-(4-trifluoromethylphenyl)-9-phosphabicyclo[4.2.1]nonatriene in chloroform (30 mL) at 0° C. was added hydrogen peroxide solution (35% w/w; 2.8 mL, 32.5 mmol, 2.5 equiv.). The resultant biphasic solution was slowed warmed to RT and stirred for 2 h. Additional water (30 mL) was added and the layers separated. The aqueous layer was washed with chloroform (3×30 mL) and the combined organic layers dried over magnesium sulfate, filtered and dried in vacuo to give a pale yellow solid. Purification by flash column chromatography (methanol/dichloromethane; gradient 0.0-4.0%) gave 9-(4-trifluoromethylphenyl)-9-phosphabicyclo[4.2.1]nonatriene oxide as a pale yellow solid (1.09 g, 3.7 mmol, 26%). ¹H NMR (400 MHz, CDCl₃) δ: 3.45-3.51 (m, 2H), 5.48-5.54 (m, 2H), 5.81-6.01 (m, 4H), 7.65 (br. dd, J=8.4 Hz, 2.0 Hz, 2H), 7.87 (dd, J=11.6 Hz, 7.6 Hz, 2H); ¹³C NMR (100 MHz, CDCl₃) δ: 42.8 (d, J_{CP}=62.6 Hz), 123.3 (d, J_{CP}=7.3 Hz), 123.6 (q, J_{CF}=271.3 Hz), 125.1 (dq, J_{CP}=12.3 Hz, J_{CF}=3.7 Hz), 127.1 (d, J_{CP}=2.9 Hz), 129.2 (d, J_{CP}=1.5 Hz), 131.3 (d, J_{CP}=9.5 Hz), 133.6 (qd, J_{CP}=2.9 Hz, J_{CF}=32.7 Hz), 135.0 (d, J_{CP}=95.3 Hz); ³¹P NMR (162 MHz, CDCl₃) δ: 40.5; ¹⁹F NMR (376 MHz, CDCl₃) δ: −63.2; HRMS [M+H]⁺ m/z calcd 297.0651. found 297.0653.

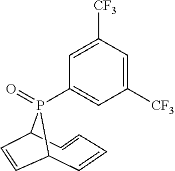 [SMILES: O=P1(c2cc(C(F)(F)F)cc(C(F)(F)F)c2)C2C=CC=CC1C=C2]

9-(3,5-Bis(trifluoromethyl)phenyl)-9-phosphabicyclo[4.2.1]nonatriene oxide was prepared in accordance with the general procedure. Cyclooctatetraene-lithium dianion solution, prepared from the reaction of lithium (25% w/w in mineral oil; 0.81 g, 29.0 mmol, 2.1 equiv.) and cyclooctatetraene (1.6 mL, 14.0 mmol, 1.0 equiv), was added via syringe to a stirring solution of crude 3,5-bis(trifluoromethyl)phenylphosphonous dichloride (13.98 g, 44.0 mmol, 3.1 equiv.) in diethyl ether (15 mL) at 0° C. Residues transferred using additional diethyl ether (15 mL). The resulting suspension was allowed to warm to RT and stirred for 18 h, cooled to 0° C., quenched using water (8 mL) and neutralized using saturated sodium carbonate solution (20 mL). Allowed to warm to RT and stirred for 1 h. A small quantity of precipitate was observed and removed by filtration through Celite®. Following extraction, drying and filtration a foamy orange residue was obtained. Toluene (60 mL) was added and the solution refluxed for 4.5 h, during which time the residue dissipated and colour deepened. Removal of solvent in vacuo gave crude phosphine as an orange-white solid (12.35 g, >100%). To a stirring solution of crude 9-(3,5-bis(trifluoromethyl)phenyl)-9-phosphabicyclo[4.2.1]nonatriene in chloroform (50 mL) at 0° C. was added hydrogen peroxide solution (35% w/w; 5.0 mL, 58.1 mmol, 4.2 equiv.). The reaction solution was brought to RT and stirred for 2 h. Water (30 mL) was added and a large quantity of precipitate was observed in the organic layer. The biphasic suspension was filtered through Celite®, filtrate transferred to a separating funnel and the layers separated. The aqueous layer was washed with chloroform (3×75 mL) and the combined organic layers dried over magnesium sulfate, filtered and dried in vacuo to give a pale orange waxy solid. Purification by flash column chromatography (methanol/dichloromethane; gradient 0.0-1.0%) gave 9-(3,5-bis(trifluoromethyl)phenyl)-9-phosphabicyclo[4.2.1]nonatriene oxide as an off-white solid (1.19 g, 3.3 mmol, 24%). ¹H NMR (400 MHz, CDCl₃) δ: 3.49-3.56 (m, 2H), 5.55-5.61 (m, 2H), 5.85-6.05 (m, 4H), 7.99 (s, 1H), 8.23 (d, J=11.6 Hz, 2H); ¹³C NMR (100 MHz, CDCl₃) δ: 43.0 (d, J_{CP}=64.0 Hz), 121.5 (q, J_{CF}=272.1 Hz), 123.4 (d, J_{CP}=6.6 Hz), 125.5-125.7 (m), 127.4 (d, J_{CP}=3.0 Hz), 129.2, 131.1-131.4 (m), 131.7 (qd, J_{CP}=11.6 Hz, J_{CF}=33.5 Hz), 134.1 (d, J_{CP}=95.3 Hz); ³¹P NMR (162 MHz, CDCl₃) δ: 37.9; ¹⁹F NMR (376 MHz, CDCl₃) δ: −63.1; HRMS [M+H]⁺ m/z calcd 365.0524. found 365.0528.

General procedure for preparation of 9-aryl-9-phosphabicyclo[4.2.1]nonane oxides via hydrogenation of 9-aryl-9-phospha-bicyclo[4.2.1]nonatriene oxides: Pd/C (10% w/w, ca. 15 mol %) was transferred to a round-bottom flask containing 9-aryl-9-phosphabicyclo[4.2.1]nonane oxide and sealed under nitrogen. Methanol (0.35 M) was added under an argon atmosphere. The vessel was purged with hydrogen using a balloon and silicon oil bubbler. The bubbler was removed and the mixture was stirred under hydrogen at room temperature for 24 h. The crude mixture was filtered through Celite® and solvent removed in vacuo to yield pure 9-aryl-9-phospha-bicyclo[4.2.1]nonatriene oxide.

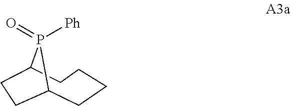 [SMILES: O=P1(c2ccccc2)C2CCCCC1CC2]

9-Phenyl-9-phosphabicyclo[4.2.1]nonane oxide (A3a) was obtained in accordance with the general hydrogenation procedure, from the reaction of 9-phenyl-9-phosphabicyclo[4.2.1]nonatriene oxide (3.31 g, 14.5 mmol, 1.0 equiv.) with an excess of H₂ using Pd/C (10% w/w; 2.50 g, 2.3 mmol, 16 mol %) in methanol (42 mL) at room temperature for 24 h. A3a was obtained as a white solid (3.20 g, 13.7 mmol, 94%). ¹H NMR (400 MHz, CDCl₃) δ: 1.02-1.12 (m, 2H), 1.36-1.45 (m, 2H), 1.50-1.67 (m, 2H), 1.77-1.86 (m, 4H), 2.68-2.82 (m, 4H), 7.46-7.54 (m, 3H), 7.66-7.72 (m, 2H); ³¹P NMR (162 MHz, CDCl₃) δ: 67.9.

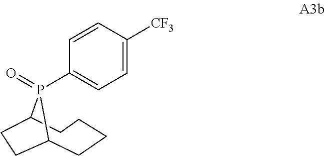 [SMILES: O=P1(c2ccc(C(F)(F)F)cc2)C2CCCCC1CC2]

9-(4-Trifluoromethylphenyl-9-phosphabicyclo[4.2.1]-nonane oxide (A3b) was obtained in accordance with the general hydrogenation procedure, from the reaction of 9-(4-trifluoromethylphenyl)-9-phosphabicyclo[4.2.1]nonatriene oxide (1.89 g, 6.4 mmol, 1.0 equiv.) with an excess of H₂ using Pd/C (10% w/w; 1.21 g, 1.1 mmol, 18 mol %) in methanol (19 mL) at room temperature for 24 h. A3b was obtained as a white solid (1.86 g, 6.2 mmol, 97%). ¹H NMR (400 MHz, CDCl₃) δ: 1.00-1.09 (m, 2H), 1.38-1.47 (m, 2H), 1.53-1.70 (m, 2H), 1.73-1.89 (m, 4H), 2.68-2.84 (m, 4H), 7.75 (br. dd, J=8.4 Hz, 2.0 Hz, 2H), 7.83 (dd, J=11.6 Hz, 7.6 Hz, 2H); ¹³C NMR (100 MHz, CDCl₃) δ: 24.4 (d, J_{CP}=2.2 Hz), 28.5 (d, J_{CP}=10.2 Hz), 30.3, 35.9 (d, J_{CP}=62.6 Hz), 123.5 (q, J_{CF}=271.1 Hz), 126.1 (dq, J_{CP}=11.0 Hz, J_{CF}=3.7 Hz), 130.8 (d, J_{CP}=9.4 Hz), 131.3 (d, J_{CP}=9.5 Hz), 133.5 (qd, J_{CP}=2.2 Hz, J_{CF}=32.7 Hz), 136.2 (d, J_{CP}=81.4 Hz); ³¹P NMR (162 MHz, CDCl₃) δ: 67.1; ¹⁹F NMR (376 MHz, CDCl₃) δ: −63.3; HRMS [M+H]⁺ m/z calcd 303.1120. found 303.1124.

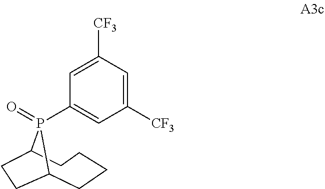 [SMILES: O=P1(c2cc(C(F)(F)F)cc(C(F)(F)F)c2)C2CCCCC1CC2]

9-(3,5-Bis(trifluoromethyl)phenyl-9-phosphabicyclo[4.2.1]-nonane oxide (A3c) was obtained in accordance with the general hydrogenation procedure, from the reaction of 9-(3,5-bis(trifluoromethyl)phenyl)-9-phosphabicyclo[4.2.1]nonatriene oxide (1.67 g, 4.6 mmol, 1.0 equiv.) with an excess of H₂ using Pd/C (10% w/w; 0.73 g, 0.7 mmol, 15 mol %) in methanol (14 mL) at room temperature for 24 h. A3c was obtained as a white solid (1.58 g, 4.3 mmol, 93%). ¹H NMR (400 MHz, CDCl₃) δ: 1.00-1.09 (m, 2H), 1.44-1.53 (m, 2H), 1.60-1.75 (m, 4H), 1.84-1.94 (m, 2H), 2.72-2.91 (m, 4H), 8.02 (s, 1H), 8.12 (d, J=10.4 Hz, 2H); ¹³C NMR (100 MHz, CDCl₃) δ: 24.4 (d, J_{CP}=1.4 Hz), 28.4 (d, J_{CP}=10.2 Hz), 30.3, 36.0 (d, J_{CP}=62.6 Hz), 122.8 (q, J_{CF}=271.6 Hz), 125.2-125.4 (m), 130.5 (br. dd, J_{CP}=8.7 Hz, J_{CF}=3.6 Hz), 132.7 (qd, J_{CP}=10.5 Hz, J_{CF}=33.4 Hz), 135.4 (d, J_{CP}=78.5 Hz); ³¹P NMR (162 MHz, CDCl₃) δ: 66.0; ¹⁹F NMR (376 MHz, CDCl₃) δ: −63.1.

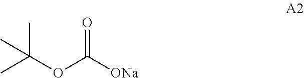

Sodium t-butyl carbonate (A2): To a flame-dried 500 mL round-bottom flask equipped with a stir-bar was added sodium t-butoxide (8.46 g, 88.0 mmol) and dry THF (250 mL). The vessel was sealed with a rubber septum and purged with argon using a silicon oil bubbler. The solution was stirred vigorously until all of the alkoxide was dissolved. Solid CO₂ (dry ice) was added gradually in small portions (˜20 g) until approximately 250 g was added in total. The turbid solution was stirred for 1 h under a flow of argon. The THF was removed in vacuo yielding a white solid. The solid was stirred in dry toluene (30 mL) for 15 min after which drying in vacuo yielded A2 as a white solid (11.20 g, 79.9 mmol, 91%). A 50 mg/mL solution of the product in water gave a pH of 9-10 on universal indicator paper. ¹H NMR (400 MHz, D₂O) δ: 1.19 (s, 9H); ¹³C NMR (100 MHz, D₂O) δ: 29.6, 69.7, 161.8.

General procedure for preparation of benzyl bromides from benzaldehydes: To a stirring solution of aldehyde (1.0 equiv) in methanol (0.2 M) was added sodium borohydride (2.0 equiv.). The resulting solution was stirred at RT for 30-60 mins, until no precipitate was evident in solution and flask was cool to the touch. Solvent was removed in vacuo and dichloromethane introduced. Organic layer was washed using water, dried over sodium sulfate, filtered and solvent removed in vacuo to yield crude benzyl alcohol, which was used without further purification. To a stirring solution of benzyl alcohol (1.0 equiv.) in dry dichloromethane (0.1 M) at 0° C. was added phosphorus tribromide (1.1 equiv.). The reaction solution was stirred at 0° C. for 30 mins, quenched with water, transferred to a separating funnel and the organic layer washed with water. Combined organic layers were dried over sodium sulfate, filtered and solvent removed in vacuo to yield crude benzyl bromide, which was used without purification in catalytic Wittig reactions.

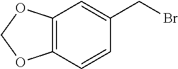 [SMILES: BrCc1ccc2c(c1)OCO2]

5-(Bromomethyl)-1,3-benzodioxole was prepared in accordance with the general procedure. 1,3-Benzodioxol-5-ylmethanol was prepared in 88% yield (2.68 g, 17.6 mmol) from the reaction of piperonal (3.00 g, 20 mmol, 1.0 equiv.) and sodium borohydride (1.51 g, 40 mmol, 2.0 equiv.). Upon reaction with phosphorus tribromide (1.82 mL, 19.4 mmol, 1.1 equiv.), 5-(bromomethyl)-1,3-benzodioxole was obtained as a white solid in 85% yield (3.54 g, 16.5 mmol). ¹H NMR (400 MHz, CDCl₃) δ: 3.84 (s, 3H), 3.87 (s, 6H), 4.47 (s, 2H), 6.62 (s, 2H).

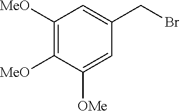 [SMILES: COc1cc(CBr)cc(OC)c1OC]

5-(Bromomethyl)-1,2,3-trimethoxybenzene was prepared in accordance with the general procedure. (3,4,5-Trimethoxyphenyl)methanol was prepared in 93% yield (3.67 g, 18.5 mmol) from the reaction of 3,4,5-trimethoxybenzaldehyde (3.92 g, 20 mmol, 1.0 equiv.) and sodium borohydride (1.51 g, 40 mmol, 2.0 equiv.). Upon reaction with phosphorus tribromide (1.91 mL, 20.4 mmol, 1.1 equiv.), 5-(bromomethyl)-1,2,3-trimethoxybenzene was obtained as an off-white solid in 82% yield (3.54 g, 16.5 mmol). ¹H NMR (400 MHz, CDCl₃) δ: 4.46 (s, 2H), 5.79 (s, 2H), 6.75 (d, J=8.4 Hz, 1H), 6.87 (dd, J=10.4 Hz, 1.6 Hz, 1H), 6.88 (br. s, 1H).

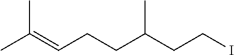

8-Iodo-2,6-dimethyloct-2-ene: To a stirring solution of citronellol (8.7 g, 55.6 mmol 1.0 equiv.) in THF (150 mL) was added triphenylphosphine (16.0 g, 61.2 mmol, 1.1 equiv.), imidazole (4.16 g, 61.2 mmol, 1.1 equiv.) and iodine (15.5 g, 61.2 mmol, 1.1 equiv.). The mixture was stirred at room temperature for 24 h and then concentrated in vacuo. Purification via dry flash chromatography (hexane, R_{f}=0.61) afforded 8-iodo-2,6-dimethyloct-2-ene as a colorless liquid (10.6 g, 72%). ¹H NMR (400 MHz, CDCl₃) δ: 0.88 (d, J=6.8 Hz, 3H), 1.12-1.21 (m, 1H), 1.25-1.38 (m, 1H), 1.53-1.71 (m, 1H), 1.61 (s, 3H), 1.68 (d, J=1.2 Hz, 3H), 1.83-2.05 (m, 3H), 3.13-3.28 (m, 2H), 5.06-5.11 (m, 1H).

### Optimization Studies.

General procedure for solvent study using A2: In air, a 1-dram vial equipped with a stir-bar was charged with A1b (18 mg, 0.1 mmol, 10 mol %) and A2 (280 mg, 2.0 mmol, 2.0 equiv.). The vial was then sealed with a septum and purged with argon. Solvent (1.0 mL), benzaldehyde (122 μL, 1.2 mmol, 1.2 equiv.), benzyl bromide (120 μL, 1.0 mmol, 1.0 equiv.) and diphenylsilane (223 μL, 1.2 mmol, 1.2 equiv.) were introduced, the septum was replaced with a PTFE-lined screw cap under an inert atmosphere,¹ and the reaction was heated at 100° C. for 24 h. The crude reaction mixture was filtered through Celite®, concentrated in vacuo, and purified via flash column chromatography to afford pure A4, as detailed in Table AS1 and FIG. 30.

TABLE AS1
Optimization of solvent using A2.

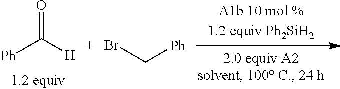 [SMILES: O=Cc1ccccc1 ; BrCc1ccccc1]

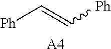

| Entry | Solvent | Yield | E/Z^{[a]} |
|---|---|---|---|
| 1 | Acetonitrile (ACN) | 37 | 66:34 |
| 2 | Dimethyl carbonate (DMC) | 38 | 66:34 |
| 3 | 1,2-Dimethoxyethane (DME) | 49 | 66:34 |
| 4 | 1,4-Dioxane | 53 | 66:34 |
| 5 | tButyl acetate (tBuOAc) | 54 | 66:34 |
| 6 | 2-Methyl tetrahydrofuran (2-MeTHF) | 73 | 66:34 |
| 7 | Cyclopentyl methyl ether (CPME) | 75 | 66:34 |
| 8 | Toluene | 81 | 66:34 |

^{[a]}E/Z ratio was determined by ¹H NMR spectroscopy of the unpurified reaction mixture.

General procedure for phosphine oxide screening using A2: In air, a 1-dram vial equipped with a stir-bar was charged with phosphine oxide (0.10 mmol, 10 mol %) and A2 (280 mg, 2.0 mmol, 2.0 equiv.). The vial was then sealed with a septum and purged with argon. Toluene (1.0 mL), benzaldehyde (122 μL, 1.2 mmol, 1.2 equiv.), benzyl bromide (120 μL, 1.0 mmol, 1.0 equiv.) and diphenylsilane (223 μL, 1.2 mmol, 1.2 equiv.) were introduced, the septum was replaced with a PTFE-lined screw cap under an inert atmosphere,¹ and the reaction was heated at 100 or 110° C. for 24 h. The crude reaction mixture was filtered through Celite®, concentrated in vacuo and purified via flash column chromatography to afford pure A4, as detailed in Table S2.

General procedure for phosphine oxide screening using DIPEA: In air, a 4 mL pressure vessel equipped with a stir-bar was charged with phosphine oxide (0.10 mmol, 10 mol %). The vessel was then sealed with a septum and purged with argon. Toluene (0.33 mL), benzaldehyde (122 μL, 1.2 mmol, 1.2 equiv.), benzyl bromide (120 μL, 1.0 mmol, 1.0 equiv.), DIPEA (210 μL, 1.2 mmol, 1.2 equiv.) and diphenylsilane (223 μL, 1.2 mmol, 1.2 equiv.) were introduced, the septum was replaced with a PTFE-lined screw cap under an inert atmosphere,¹ and the reaction was heated at 100 or 140° C. for 24 h. The crude reaction mixture was filtered through Celite®, concentrated in vacuo and purified via flash column chromatography to afford pure A4, as detailed in Table AS2 and FIG. 31.

TABLE AS2
Phosphine oxide screening.

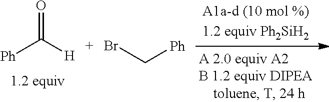 [SMILES: O=Cc1ccccc1 ; BrCc1ccccc1]

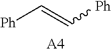

| | | | | Conversion | |
|---|---|---|---|---|---|
| Entry | P═O | Base | T (° C.) | (Yield) (%)^{[a]} | E/Z^{[b]} |
| 1 | A1b | A | 100 | 100 (76) | 66:34 |
| 2 | A1a | A | 100 | 100 (74) | 80:20 |
| 3 | A1a | A | 110 | 100 (80) | 80:20 |
| 4 | A1b | B | 100 | trace | — |
| 5 | A1a | B | 140 | 55 (37) | 75:25 |
| 6 | A1b | B | 140 | 65 (43) | 80:20 |
| 7 | A1c | B | 140 | 88 (61) | 75:25 |
| 8 | A1d | B | 140 | 91 (72) | 82:18 |

^{[a]}Conversions were determined by ¹H NMR spectroscopy.
^{[b]}E/Z ratio was determined by ¹H NMR spectroscopy of the unpurified reaction mixture.

General procedure for solvent study using DIPEA: In air, a 4 mL pressure vessel equipped with a stir-bar was charged with A1d (32 mg, 0.10 mmol, 10 mol %). The vessel was then sealed with a septum and purged with argon. Solvent (0.33 mL), benzaldehyde (122 μL, 1.2 mmol, 1.2 equiv.), benzyl bromide (120 μL, 1.0 mmol, 1.0 equiv.), DIPEA (210 μL, 1.2 mmol, 1.2 equiv.) and diphenylsilane (223 μL, 1.2 mmol, 1.2 equiv.) were introduced, the septum was replaced with a PTFE-lined screw cap under an inert atmosphere,¹ and the reaction was heated at 140° C. for 24 h. The crude reaction mixture was filtered through Celite®, concentrated in vacuo and ¹H NMR spectroscopy analysis was used to determine conversion and E/Z ratio, as shown in Table AS3 and FIG. 32.

TABLE AS3
Solvent study using DIPEA.

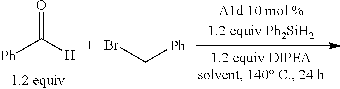 [SMILES: O=Cc1ccccc1 ; BrCc1ccccc1]

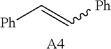

| | | Conversion | |
|---|---|---|---|
| Entry | Solvent | (%)^{[a]} | E/Z^{[b]} |
| 1 | Cyclopentyl methyl ether (CPME) | 75 | 81:19 |
| 2 | tButyl acetate (tBuOAc) | 84 | 81:19 |
| 3 | Dimethyl carbonate (DMC) | 87 | 75:25 |
| 4 | Toluene | 91 | 82:18 |
| 5 | 2-Methyl tetrahydrofuran (2-MeTHF) | 92 | 77:23 |
| 6 | α,α,α-Trifluorotoluene (CF₃Ph) | 100 | 79:21 |

^{[a]}Conversions were determined by ¹H NMR spectroscopy.
^{[b]}E/Z ratio was determined by ¹H NMR spectroscopy of the unpurified reaction mixture.

### Screening of A3a in Existing CWR Protocols—Standard Elevated Temperature Conditions:

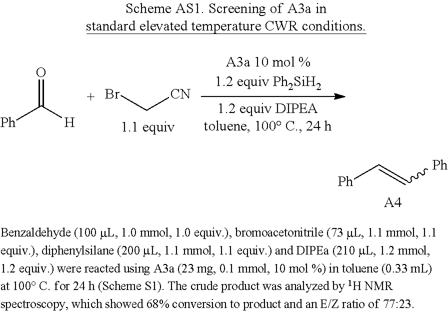

### Screening of A3a in Existing CWR Protocols—Standard Room Temperature Conditions:

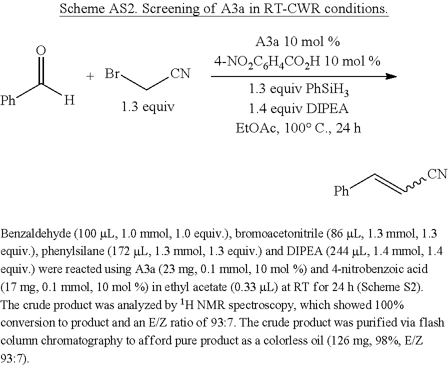

### Catalytic Wittig Olefination Procedures.

### General Procedure A: Preparation of Compounds A4-A10 and A12-A15 Via Catalytic Wittig Reaction Using A2.

In air, a 1-dram vial equipped with a stir-bar was charged with phosphine oxide (0.10-0.20 mmol, 10-20 mol %) and A2 (2.0 mmol, 2.0 equiv.). Any other solid reagents were also added at this point, in the following quantities: aldehyde (1.1-1.2 mmol, 1.1-1.2 equiv.) and organohalide (1.0 mmol, 1.0 equiv.). The vial was then sealed with a septum and purged with argon. Toluene (1.0 mL) and liquid reagents were introduced in the following quantities: aldehyde (1.1-1.2 mmol, 1.1-1.2 equiv.), organohalide (1.0 mmol, 1.0 equiv.). Diphenylsilane (1.1-1.4 mmol, 1.1-1.4 equiv.) was introduced and the septum was replaced with a PTFE-lined screw cap under an inert atmosphere, and the reaction was heated at 110° C. for 24 h. The crude reaction mixture was filtered through Celite®, concentrated in vacuo, and purified via flash column chromatography.

General Procedure X: Preparation of Compounds A11 and A16 Via Catalytic Wittig Reaction Using A2 with Portion-Wise Addition.

In air, a 1-dram vial equipped with a stir-bar was charged with phosphine oxide (0.15 mmol, 15 mol %) and A2 (0.66 mmol, 0.66 equiv.). The vial was then sealed with a septum and purged with argon. Toluene (1.0 mL) and diphenylsilane (0.9 mmol, 0.9 equiv.) were introduced and the septum was replaced with a PTFE-lined screw cap under an inert atmosphere.¹ The reaction solution was heated at 110° C. for 45 min, then aldehyde (0.33 mmol, 0.33 equiv.) and organohalide (0.15 mmol, 0.15 equiv.) were introduced and the reaction solution stirred at RT for 5-10 min, before returning to 110° C. for a further hour. Additional halide (0.15 mmol, 0.15 equiv.) was added hourly (total of 7 additions) and additional A2 (2×0.66 mmol, 0.66 equiv.) and aldehyde (2×0.33 mmol, 0.33 equiv.) were added after 2 h and 5 h. Diphenylsilane (0.3 mmol, 0.3 equiv.) was added after 5 h. After all additions were complete the reaction solution was stirred at 110° C. for a total time of 24 h. The crude reaction mixture was filtered through Celite®, concentrated in vacuo, and purified via flash column chromatography.

### General Procedure B: Preparation of Compounds A4-A10 and A13-A15 Via Catalytic Wittig Reaction Using DIPEA.

In air, a 4 mL pressure vessel equipped with a stir-bar was charged with phosphine oxide (0.10 mmol, 10 mol %). Any other solid reagents were also added at this point, in the following quantities: aldehyde (1.2 mmol, 1.2 equiv.) and organohalide (1.0 mmol, 1.0 equiv.). The vessel was then sealed with a septum and purged with argon. Toluene (0.33 mL) and liquid reagents were introduced in the following quantities: aldehyde (1.2 mmol, 1.2 equiv.), organohalide (1.0 mmol, 1.0 equiv.), DIPEA (1.2 mmol, 1.2 equiv.). Diphenylsilane (1.2 mmol, 1.2 equiv.) was introduced and the septum was replaced with a PTFE-lined screw cap under an inert atmosphere, and the reaction was heated at 140° C. for 24 h. The crude reaction mixture was concentrated in vacuo, and purified via flash column chromatography.

### General Procedure C: Preparation of Compounds A17-A24 Via Catalytic Wittig Reaction.

In air, a 1-dram vial equipped with a stir-bar was charged with A1d (0.2 mmol, 20 mol %) and A2 (2.0-3.5 mmol, 2.0-3.5 equiv.). If solid, aldehyde (1.0-1.2 mmol, 1.0-1.2 equiv.) was also added at this point. The vial was then sealed with a septum and purged with argon. Toluene (1.4 mL) and liquid reagents were introduced in the following quantities: aldehyde (1.2 mmol, 1.2 equiv.) and organohalide (1.0 mmol, 1.0 equiv.). Diphenylsilane (1.2 mmol, 1.2 equiv.) was introduced and the septum was replaced with a PTFE-lined screw cap under an inert atmosphere. The reaction was heated at 140° C. or 150° C. for 24-48 h. Additional portions of base and halide were added at 24 h for 48 h reactions. The crude reaction mixture was filtered through Celite®, concentrated in vacuo, and purified via flash column chromatography.

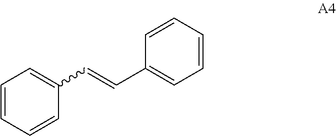 [SMILES: C(=Cc1ccccc1)c1ccccc1]

1,2-Diphenylethene (A4) was obtained in accordance with general procedure A from the reaction of benzaldehyde (122 μL, 1.2 mmol, 1.2 equiv.), benzyl bromide (120 μL, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (hexane, E-A4: R_{f}=0.44, Z-A4: R_{f}=0.52) to afford E-A4 as a white solid and Z-A4 as a colorless oil (144 mg, 80%, E/Z 80:20). E-A4: ¹H NMR (400 MHz, CDCl₃) δ: 7.12 (s, 2H), 7.25-7.29 (m, 2H), 7.37 (t, J=7.6 Hz, 4H), 7.53 (d, J=7.6 Hz, 4H). Z-A4: ¹H NMR (400 MHz, CDCl₃) δ: 6.62 (s, 2H), 7.19-7.29 (m, 10H).

When A4 was prepared in accordance with general procedure A from the reaction of benzaldehyde (122 μL, 1.2 mmol, 1.2 equiv.), benzyl bromide (120 μL, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 82% (148 mg, E/Z 95:5).

When A4 was prepared in accordance with general procedure B from the reaction of benzaldehyde (122 μL, 1.2 mmol, 1.2 equiv.), benzyl bromide (120 μL, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 10 mol %) in toluene (0.33 mL) at 140° C. for 24, yield was 72% (129 mg, E/Z 80:20).

When A4 was prepared in accordance with general procedure B from the reaction of benzaldehyde (122 μL, 1.2 mmol, 1.2 equiv.), benzyl bromide (120 μL, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 10 mol %) in toluene (0.33 mL) at 140° C. for 24, yield was 79% (142 mg, E/Z 95:5).

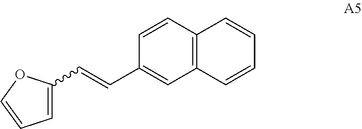 [SMILES: C(=Cc1ccco1)c1ccc2ccccc2c1]

1-(2-Furyl)-2-(2-naphthyl)ethene (A5) was obtained in accordance with general procedure A from the reaction of furfural (100 μL, 1.2 mmol, 1.2 equiv.), 2-(bromomethyl)naphthalene (221 mg, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (hexane, R_{f}=0.31) to afford A5 as a white solid (181 mg, 82%, E/Z 66:34). E-A5: ¹H NMR (400 MHz, CDCl₃) δ: 6.47 (d, J=3.2 Hz, 1H), 6.52 (dd, J=3.2 Hz, 1.6 Hz, 1H), 7.10 (d, J=16.4 Hz, 1H), 7.31 (d, J=16.4 Hz, 1H), 7.50-7.56 (m, 3H), 7.74 (dd, J=8.4 Hz, 1.2 Hz, 1H), 7.86-7.92 (m, 4H); Z-A5: ¹H NMR (400 MHz, CDCl₃) δ: 6.39 (d, J=0.8 Hz, 2H), 6.58 (d, J=12.8 Hz, 1H), 6.71 (d, J=12.8 Hz, 1H), 7.39 (br. s, 1H), 7.50-7.56 (m, 2H), 7.69 (dd, J=8.4 Hz, 1.2 Hz, 1H), 7.86-7.92 (m, 3H), 8.00 (br. s, 1H).

When A5 was prepared in accordance with general procedure A from the reaction of furfural (100 μL, 1.2 mmol, 1.2 equiv.), 2-(bromomethyl)naphthalene (221 mg, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 65% (143 mg, E/Z 90:10).

When A5 was prepared in accordance with general procedure B from the reaction of furfural (100 μL, 1.2 mmol, 1.2 equiv.), 2-(bromomethyl)naphthalene (221 mg, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 10 mol %) in toluene (0.33 mL) at 140° C. for 24 h, yield was 72% (160 mg, E/Z 70:30).

When A5 was prepared in accordance with general procedure B from the reaction of furfural (100 μL, 1.2 mmol, 1.2 equiv.), 2-(bromomethyl)naphthalene (221 mg, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 10 mol %) in toluene (0.33 mL) at 140° C. for 24 h, yield was 82% (181 mg, E/Z 85:15).

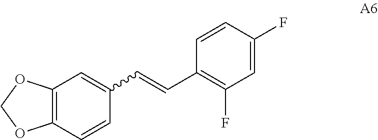 [SMILES: Fc1ccc(C=Cc2ccc3c(c2)OCO3)c(F)c1]

5-(2-(2,4-Difluorophenyl)ethenyl)-1,3-benzodioxole (A6) was obtained in accordance with general procedure A from the reaction of piperonal (180 mg, 1.2 mmol, 1.2 equiv.), 2,5-difluorobenzyl bromide (128 μL, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (benzene/hexane, 10:90, E-A6: R_{f}=0.32, Z-A6: R_{f}=0.36) to afford both E-A6 and Z-A6 as white solids (203 mg, 78%, E/Z 75:25, Z-A6 inseparable from E-A6). E-A6: ¹H NMR (400 MHz, CDCl₃) δ: 5.98 (s, 2H), 6.79-6.90 (m, 2H), 6.80 (d, J=8.0 Hz, 1H), 6.94 (dd, J=8.0 Hz, 1.6 Hz, 1H), 7.01 (s, 2H), 7.07 (d, J=1.6 Hz, 1H), 7.52 (dt, J=8.8 Hz, 6.8 Hz, 1H); ¹³C NMR (100 MHz, CDCl₃) δ: 101.3, 104.2 (t, J_{CF}=25.8 Hz), 105.6, 108.5, 111.6 (dd, J_{CF}=21.3 Hz, 3.6 Hz), 118.2 (dd, J_{CF}=2.9 Hz, 1.5 Hz), 121.7-121.9 (m), 121.8, 127.6 (dd, J_{CF}=9.6 Hz, 5.1 Hz), 130.3 (dd, J_{CF}=5.1 Hz, 2.9 Hz), 131.7, 147.7, 148.3, 159.9 (dd, J_{CF}=178.2 Hz, 11.7 Hz), 162.4 (dd, J_{CF}=177.7 Hz, 11.7 Hz); ¹⁹F NMR (376 MHz, CDCl₃) δ: −114.0 (d, J=7.1 Hz, 1F), −111.3 (d, J=7.1 Hz, 1F); mp 84-85° C. Z-A6: ¹H NMR (400 MHz, CDCl₃) δ: 5.92 (s, 2H), 6.45 (d, J=12.0 Hz, 1H), 6.62 (d, J=12.0 Hz, 1H), 6.70-6.76 (m, 4H), 6.80-6.90 (m, 1H), 7.24 (dt, J=8.8 Hz, 6.4 Hz, 1H); ¹³C NMR (100 MHz, CDCl₃) δ: 101.1, 104.1 (t, J_{CF}=25.8 Hz), 108.3, 108.6, 111.2 (dd, J_{CF}=21.3 Hz, 3.6 Hz), 120.5 (d, J_{CF}=2.2 Hz), 121.2 (dd, J_{CF}=14.6 Hz, 3.6 Hz), 123.1, 130.7, 131.3 (dd, J_{CF}=9.5 Hz, 5.1 Hz), 132.0, 147.0, 147.6, 160.0 (dd, J_{CF}=183.6 Hz, 11.7 Hz), 162.6 (dd, J_{CF}=181.5 Hz, 11.7 Hz); ¹⁹F NMR (376 MHz, CDCl₃) δ: −110.8 (d, J=7.1 Hz, 1F), −110.4 (d, J=7.1 Hz, 1F). HRMS [M]⁺ m/z calcd. 260.0649. found 260.0645.

When A6 was prepared in accordance with general procedure A from the reaction of piperonal (180 mg, 1.2 mmol, 1.2 equiv.), 2,5-difluorobenzyl bromide (128 μL, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 87% (197 mg, E/Z 90:10).

When A6 was prepared in accordance with general procedure B from the reaction of piperonal (180 mg, 1.2 mmol, 1.2 equiv.), 2,5-difluorobenzyl bromide (128 μL, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 0.1 mmol, 10 mol %) in toluene (0.33 mL) at 140° C. for 24 h, yield was 85% (222 mg, E/Z 70:30).

When A6 was prepared in accordance with general procedure B from the reaction of piperonal (180 mg, 1.2 mmol, 1.2 equiv.), 2,5-difluorobenzyl bromide (128 μL, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 10 mol %) in toluene (0.33 mL) at 140° C. for 24 h, yield was 73% (190 mg, E/Z 90:10).

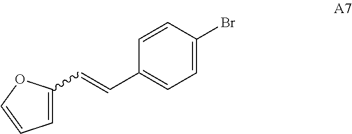 [SMILES: Brc1ccc(C=Cc2ccco2)cc1]

2-(4-Bromophenyl)-1-(2-furyl)ethene (A7) was obtained in accordance with general procedure A from the reaction of furfural (100 μL, 1.2 mmol, 1.2 equiv.), 4-bromobenzyl bromide (250 mg, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (hexane, R_{f}=0.33) to afford an isomeric mixture of A7 as a white solid (185 mg, 74%, E/Z 66:34). E-A7: ¹H NMR (600 MHz, CDCl₃) δ: 6.39-6.40 (m, 1H), 6.46 (dd, J=3.6 Hz, 1.8 Hz, 1H), 6.89 (d, J=16.2 Hz, 1H), 6.99 (d, J=16.2 Hz, 1H), 7.31-7.37 (m, 2H), 7.44 (d, J=1.8 Hz, 1H), 7.47-7.50 (m, 2H); ¹³C NMR (100 MHz, CDCl₃) δ: 109.3, 111.8, 117.2, 121.3, 125.8, 127.8, 131.8, 136.0, 142.5, 153.0. Z-A7: ¹H NMR (600 MHz, CDCl₃) δ: 6.31 (d, J=3.6 Hz, 1H), 6.37 (dd, J=3.6 Hz, 1.8 Hz, 1H), 6.38 (d, J=12.0 Hz, 1H), 6.41 (d, J=12.6 Hz, 1H), 7.31-7.37 (m, 2H), 7.34 (d, J=1.2 Hz, 1H), 7.47-7.50 (m, 2H); ¹³C NMR (100 MHz, CDCl₃) δ: 110.7, 111.4, 118.5, 121.3, 126.5, 130.5, 131.3, 136.3, 141.9, 151.9. HRMS [M]⁺ m/z calcd. 247.9837. found 247.9835.

When A7 was prepared in accordance with general procedure A from the reaction of furfural (100 μL, 1.2 mmol, 1.2 equiv.), 4-bromobenzyl bromide (250 mg, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 64% (159 mg, E/Z 85:15).

When A7 was prepared in accordance with general procedure B from the reaction of furfural (100 μL, 1.2 mmol, 1.2 equiv.), 4-bromobenzyl bromide (250 mg, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 10 mol %) in toluene (0.33 mL) at 140° C. for 24, yield was 61% (152 mg, E/Z 66:34).

When A7 was prepared in accordance with general procedure B from the reaction of furfural (100 μL, 1.2 mmol, 1.2 equiv.), 4-bromobenzyl bromide (250 mg, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 10 mol %) in toluene (0.33 mL) at 140° C. for 24, yield was 89% (222 mg, E/Z 85:15).

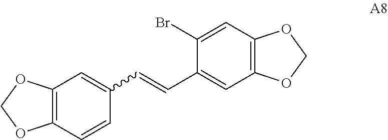 [SMILES: Brc1cc2c(cc1C=Cc1ccc3c(c1)OCO3)OCO2]

5-(2-(1,3-Benzodioxol-5-yl)ethenyl)-6-bromo-1,3-benzodioxole (A8) was obtained in accordance with general procedure A from the reaction of piperonal (180 mg, 1.2 mmol, 1.2 equiv.), 5-bromo-6-bromomethyl-1,3-benzodioxole (294 mg, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (benzene/hexane, 20:80, R_{f}=0.32) to afford both E-A8 and Z-A8 as white solids (276 mg, 79%, E/Z 70:30, Z-A8 inseparable from E-A8). E-A8: ¹H NMR (400 MHz, CDCl₃) δ: 5.98 (s, 4H), 6.79 (d, J=16.4 Hz, 1H), 6.80 (d, J=8.4 Hz, 1H), 6.93 (dd, J=8.4 Hz, 1.6 Hz, 1H), 7.02 (s, 1H), 7.08 (d, J=1.6 Hz, 1H), 7.10 (s, 1H), 7.21 (d, J=16.0 Hz, 1H); ¹³C NMR (100 MHz, CDCl₃) δ: 101.3, 101.9, 105.7, 105.8, 108.5, 112.9, 115.2, 121.8, 125.7, 129.5, 130.7, 131.8, 147.6, 147.8, 147.9, 148.3. Z-A8: ¹H NMR (400 MHz, CDCl₃) δ: 5.91 (s, 2H), 5.93 (s, 2H), 6.40 (d, J=12.0 Hz, 1H), 6.50 (d, J=12.0 Hz, 1H), 6.64-6.69 (m, 4H), 7.04 (s, 1H); ¹³C NMR (100 MHz, CDCl₃) δ: 101.1, 101.8, 108.3, 108.9, 110.2, 112.7, 114.8, 123.4, 128.1, 130.4, 130.4, 130.9, 146.9, 147.1, 147.5, 147.7. HRMS [M]⁺ m/z calcd. 345.9841. found 345.9832.

When A8 was prepared in accordance with general procedure A from the reaction of piperonal (180 mg, 1.2 mmol, 1.2 equiv.), 5-bromo-6-bromomethyl-1,3-benzodioxole (294 mg, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 72% (252 mg, E/Z 80:20).

When A8 was prepared in accordance with general procedure B from the reaction of piperonal (180 mg, 1.2 mmol, 1.2 equiv.), 5-bromo-6-bromomethyl-1,3-benzodioxole (294 mg, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 0.1 mmol, 10 mol %) in toluene (0.33 mL) at 140° C. for 24 h, yield was 70% (243 mg, E/Z 66:34).

When A8 was prepared in accordance with general procedure B from the reaction of piperonal (180 mg, 1.2 mmol, 1.2 equiv.), 5-bromo-6-bromomethyl-1,3-benzodioxole (294 mg, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 0.1 mmol, 10 mol %) in toluene (0.33 mL) at 140° C. for 24 h, yield was 55% (191 mg, E/Z 85:15).

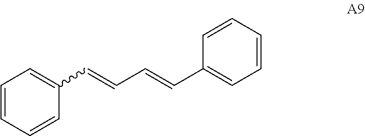 [SMILES: C(=Cc1ccccc1)/C=C/c1ccccc1]

(1E)-1,4-Diphenylbuta-1,3-diene (A9) was obtained in accordance with general procedure A from the reaction of benzaldehyde (122 μL, 1.2 mmol, 1.2 equiv.), 3-bromo-1-phenyl-1-propene (197 mg, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (hexane, E-A9: R_{f}=0.26, Z-A9: R_{f}=0.36) to afford both E-A9 and Z-A9 as white solids (152 mg, 74%, E/Z 70:30). E-A9 ¹H NMR (400 MHz, CDCl₃) δ: 6.65-6.73 (m, 2H), 6.94-7.01 (m, 2H), 7.25 (t, J=7.6 Hz, 2H), 7.48 (t, J=7.6 Hz, 4H), 7.46 (d, J=7.6 Hz, 4H). Z-A9 ¹H NMR (400 MHz, CDCl₃) δ: 6.45 (t, J=11.6 Hz, 1H), 6.55 (d, J=11.6 Hz, 1H), 6.74 (d, J=15.6 Hz, 1H), 7.22-7.43 (m, 11H).

When A9 was prepared in accordance with general procedure A from the reaction of benzaldehyde (122 μL, 1.2 mmol, 1.2 equiv.), 3-bromo-1-phenyl-1-propene (197 mg, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 64% (132 mg, E/Z 87:13).

When A9 was prepared in accordance with general procedure B from the reaction of benzaldehyde (122 μL, 1.2 mmol, 1.2 equiv.), 3-bromo-1-phenyl-1-propene (197 mg, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 0.1 mmol, 10 mol %) in toluene (0.33 mL) at 140° C. for 24 h, yield was 52% (107 mg, E/Z 73:27).

When A9 was prepared in accordance with general procedure B from the reaction of benzaldehyde (122 μL, 1.2 mmol, 1.2 equiv.), 3-bromo-1-phenyl-1-propene (197 mg, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 0.1 mmol, 10 mol %) in toluene (0.33 mL) at 140° C. for 24 h, yield was 65% (134 mg, E/Z 88:12).

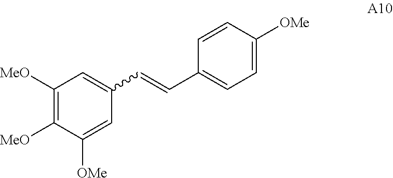 [SMILES: COc1ccc(C=Cc2cc(OC)c(OC)c(OC)c2)cc1]

1,2,3-Trimethoxy-5-(2-(4-methoxyphenyl)ethenyl)benzene (A10) was obtained in accordance with general procedure A from the reaction of 3,4,5-trimethoxybenzaldehyde (235 mg, 1.2 mmol, 1.2 equiv.), 4-methoxybenzyl chloride (136 μL, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (ethyl acetate/benzene, gradient 0-2%, E-A10: R_{f}=0.34, Z-A10: R_{f}=0.31) to afford E-A10 as a light yellow solid and Z-A10 as a pale yellow oil (249 mg, 83%, E/Z 83:17). E-A10: ¹H NMR (400 MHz, CDCl₃) δ: 3.83 (s, 3H), 3.87 (s, 3H), 3.91 (s, 6H), 6.72 (s, 2H), 6.90 (br. d, J=8.8 Hz, 2H), 6.91 (d, J=16.0 Hz, 1H), 6.98 (d, J=16.0 Hz, 1H), 7.45 (br. d, J=8.8 Hz, 1H). Z-A10: ¹H NMR (400 MHz, CDCl₃) δ: 3.69 (s, 6H), 3.79 (s, 3H), 3.85 (s, 3H), 6.42 (d, J=12.0 Hz, 1H), 6.51 (s, 2H), 6.52 (d, J=12.0 Hz, 1H), 6.79 (d, J=8.8 Hz, 2H), 7.24 (d, J=8.8 Hz, 2H).

When A10 was prepared in accordance with general procedure A from the reaction of 3,4,5-trimethoxybenzaldehyde (235 mg, 1.2 mmol, 1.2 equiv.), 4-methoxybenzyl chloride (136 μL, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 73% (219 mg, E/Z>95:5).

When A10 was prepared in accordance with general procedure B from the reaction of 3,4,5-trimethoxybenzaldehyde (235 mg, 1.2 mmol, 1.2 equiv.), 4-methoxybenzyl chloride (136 μL, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 0.1 mmol, 10 mol %) in toluene (0.33 mL) at 140° C. for 24 h, yield was 75% (225 mg, E/Z 75:25).

The reaction was performed on scale, yielding A10 on a 25.0 mmol scale from the reaction of 3,4,5-trimethoxybenzaldehyde (5.90 g, 30.0 mmol, 1.2 equiv.), 4-methoxybenzyl chloride (3.5 mL, 25.0 mmol, 1.0 equiv.), diphenylsilane (5.7 mL, 30.0 mmol, 1.2 equiv.) and DIPEA (5.3 mL, 30.0 mmol, 1.2 equiv.) using A1d (790 mg, 0.1 mmol, 10 mol %) in toluene (8.30 mL). The reaction was prepared in a 100 mL pressure vessel under an inert atmosphere and run at 140° C. for 24 h before purification by dry flash chromatography (ethyl acetate/benzene, gradient 0-2%) to afford A10 in 81% yield (6.42 g, E/Z 75:25). Iodine isomerization produced E-A10 in 77% yield (5.78 g, 19.0 mmol).

When A10 was prepared in accordance with general procedure B from the reaction of 3,4,5-trimethoxybenzaldehyde (235 mg, 1.2 mmol, 1.2 equiv.), 4-methoxybenzyl chloride (136 μL, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 0.1 mmol, 10 mol %) in toluene (0.33 mL) at 140° C. for 24 h, yield was 85% (255 mg, E/Z 93:7).

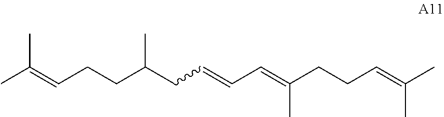 [SMILES: CC(C)=CCC/C(C)=C/C=CCC(C)CCC=C(C)C]

(6E)-2,6,11,15-Tetramethyl hexadeca-2,6,8,14-tetraene (A11) was obtained in accordance with general procedure X from the reaction of (±)-citronellal (180 μL, 1.0 mmol, 1.0 equiv.), geranyl bromide (238 μL, 1.2 mmol, 1.2 equiv.), diphenylsilane (223 μL, 1.2 mmol, 1.2 equiv.) and A2 (280 mg, 2.0 mmol, 2.0 equiv.) using A1a (32 mg, 0.15 mmol, 15 mol %) in toluene (1.0 mL) at 110° C. for 24 h using a portion-wise addition process. The crude product was purified via flash column chromatography (hexane, R_{f}=0.71) to afford an isomeric mixture of A11 as a clear liquid (203 mg, 74%, E/Z 70:30). E-A11: ¹H NMR (400 MHz, CDCl₃) δ: 0.90 (d, J=6.8 Hz, 3H), 1.12-1.22 (m, 1H), 1.34-1.44 (m, 1H), 1.47-1.57 (m, 1H), 1.62 (br. s, 6H), 1.70 (br. s, 6H), 1.76 (s, 3H), 1.92-2.23 (m, 8H), 5.10-5.15 (m, 2H), 5.58 (dt, J=15.2 Hz, 7.2 Hz, 1H), 5.83 (br. d, J=10.8 Hz, 1H), 6.21-6.28 (m, 1H). Z-A11: ¹H NMR (400 MHz, CDCl₃) δ: 0.92 (d, J=6.8 Hz, 3H), 1.12-1.22 (m, 1H), 1.34-1.44 (m, 1H), 1.47-1.57 (m, 1H), 1.62 (br. s, 6H), 1.70 (br. s, 6H), 1.76 (s, 3H), 1.92-2.23 (m, 8H), 5.10-5.15 (m, 2H), 5.38 (dt, J=10.8 Hz, 7.6 Hz, 1H), 6.09 (br. d, J=11.6 Hz, 1H), 6.21-6.28 (m, 1H). E+Z-A11: ¹³C NMR (100 MHz, CDCl₃) δ: 16.6, 16.7, 17.8, 17.8, 17.8, 19.6, 19.7, 25.8, 25.8, 25.8, 25.9, 26.8, 33.1, 33.3, 34.8, 36.8, 36.9, 40.0, 40.4, 40.6, 120.3, 124.3, 124.3, 124.9, 125.0, 125.6, 128.0, 128.7, 131.1, 131.2, 131.6, 136.3, 138.4; HRMS [M]⁺ m/z calcd. 274.2661. found 274.2666.

The reaction was performed on scale, yielding A11 on a 28.0 mmol scale from the reaction of (±)-citronellal (5.3 mL, 28.0 mmol, 1.0 equiv.), geranyl bromide (7.0 mL, 33.6 mmol, 1.2 equiv.), diphenylsilane (6.2 mL, 33.6 mmol, 1.2 equiv.) and A2 (7.85 g, 56.0 mmol, 2.0 equiv.) using A1a (908 mg, 4.2 mmol, 15 mol %) in toluene (28 mL). The reaction was prepared in a 100 mL pressure vessel under an inert atmosphere and run at 0.110° C. for 24 h to afford A11 in 84% yield (6.42 g, E/Z 70:30).

When A11 was prepared in accordance with general procedure X from the reaction of (±)-citronellal (180 μL, 1.0 mmol, 1.0 equiv.), geranyl bromide (238 μL, 1.2 mmol, 1.2 equiv.), diphenylsilane (223 μL, 1.2 mmol, 1.2 equiv.) and A2 (280 mg, 2.0 mmol, 2.0 equiv.) using A3a (35 mg, 0.15 mmol, 15 mol %) in toluene (1.0 mL) at 110° C. for 24 h, yield was 63% (173 mg, E/Z 85:15).

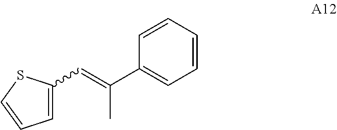

2-Phenyl-1-(2-thienyl)-prop-1-ene (A12) was obtained in accordance with general procedure A from the reaction of 2-thiophenecarboxaldehyde (112 μL, 1.2 mmol, 1.2 equiv.), (1-bromoethyl)benzene (136 μL, 1.0 mmol, 1.0 equiv.), diphenylsilane (223 μL, 1.2 mmol, 1.2 equiv.) and A2 (280 mg, 2.0 mmol, 2.0 equiv.) using A1a (22 mg, 0.1 mmol, 10 mol %) in toluene (1.0 mL) at 110° C. for 24 h. The crude product was purified via flash column chromatography (hexane, R_{f}=0.26) to afford an isomeric mixture of A12 as a pale yellow oil (148 mg, 74%, E/Z 70:30). E-A12: ¹H NMR (400 MHz, CDCl₃) δ: 2.54 (d, J=1.2 Hz, 3H), 7.09 (br. s, 1H), 7.17 (dd, J=4.8 Hz, 3.6 Hz, 1H), 7.21 (br. d, J=3.6 Hz, 1H), 7.36-7.62 (m, 6H). Z-A12: ¹H NMR (400 MHz, CDCl₃) δ: 2.29 (d, J=1.2 Hz, 3H), 6.74 (d, J=1.2 Hz, 1H), 6.85 (br. d, J=3.6 Hz, 1H), 6.92 (dd, J=4.8 Hz, 3.6 Hz, 1H), 7.04 (br. d, J=5.2 Hz, 1H), 7.36-7.62 (m, 5H).

When A12 was prepared in accordance with general procedure A from the reaction of 2-thiophenecarboxaldehyde (112 μL, 1.2 mmol, 1.2 equiv.), (1-bromoethyl)benzene (136 μL, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h, yield was 51% (102 mg, E/Z 70:30).

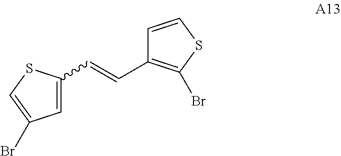 [SMILES: Brc1csc(C=Cc2ccsc2Br)c1]

1-(2-Bromo-3-thienyl)-2-(4-bromo-2-thienyl)ethene (A13) was obtained in accordance with general procedure A from the reaction of 4-bromo-2-thiophenecarboxaldehyde (229 mg, 1.2 mmol, 1.2 equiv.), 2-bromo-3-(bromomethyl)thiophene (130 μL, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h. The crude product was purified via flash column chromatography (hexane, E-A13: R_{f}=0.44, Z-A13: R_{f}=0.66) to afford both E-A13 and Z-A13 as pale yellow oils (231 mg, 66%, E/Z 91:9). E-A13: ¹H NMR (400 MHz, CDCl₃) δ: 6.91 (d, J=16.0 Hz, 1H), 7.00 (d, J=16.0 Hz, 1H), 7.00 (d, J=1.2 Hz, 1H), 7.11 (d, J=1.2 Hz, 1H), 7.15 (d, J=6.0 Hz, 1H), 7.27 (d, J=6.0 Hz, 1H); ¹³C NMR (100 MHz, CDCl₃) δ: 110.5, 112.3, 121.8, 121.9, 122.3, 124.5, 126.5, 128.3, 137.4, 143.4. Z-A13: ¹H NMR (400 MHz, CDCl₃) δ: 6.33 (d, J=12.0 Hz, 1H), 6.68 (d, 12.0 Hz, 1H), 6.88 (d, J=5.6 Hz, 1H), 6.90 (br. s, 1H), 7.08 (d, J=1.2 Hz, 1H), 7.25 (d, J=5.6 Hz, 1H); ¹³C NMR (100 MHz, CDCl₃) δ: 109.7, 113.2, 123.3, 123.6, 124.1, 126.4, 127.9, 130.4, 136.9, 140.6. HRMS [M]⁺ m/z calcd. 347.8278. found 347.8282.

When A13 was prepared in accordance with general procedure B from the reaction of 4-bromo-2-thiophenecarboxaldehyde (229 mg, 1.2 mmol, 1.2 equiv.), 2-bromo-3-(bromomethyl)thiophene (130 μL, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 0.1 mmol, 10 mol %) in toluene (0.33 mL) at 140° C. for 24 h, yield was 89% (312 mg, E/Z 75:25).

When A13 was prepared in accordance with general procedure B from the reaction of 4-bromo-2-thiophenecarboxaldehyde (229 mg, 1.2 mmol, 1.2 equiv.), 2-bromo-3-(bromomethyl)thiophene (130 μL, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 0.1 mmol, 10 mol %) in toluene (0.33 mL) at 140° C. for 24 h, yield was 90% (315 mg, E/Z 90:10).

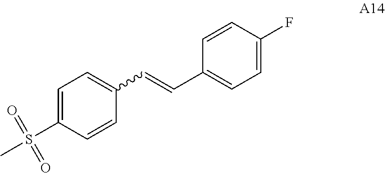 [SMILES: CS(=O)(=O)c1ccc(C=Cc2ccc(F)cc2)cc1]

1-Fluoro-4-(2-(4-(methylsulfonyl)phenyl)ethenyl)benzene (A14) was obtained in accordance with general procedure A from the reaction of 4-(methylsulfonyl)benzaldehyde (221 mg, 1.2 mmol, 1.2 equiv.), 4-fluorobenzyl bromide (125 μL, 1.0 mmol, 1.0 equiv.), diphenylsilane (223 μL, 1.2 mmol, 1.2 equiv.) and A2 (280 mg, 2.0 mmol, 2.0 equiv.) using A3a (23 mg, 0.1 mmol, 10 mol %) in toluene (1.0 mL) at 110° C. for 24 h. The crude product was purified via flash column chromatography (0.5% ethyl acetate in benzene, R_{f}=0.28) to afford an isomeric mixture of A14 as a white solid (199 mg, 72%, E/Z 85:15). E-A14: ¹H NMR (400 MHz, CDCl₃) δ: 3.07 (s, 3H), 7.04 (d, J=16.4 Hz, 1H), 7.07 (t, J=8.8 Hz, 2H), 7.20 (d, J=16.4 Hz, 1H), 7.51 (dd, J=8.8 Hz, 5.6 Hz, 2H), 7.65 (d, J=8.4 Hz, 2H), 7.91 (d, J=8.4 Hz, 2H). Z-A14: ¹H NMR (400 MHz, CDCl₃) δ: 3.05 (s, 3H), 6.58 (d, J=12.0 Hz, 1H), 6.72 (d, J=12.0 Hz, 1H), 6.94 (t, J=8.4 Hz, 2H), 7.17 (dd, J=8.4 Hz, 5.6 Hz, 2H), 7.39 (d, J=8.4 Hz, 2H), 7.79 (d, J=8.4 Hz, 2H).

When A14 was prepared in accordance with general procedure B from the reaction of 4-(methylsulfonyl)benzaldehyde (221 mg, 1.2 mmol, 1.2 equiv.), 4-fluorobenzyl bromide (125 μL, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 0.1 mmol, 10 mol %) in toluene (0.33 mL) at 140° C. for 24 h, yield was 87% (240 mg, E/Z 66:34).

When A14 was prepared in accordance with general procedure B from the reaction of 4-(methylsulfonyl)benzaldehyde (221 mg, 1.2 mmol, 1.2 equiv.), 4-fluorobenzyl bromide (125 μL, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 0.1 mmol, 10 mol %) in toluene (0.33 mL) at 140° C. for 24 h, yield was 94% (260 mg, E/Z 85:15).

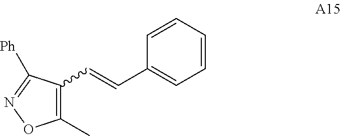 [SMILES: Cc1onc(-c2ccccc2)c1C=Cc1ccccc1]

1-(5-Methyl-3-phenyl-4-isoxazolyl)-2-phenylethene (A15) was obtained in accordance with general procedure B from the reaction of 5-methyl-3-phenylisoxazole-4-carboxaldehyde (225 mg, 1.2 mmol, 1.2 equiv.), benzyl bromide (120 μL, 1.0 mmol, 1.0 equiv.), diphenylsilane (223 μL, 1.2 mmol, 1.2 equiv.) and DIPEA (210 μL, 1.2 mmol, 1.2 equiv.) using A1d (32 mg, 0.1 mmol, 10 mol %) in toluene (0.33 mL) at 140° C. for 24 h. The crude product was purified via flash column chromatography (benzene/hexane, 50:50, E-A15: R_{f}=0.17, Z-A15: R_{f}=0.31) to afford both E-A15 and Z-A15 as pale yellow oils (211 mg, 81%, E/Z 70:30). E-A15: ¹H NMR (400 MHz, CDCl₃) δ: 2.51 (s, 3H), 6.60 (d, J=16.4 Hz, 1H), 6.71 (d, J=16.4 Hz, 1H), 7.15-7.20 (m, 1H), 7.25 (br. t, J=7.2 Hz, 2H), 7.30-7.32 (m, 2H), 7.37-7.40 (m, 3H), 7.57-7.61 (m, 2H); ¹³C NMR (100 MHz, CDCl₃) δ: 12.5, 112.7, 116.7, 126.3, 128.0, 128.7, 128.8, 128.9, 129.5, 129.7, 132.3, 137.0, 161.7, 166.3. Z-A15: ¹H NMR (400 MHz, CDCl₃) δ: 1.95 (d, J=0.8 Hz, 3H), 6.28 (dd, J=12.0 Hz, 0.8 Hz, 1H), 6.79 (d, J=12.0 Hz, 1H), 7.18-7.29 (m, 5H), 7.44-7.47 (m, 3H), 7.81-7.86 (m, 2H); ¹³C NMR (100 MHz, CDCl₃) δ: 11.0, 111.5, 118.1, 127.6, 127.9, 128.4, 128.7, 128.8, 129.6, 129.8, 134.1, 136.8, 161.7, 166.3. HRMS [M+H]⁺ m/z calcd 262.1232. found 262.1228.

When A15 was prepared in accordance with general procedure B from the reaction of 5-methyl-3-phenylisoxazole-4-carboxaldehyde (225 mg, 1.2 mmol, 1.2 equiv.), benzyl bromide (120 μL, 1.0 mmol, 1.0 equiv.), diphenylsilane (223 μL, 1.2 mmol, 1.2 equiv.) and DIPEA (210 μL, 1.2 mmol, 1.2 equiv.) using A3c (37 mg, 0.1 mmol, 10 mol %) in toluene (0.33 mL) at 140° C. for 24 h, yield was 80% (211 mg, E/Z 90:10).

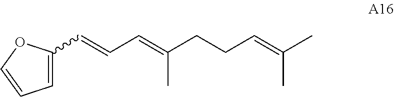 [SMILES: CC(C)=CCC/C(C)=C/C=Cc1ccco1]

(3E)-1-(2-Furyl)-4,8-dimethylnona-1,3,7-triene (A16) was obtained in accordance with general procedure X from the reaction of furfural (83 μL, 1.0 mmol, 1.0 equiv.), geranyl bromide (238 μL, 1.2 mmol, 1.2 equiv.), diphenylsilane (223 μL, 1.2 mmol, 1.2 equiv.) and A2 (280 mg, 2.0 mmol, 2.0 equiv.) using A1a (32 mg, 0.15 mmol, 15 mol %) in toluene (1.0 mL) at 110° C. for 24 h using a portion-wise addition process. The crude product was purified via flash column chromatography (hexane, R_{f}=0.42) to afford an isomeric mixture of A16 as a pale yellow liquid (139 mg, 64%, E/Z 66:34). E-A16: ¹H NMR (400 MHz, CDCl₃) δ: 1.64 (s, 3H), 1.71 (s, 3H), 1.86 (s, 3H), 2.00-2.31 (m, 4H), 5.11-5.19 (m, 1H), 5.96 (d, J=11.2 Hz, 1H), 6.21 (d, J=3.2 Hz, 1H), 6.26 (d, J=15.6 Hz, 1H), 6.40 (br. d, J=11.6 Hz, 1H), 6.93 (dd, J=15.2 Hz, 11.6 Hz, 1H), 7.35 (br. s, 1H). Z-A16: ¹H NMR (400 MHz, CDCl₃) δ: 1.65 (s, 3H), 1.71 (s, 3H), 1.85 (s, 3H), 2.00-2.31 (m, 4H), 5.11-5.19 (m, 1H), 6.06 (d, J=12.0 Hz, 1H), 6.28 (d, J=11.6 Hz, 1H), 6.32 (d, J=2.8 Hz, 1H), 6.40 (br. d, J=11.6 Hz, 1H), 6.79 (d, J=11.2 Hz, 1H), 7.43 (br. s, 1H). E+Z-A16: ¹³C NMR (100 MHz, CDCl₃) δ: 16.8, 17.1, 17.9, 18.0, 25.9, 26.7, 26.8, 27.1, 40.3, 40.6, 107.3, 109.8, 111.4, 111.6, 114.6, 117.8, 122.2, 123.8, 124.0, 124.1, 124.6, 132.0, 140.7, 141.7, 142.0, 142.7, 154.0, 154.1. HRMS [M]⁺ m/z calcd. 216.1514. found 216.1507.

When A16 was prepared in accordance with general procedure X from the reaction of furfural (83 μL, 1.0 mmol, 1.0 equiv.), geranyl bromide (238 μL, 1.2 mmol, 1.2 equiv.), diphenylsilane (223 μL, 1.2 mmol, 1.2 equiv.) and A2 (280 mg, 2.0 mmol, 2.0 equiv.) using A3a (35 mg, 0.15 mmol, 15 mol %) in toluene (1.0 mL) at 110° C. for 24 h, yield was 64% (139 mg, E/Z 85:15).

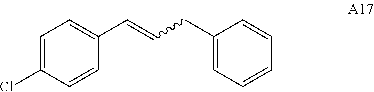 [SMILES: Clc1ccc(C=CCc2ccccc2)cc1]

1-(4-Chlorophenyl)-3-phenylprop-1-ene (A17) was obtained in accordance with general procedure C from the reaction of 4-chlorobenzaldehyde (169 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (280 mg, 2.0 mmol, 2.0 equiv.) using A1d (63 mg, 20 mol %) in toluene (1.4 mL) at 140° C. for 48 h. An additional portion of A2 (210 mg, 1.5 mmol, 1.5 equiv.) was added at 24 h. The crude product was purified via flash column chromatography (hexane, R_{f}=0.45) to afford an isomeric mixture of A17 as a colorless liquid (166 mg, 73%, E/Z 55:45). E-A17: ¹H NMR (400 MHz, CDCl₃) δ: 3.54 (d, J=6.0 Hz, 2H), 6.33 (dt, J=16.0 Hz, 6.0 Hz, 1H), 6.40 (d, J=16.0 Hz, 1H), 7.21-7.34 (m, 9H). Z-A17: ¹H NMR (400 MHz, CDCl₃) δ: 3.64 (d, J=7.6 Hz, 2H), 5.89 (dt, J=11.6 Hz, 7.6 Hz, 1H), 6.54 (d, J=11.6 Hz, 1H), 7.18-7.34 (m, 9H).

When A17 was prepared in accordance with general procedure C from the reaction of 4-chlorobenzaldehyde (169 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (490 mg, 3.5 mmol, 3.5 equiv.) using A3a (47 mg, 20 mol %) in toluene (1.4 mL) at 140° C. for 48 h, yield was 63% (144 mg, E/Z 75:25).

When A17 was prepared in accordance with general procedure C from the reaction of 4-chlorobenzaldehyde (169 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (490 mg, 3.5 mmol, 3.5 equiv.) using A3b (60 mg, 20 mol %) in toluene (1.4 mL) at 140° C. for 48 h, yield was 95% (217 mg, E/Z 75:25).

When A17 was prepared in accordance with general procedure C from the reaction of 4-chlorobenzaldehyde (169 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (490 mg, 3.5 mmol, 3.5 equiv.) using A3b (60 mg, 20 mol %) in toluene (1.4 mL) at 140° C. for 24 h, yield was 74% (169 mg, E/Z 75:25).

When A17 was prepared in accordance with general procedure C from the reaction of 4-chlorobenzaldehyde (169 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (490 mg, 3.5 mmol, 3.5 equiv.) using A3c (75 mg, 20 mol %) in toluene (1.4 mL) at 140° C. for 48 h, yield was 83% (189 mg, E/Z 75:25).

When A17 was prepared in accordance with general procedure C from the reaction of 4-chlorobenzaldehyde (169 mg, 1.2 mmol, 1.2 equiv.), (2-bromoethyl)benzene (137 μL, 1.0 mmol, 1.0 equiv.), diphenylsilane (223 μL, 1.2 mmol, 1.2 equiv.) and A2 (490 mg, 3.5 mmol, 3.5 equiv.) using A3b (60 mg, 20 mol %) in toluene (1.4 mL) at 140° C. for 48 h, yield was 76% (174 mg, E/Z 75:25).

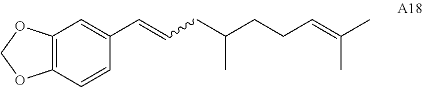 [SMILES: CC(C)=CCCC(C)CC=Cc1ccc2c(c1)OCO2]

5-(4,8-Dimethylnona-1,7-dien-1-yl)-1,3-benzodioxole (A18) was obtained in accordance with general procedure C from the reaction of piperonal (180 mg, 1.2 mmol, 1.2 equiv.), 8-iodo-2,6-dimethyl-oct-2-ene (266 mg, 1.0 mmol, 1.0 equiv.), diphenylsilane (223 μL, 1.2 mmol, 1.2 equiv.) and A2 (280 mg, 2.0 mmol, 2.0 equiv.) using A1d (63 mg, 20 mol %) in toluene (1.4 mL) at 140° C. for 48 h. An additional portion of A2 (210 mg, 1.5 mmol, 1.5 equiv.) was added at 24 h. The crude product was purified via flash column chromatography (8% benzene in hexane, R_{f}=0.34) to afford an isomeric mixture of A18 as a colorless liquid (144 mg, 53%, E/Z 55:45). E-A18: ¹H NMR (400 MHz, CDCl₃) δ: 0.97 (d, J=6.8 Hz, 3H), 1.18-1.51 (m, 3H), 1.66 (s, 3H), 1.76 (s, 3H), 1.98-2.40 (m, 4H), 4.71-4.74 (m, 1H), 5.94 (,s, 2H), 6.08 (dt, J=15.6 Hz, 7.2 Hz, 1H), 6.32 (d, J=15.6 Hz, 1H), 6.75-7.00 (m, 3H); ¹³C NMR (100 MHz, CDCl₃) δ: 17.7, 19.6, 25.7, 25.8, 33.1, 36.8, 40.5, 101.0, 105.5, 108.2, 121.1, 124.9, 127.9, 130.6, 131.2, 132.6, 146.6, 148.0. Z-A18: ¹H NMR (400 MHz, CDCl₃) δ: 0.97 (d, J=6.8 Hz, 3H), 1.18-1.51 (m, 3H), 1.64 (s, 3H), 1.73 (s, 3H), 1.98-2.40 (m, 4H), 5.14-5.16 (m, 1H), 5.63 (dt, J=11.6 Hz, 7.2 Hz, 1H), 5.96 (s, 2H), 6.39 (d, J=11.6 Hz, 1H), 6.75-7.00 (m, 3H); ¹³C NMR (100 MHz, CDCl₃) δ: 17.7, 19.7, 25.7, 25.8, 33.5, 35.8, 36.9, 100.9, 108.1, 109.1, 120.3, 122.6, 124.9, 129.1, 130.8, 132.1, 146.1, 147.5. HRMS [M]⁺ m/z calcd. 272.1776. found 272.1770.

When A18 was prepared in accordance with general procedure C from the reaction of piperonal (180 mg, 1.2 mmol, 1.2 equiv.), 8-iodo-2,6-dimethyl-oct-2-ene (266 mg, 1.0 mmol, 1.0 equiv.), diphenylsilane (223 μL, 1.2 mmol, 1.2 equiv.) and A2 (280 mg, 2.0 mmol, 2.0 equiv.) using A3b (60 mg, 20 mol %) in toluene (1.4 mL) at 140° C. for 48 h, yield was 77% (210 mg, E/Z 78:22).

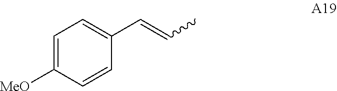

1-Methoxy-4-(prop-1-en-1-yl)benzene (A19) was obtained from the reaction of 4-anisaldehyde (136 mg, 1.0 mmol, 1.0 equiv.), iodoethane (80 μL, 1.0 mmol, 1.0 equiv.), diphenylsilane (223 μL, 1.2 mmol, 1.2 equiv.) and A2 (280 mg, 2.0 mmol, 2.0 equiv.) using A1d (63 mg, 20 mol %) in toluene (1.4 mL) at 150° C. for 48 h. Additional portions of A2 (210 mg, 1.5 mmol, 1.5 equiv.) and iodoethane (80 μL, 1.0 mmol, 1.0 equiv.) were added at 24 h. The crude product was purified via flash column chromatography (gradient 5-10% benzene in hexane, R_{f} (7% benzene in hexane)=0.31) to afford an isomeric mixture of A19 as a colorless liquid (94 mg, 63%, E/Z 55:45). E-A19: ¹H NMR (400 MHz, CDCl₃) δ: 1.90 (dd, J=6.4 Hz, 1.6 Hz, 3H), 3.83 (s, 3H), 6.14 (dq, J=15.6 Hz, 6.8 Hz, 1H), 6.37-6.43 (m, 1H), 6.88 (d, J=8.4 Hz, 2H), 7.27-7.31 (m, 2H). Z-A19: ¹H NMR (400 MHz, CDCl₃) δ: 1.94 (dd, J=7.2 Hz, 1.6 Hz, 3H), 3.85 (s, 3H), 5.75 (dq, J=11.6 Hz, 6.8 Hz, 1H), 6.37-6.43 (m, 1H), 6.93 (d, J=8.4 Hz, 2H), 7.27-7.31 (m, 2H).

When A19 was prepared from the reaction of 4-anisaldehyde (136 mg, 1.0 mmol, 1.0 equiv.), iodoethane (80 μL, 1.0 mmol, 1.0 equiv.), diphenylsilane (223 μL, 1.2 mmol, 1.2 equiv.) and A2 (280 mg, 2.0 mmol, 2.0 equiv.) using A3b (60 mg, 20 mol %) in toluene (1.4 mL) at 140° C. for 48 h (with additional portions of A2 (210 mg, 1.5 mmol, 1.5 equiv.) and iodoethane (80 μL, 1.0 mmol, 1.0 equiv.) added at 24 h), yield was 70% (104 mg, E/Z 75:25).

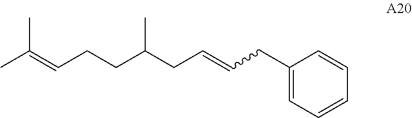 [SMILES: CC(C)=CCCC(C)CC=CCc1ccccc1]

5,9-Dimethyl-1-phenyl-2,8-decadiene (A20) was obtained in accordance with general procedure C from the reaction of (±)-citronellal (216 μL, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (280 mg, 2.0 mmol, 2.0 equiv.) using A1d (63 mg, 20 mol %) in toluene (1.4 mL) at 140° C. for 24 h. The crude product was purified via flash column chromatography (hexane, R_{f}=0.82) to afford an isomeric mixture of A20 as a colorless liquid (121 mg, 50%, E/Z 60:40). E-A20: ¹H NMR (400 MHz, CDCl₃) δ: 0.96 (d, J=6.8 Hz, 3H), 1.19-1.61 (m, 3H), 1.65 (s, 3H), 1.73 (s, 3H), 1.88-2.24 (m, 4H), 3.44 (d, J=7.2 Hz, 2H), 5.13-5.17 (m, 1H), 5.53-5.68 (m, 2H), 7.20-7.36 (m, 5H); ¹³C NMR (100 MHz, CDCl₃) δ: 17.8, 19.7, 25.8, 25.9, 33.2, 33.7, 34.6, 37.0, 125.0, 125.9, 128.5, 128.5, 129.0, 129.7, 131.3, 141.4. Z-A20: ¹H NMR (400 MHz, CDCl₃) δ: 0.92 (d, J=6.4 Hz, 3H), 1.19-1.61 (m, 3H), 1.64 (s, 3H), 1.73 (s, 3H), 1.88-2.24 (m, 4H), 3.39 (d, J=7.2 Hz, 2H), 5.13-5.17 (m, 1H), 5.58-5.68 (m, 2H), 7.20-7.36 (m, 5H); ¹³C NMR (100 MHz, CDCl₃) δ: 17.8, 19.6, 25.7, 25.9, 32.9, 33.5, 34.7, 36.8, 125.0, 126.0, 127.0, 128.5, 130.1, 130.7, 131.2, 141.2. HRMS [M]⁺ m/z calcd. 242.2035. found 242.2033.

When A20 was prepared in accordance with general procedure C from the reaction of (±)-citronellal (216 μL, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (280 mg, 2.0 mmol, 2.0 equiv.) using A3b (60 mg, 20 mol %) in toluene (1.4 mL) at 140° C. for 48 h, yield was 68% (165 mg, E/Z 75:25).

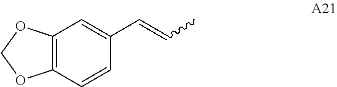

5-(Prop-1-en-1-yl)-1,3-benzodioxole (A21) was obtained from the reaction of piperonal (150 mg, 1.0 mmol, 1.0 equiv.), iodoethane (80 μL, 1.0 mmol, 1.0 equiv.), diphenylsilane (223 μL, 1.2 mmol, 1.2 equiv.) and A2 (280 mg, 2.0 mmol, 2.0 equiv.) using A1d (63 mg, 20 mol %) in toluene (1.4 mL) at 150° C. for 48 h. Additional portions of A2 (210 mg, 1.5 mmol, 1.5 equiv.) and iodoethane (80 μL, 1.0 mmol, 1.0 equiv.) were added at 24 h. The crude product was purified via flash column chromatography (5% benzene in hexane, R_{f}=0.34) to afford an isomeric mixture of A21 as a colorless liquid (111 mg, 68%, E/Z 60:40). E-A21: ¹H NMR (400 MHz, CDCl₃) δ: 1.86 (dd, J=6.8 Hz, 1.6 Hz, 3H), 5.94 (s, 2H), 6.07 (dq, J=16.0 Hz, 6.8 Hz, 1H), 6.23-6.36 (m, 1H), 6.73-6.89 (m, 3H). Z-A21: ¹H NMR (400 MHz, CDCl₃) δ: 1.89 (dd, J=7.2 Hz, 2.0 Hz, 3H), 5.71 (dq, J=11.6 Hz, 7.2 Hz, 1H), 5.96 (s, 2H), 6.23-6.36 (m, 1H), 6.73-6.89 (m, 3H).

When A21 was prepared from the reaction of piperonal (150 mg, 1.0 mmol, 1.0 equiv.), iodoethane (80 μL, 1.0 mmol, 1.0 equiv.), diphenylsilane (223 μL, 1.2 mmol, 1.2 equiv.) and A2 (280 mg, 2.0 mmol, 2.0 equiv.) using A3b (60 mg, 20 mol %) in toluene (1.4 mL) at 140° C. for 48 h (with additional portions of A2 (210 mg, 1.5 mmol, 1.5 equiv.) and iodoethane (80 μL, 1.0 mmol, 1.0 equiv.) added at 24 h), yield was 74% (120 mg, E/Z 75:25).

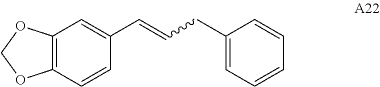 [SMILES: C(=Cc1ccc2c(c1)OCO2)Cc1ccccc1]

5-(3-phenylprop-1-en-1-yl)-1,3-benzodioxole (A22) was obtained in accordance with general procedure C from the reaction of piperonal (180 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (280 mg, 2.0 mmol, 2.0 equiv.) using A1d (63 mg, 20 mol %) in toluene (1.4 mL) at 140° C. for 48 h. An additional portion of A2 (210 mg, 1.5 mmol, 1.5 equiv.) was added at 24 h. The crude product was purified via flash column chromatography (hexane/benzene, 80:20, R_{f}=0.33) to afford an isomeric mixture of A22 as a pale yellow liquid (179 mg, 75%, E/Z 60:40). E-A22: ¹H NMR (400 MHz, CDCl₃) δ: 3.57 (d, J=6.8 Hz, 2H), 5.96 (s, 2H), 6.24 (dt, J=16.0 Hz, 6.8 Hz, 1H), 6.42 (d, J=16.0 Hz, 1H), 6.78-6.86 (m, 2H), 6.97 (br. s, 1H), 7.25-7.39 (m, 5H); ¹³C NMR (100 MHz, CDCl₃) δ: 39.3, 101.0, 108.3, 120.7, 126.3, 127.6, 128.6, 128.7, 130.7, 132.1, 134.4, 140.4, 146.9, 148.9. Z-A22: ¹H NMR (400 MHz, CDCl₃) δ: 3.72 (d, J=7.6 Hz, 2H), 5.84 (dt, J=11.6 Hz, 7.6 Hz, 1H), 5.98 (s, 2H), 6.55 (d, J=11.6 Hz, 1H), 6.78-6.86 (m, 2H), 6.90 (br. s, 1H), 7.25-7.39 (m, 5H); ¹³C NMR (100 MHz, CDCl₃) δ: 34.8, 108.3, 109.0, 122.5, 126.2, 128.4, 128.6, 129.6, 129.8, 130.2, 131.4, 140.9, 146.5, 147.6. HRMS [M]⁺ m/z calcd. 238.0994. found 238.0997.

When A22 was prepared in accordance with general procedure C from the reaction of piperonal (180 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (490 mg, 3.5 mmol, 3.5 equiv.) using A3c (75 mg, 20 mol %) in toluene (1.4 mL) at 140° C. for 48 h, yield was 71% (144 mg, E/Z 75:25).

When A22 was prepared in accordance with general procedure C from the reaction of piperonal (180 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (490 mg, 3.5 mmol, 3.5 equiv.) using A3b (60 mg, 20 mol %) in toluene (1.4 mL) at 140° C. for 48 h, yield was E/Z 75:25).

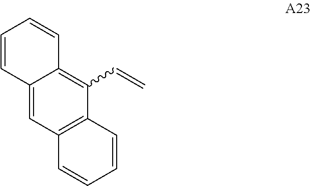 [SMILES: C=Cc1c2ccccc2cc2ccccc12]

When A22 was prepared in accordance with general procedure C from the reaction of piperonal (180 mg, 1.2 mmol, 1.2 equiv.), (2-iodoethyl)benzene (145 μL, 1.0 mmol, 1.0 equiv.), diphenylsilane (223 μL, 1.2 mmol, 1.2 equiv.) and A2 (490 mg, 3.5 mmol, 3.5 equiv.) using A3b (60 mg, 20 mol %) in toluene (1.4 mL) at 140° C. for 24 h, yield was 76% (181 mg, E/Z 75:25).

9-Ethenylanthracene (A23) was obtained from the reaction of 9-anthracenecarboxaldehyde (128 mg, 0.6 mmol, 1.2 equiv.), methyl iodide (31 μL, 0.5 mmol, 1.0 equiv.), diphenylsilane (112 μL, 0.6 mmol, 1.2 equiv.) and A2 (210 mg, 1.5 mmol, 3.0 equiv.) using A3b (30 mg, 20 mol %) in toluene (0.7 mL) at 140° C. for 24 h. Methyl iodide and A2 were added in two portions, at 0 h and 4 h. The crude product was purified via flash column chromatography (hexane, R_{f}=0.35) to afford A23 as a yellow liquid (66 mg, 65%). ¹H NMR (400 MHz, CDCl₃) δ: 5.68 (d, J=18.0 Hz, 1H), 6.06 (d, J=11.5 Hz, 1H), 7.48-7.60 (m, 5H), 8.00-8.08 (m, 2H), 8.35-8.40 (m, 2H).

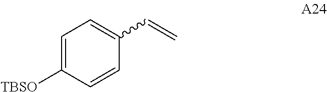 [SMILES: C=Cc1ccc(O[Si](C)(C)C(C)(C)C)cc1]

1-[[(1,1-Dimethylethyl)dimethylsilyl]oxy]-4-ethenylbenzene (A24) was obtained from the reaction of 4-[[(1,1-dimethylethyl)dimethylsilyl]oxy]benzaldehyde (142 mg, 0.6 mmol, 1.2 equiv.), methyl iodide (31 μL, 0.5 mmol, 1.0 equiv.), diphenylsilane (112 μL, 0.6 mmol, 1.2 equiv.) and A2 (140 mg, 1.0 mmol, 2.0 equiv.) using A3b (30 mg, 20 mol %) in toluene (0.7 mL) at 140° C. for 24 h. Methyl iodide and A2 were added in two portions, at 0 h and 4 h. The crude product was purified via flash column chromatography (hexane, R_{f}=0.30) to afford A24 as colorless liquid (52 mg, 44%). ¹H NMR (400 MHz, CDCl₃) δ: 3.05 (s, 3H), 5.46 (d, J=11.0 Hz, 1H), 5.91 (d, J=17.5 Hz, 1H), 5.46 (dd, J=11.0 Hz, 17.7 Hz, 1H), 7.57 (d, J=8.3 Hz, 2H), 7.89 (d, J=5.5 Hz, 2H).

Development of the Ketone olefination protocol: In air, a 1-dram vial equipped with a stir-bar was charged with phosphine oxide (15 mol %) and A2 (0.5-1.0 equiv.). The vial was then sealed with a septum and purged with argon. Toluene (1.0 mL), acetophenone (117 μL, 1.2 mmol, 1.2 equiv.) and diphenylsilane (1.2 mmol, 1.2 equiv.) were introduced at this time. Addition of A2 and benzyl bromide (1.0-1.35 equiv.) was varied as detailed in Table S4. The reactions were conducted at 110° C. unless otherwise stated. The crude reaction mixture was filtered through Celite®, concentrated in vacuo and ¹H NMR spectroscopy analysis was used to determine conversion and E/Z ratio, as shown in Table S4.

TABLE S4
Development of Ketone olefination protocol.

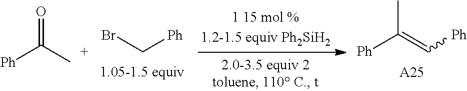

| | | Halide | Base | | | Conv. (%) | |
|---|---|---|---|---|---|---|---|
| Entry | P═O | (equiv.) | (equiv.) | Conditions | t (h) | (Yield)^{[a]} | E/Z^{[b]} |
| 1 | A1b | 1.50 | 2.0 | All-in | 24 | 0^{[c]} | — |
| 2 | A1b | 1.50 | 2.0 | Portion-wise addition of halide (8 | 24 | 91^{[d]} | — |
| | | | | additions, 1 h intervals) | | | |
| 3 | A1a | 1.05 | 2.0 | olefination: halide (7 additions), base (2 × | 24 | 65 (58) | 65:35 |
| | | | | 1.0 equiv., 0 h and after 4^{th} addition of | | | |
| | | | | halide); Heating cycle: 30 min at RT, 1.5 h | | | |
| | | | | heating | | | |
| 4 | A1a | 1.23 | 2.0 | olefination: halide (7 additions), base (4 × | 24 | 52 | 65:35 |
| | | | | 0.5 equiv., 0 h and after 3^{rd}, 4^{th} and 6^{th} | | | |
| | | | | additions of halide); Heating cycle: 30 | | | |
| | | | | min at RT, 1.5 h heating | | | |
| 5 | A1a | 1.20 | 3.0 | olefination: halide (8 additions), base (3 × | 31 | 75 (72) | 63:37 |
| | | | | 1.0 equiv., 0 h and after 3^{rd} and 6^{th} | | | |
| | | | | additions of halide); Heating cycle: 30 | | | |
| | | | | min at RT, 2.2 h heating^{[e]} | | | |
| 6 | A1a | 1.35 | 3.5 | olefination: halide (9 additions), base (3 × | 36 | 97 (87) | 66:34 |
| | | | | 1.0 equiv., 0 h and after 3^{rd} and 6^{th} | | | |
| | | | | additions of halide, 1 x 0.5 equiv. after | | | |
| | | | | 8^{th} addition of halide); Heating cycle: 30 | | | |
| | | | | min at RT, 2.2 h heating^{[e]} | | | |

^{[a]}Conversions were determined by ¹H NMR spectroscopy, based on residual ketone. Isolated yields shown in parentheses.
^{[b]}E/Z ratio was determined by ¹H NMR spectroscopy of the unpurified reaction mixture.
[c]No halide or silane remaining.
^{[d]}The only product observed was 1,3-diphenylpropanone, which is the result of α-deprotonation of the ketone.
^{[e]}Stirred for 10 h at 110° C. between 5^{th} and 6^{th} cycles. Additional diphenylsilane (0.3 equiv.) was added after this time.

### General Procedure D: Preparation of Compounds A25-A30 Via Catalytic Wittig Reaction Using Ketone Olefination Protocol.

In air, a 1-dram vial equipped with a stir-bar was charged with A1a (0.15 mmol, 15 mol %) and A2 (1.0 mmol, 1.0 equiv.). If solid, ketone (1.0 mmol, 1.0 equiv.) was also added at this point. The vial was then sealed with a septum and purged with argon. Toluene (1.0 mL) and ketone (1.0 mmol, 1.0 equiv.), if liquid, were added via syringe. Diphenylsilane (1.2 mmol, 1.2 equiv.) was introduced and the septum was replaced with a PTFE-lined screw cap under an inert atmosphere, and the reaction was heated at 110° C. for 30 min. The reaction was cooled to RT and organohalide (0.15 mmol, 0.15 equiv.) was added. The reaction was stirred at RT for 30 min, then returned to 110° C. for 2 h. This process was repeated until 9 additions of halide were carried out. Additional base was introduced after the 3^{rd} (1.0 mmol, 1.0 equiv.), 6^{th} (1.0 mmol, 1.0 equiv.) and 8^{th} (0.5 mmol, 0.5 equiv.) additions. If required, the reaction was allowed to stir at 110° C. overnight (10 h) between the 5^{th} and 6^{th} addition. The crude reaction mixture was filtered through Celite®, concentrated in vacuo, and purified via flash column chromatography.

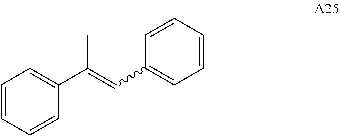

1,2-Diphenylprop-1-ene (A25) was obtained in accordance with general procedure D from the reaction of acetophenone (117 μL, 1.0 mmol, 1.0 equiv.), benzyl bromide (160 μL, 1.3 mmol, 1.3 equiv.), diphenylsilane (279 μL, 1.2 mmol, 1.2 equiv.) and A2 (490 mg, 3.5 mmol, 3.5 equiv.) using A1a (32 mg, 0.15 mmol, 15 mol %) in toluene (1.0 mL) using the pulse olefination technique. The crude product was purified via flash column chromatography (hexane, R_{f}=0.28) to afford an isomeric mixture of A25 as a white solid (168 mg, 86%, E/Z 65:35). E-A25: ¹H NMR (400 MHz, CDCl₃) δ: 2.18 (d, J=1.5 Hz, 3H), 6.74 (br. d, J=1.2 Hz, 1H), 6.83-7.44 (m, 5H). Z-A25: ¹H NMR (400 MHz, CDCl₃) δ: 2.10 (d, J=1.5 Hz, 3H), 6.37 (br. d, J=1.3 Hz, 1H), 6.83-7.44 (m, 5H).

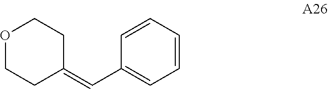 [SMILES: C(=C1CCOCC1)c1ccccc1]

4-Benzylidenetetrahydro-2H-pyran (A26) was obtained in accordance with general procedure D from the reaction of tetrahydro-4H-pyran-4-one (92 μL, 1.0 mmol, 1.0 equiv.), benzyl bromide (160 μL, 1.3 mmol, 1.3 equiv.), diphenylsilane (279 μL, 1.2 mmol, 1.2 equiv.) and A2 (490 mg, 3.5 mmol, 3.5 equiv.) using A1a (32 mg, 0.15 mmol, 15 mol %) in toluene (1.0 mL) using the pulse olefination technique. The crude product was purified via flash column chromatography (benzene/hexane gradient 5-100%, R_{f} (benzene)=0.36) to afford A26 as a yellow oil (105 mg, 60%). ¹H NMR (400 MHz, CDCl₃) δ: 2.41 (td, J=5.6 Hz, 1.3 Hz, 2H), 2.54 (td, J=5.6 Hz, 1.3 Hz, 2H), 3.67 (t, J=5.6 Hz, 2H), 3.80 (t, J=5.6 Hz, 2H), 6.35 (s, 1H), 7.19-7.23 (m, 3H), 7.31-7.35 (m, 2H); ¹³C NMR (100 MHz, CDCl₃) δ: 30.7, 37.3, 68.6, 69.5, 124.0, 126.3, 128.3, 128.9, 137.5, 137.8.

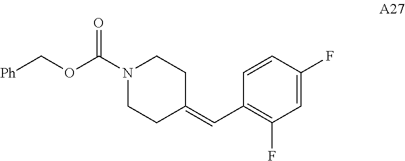 [SMILES: O=C(OCc1ccccc1)N1CCC(=Cc2ccc(F)cc2F)CC1]

Benzyl 4-(2,4-difluorobenzylidene)piperidine-1-carboxylate (A27) was obtained in accordance with general procedure D from the reaction of 2-acetyl-5-methylfuran (116 μL, 1.0 mmol, 1.0 equiv.), 2,4-difluorobenzyl bromide (167 μL, 1.3 mmol, 1.3 equiv.), diphenylsilane (279 μL, 1.2 mmol, 1.2 equiv.) and A2 (490 mg, 3.5 mmol, 3.5 equiv.) using A1a (32 mg, 0.15 mmol, 15 mol %) in toluene (1.0 mL) using the pulse olefination technique. The crude product was purified via flash column chromatography (benzene, R_{f}=0.30) to afford A27 as a colorless oil (299 mg, 87%). ¹H NMR (400 MHz, CDCl₃) δ: 2.25-2.45 (m, 4H), 3.51 (t, J=5.8 Hz, 2H), 3.61 (t, J=5.8 Hz, 2H), 5.17 (s, 2H), 6.22 (s, 1H), 6.76-6.88 (m, 2H), 7.12 (q, J=7.8 Hz, 1H), 7.29-7.41 (m, 5H); ¹³C NMR (100 MHz, CDCl₃) δ: 44.7, 45.6, 67.2, 103.9 (t, J_{CF}=25.5 Hz), 110.9 (dd, J_{CF}=21.1 Hz, 3.6 Hz), 116.6 (d, J_{CF}=1.5 Hz), 121.0 (dd, J_{CF}=15.3 Hz, 3.6 Hz), 128.0, 128.1, 128.6, 131.5 (dd, J_{CF}=9.5 Hz, 5.1 Hz), 134.3-134.7 (m, 2C), 136.8, 140.6, 155.3, 160.1 (dd, J_{CF}=247.3 Hz, 11.6 Hz), 161.8 (dd, J_{CF}=247.3 Hz, 11.6 Hz); ¹⁹F NMR (376 MHz, CDCl₃) δ: −110.3 (d, J=43.5 Hz, 1F), −110.7 (br. s, 1F). HRMS [M+H]⁺ m/z calcd. 344.1462. found 344.1457.

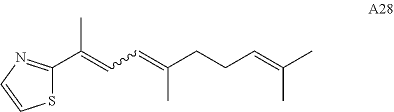 [SMILES: CC(C)=CCCC(C)=CC=C(C)c1nccs1]

5,9-Dimethyl-2-(1,3-thiazol-2-yl)-deca-2,4,8-triene (A28) was obtained in accordance with general procedure D from the reaction of 2-acetylthiazole (104 μL, 1.0 mmol, 1.0 equiv.), geranyl bromide (258 μL, 1.3 mmol, 1.3 equiv.), diphenylsilane (279 μL, 1.2 mmol, 1.2 equiv.) and A2 (490 mg, 3.5 mmol, 3.5 equiv.) using A1a (32 mg, 0.15 mmol, 15 mol %) in toluene (1.0 mL) using the pulse olefination technique. The crude product was purified via flash column chromatography (benzene/hexane, gradient 5-50%, R_{f} (50% benzene in hexane)=0.23) to afford an isomeric mixture of A28 as a yellow oil (178 mg, 72%, E/Z 63:37). E-A28: ¹H NMR (600 MHz, CDCl₃) δ: 1.63 (s, 3H), 1.71 (s, 3H), 1.91 (br. d, J=0.8 Hz, 3H), 2.16-2.21 (m, 4H), 2.26 (br. d, J=0.7 Hz, 3H), 5.10-5.15 (m, 1H), 6.23 (dd, J=11.3 Hz, 1.1 Hz, 1H), 7.16 (d, J=3.4 Hz, 1H), 7.28 (dd, J=11.7 Hz, 1.5 Hz, 1H), 7.75 (d, J=3.0 Hz, 1H); ¹³C NMR (100 MHz, CDCl₃) δ: 15.1, 17.2, 17.8, 25.7, 26.6, 40.7, 117.3, 120.8, 123.8, 126.8, 127.7, 131.9, 143.1, 144.1, 172.3. Z-A28: ¹H NMR (600 MHz, CDCl₃) δ: 1.62 (s, 3H), 1.69 (s, 3H), 1.86 (s, 3H), 2.10-2.37 (m, 4H), 2.31 (s, 3H), 5.12-5.19 (m, 1H), 6.58 (dd, J=11.7 Hz, 1.1 Hz, 1H), 6.96 (d, J=11.6 Hz, 1H), 7.29 (d, J=3.4 Hz, 1H), 7.85 (d, J=3.4 Hz, 1H); ¹³C NMR (100 MHz, CDCl₃) δ: 17.0, 17.8, 24.5, 25.8, 26.7, 40.6, 118.3, 122.0, 124.0, 126.0, 128.4, 131.8, 142.8, 143.9, 167.9. HRMS [M+H]⁺ m/z calcd. 248.1473. found 248.1469.

When A28 was prepared on a 25.0 mmol scale from the reaction of 2-acetylthiazole (3.7 mL, 35.0 mmol, 1.0 equiv.), geranyl bromide (9.9 mL, 47.3 mmol 1.35 equiv.), diphenylsilane (9.8 mL, 51.2 mmol, 1.5 equiv.) and A2 (17.20 g, 122.5 mmol, 3.5 equiv.) using A1a (1.14 g, 5.3 mmol, 15 mol %) in toluene (35 mL), the reaction was prepared in a 100 mL pressure vessel under an inert atmosphere and run at 110° C. for 24 h before purification by dry flash chromatography (benzene/hexane, gradient 10-100%) to afford A28 in 68% yield (5.89 g, E/Z 75:25).

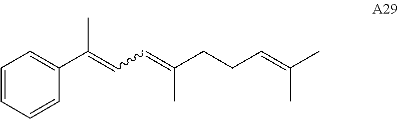 [SMILES: CC(C)=CCCC(C)=CC=C(C)c1ccccc1]

5,9-Dimethyl-2-phenyldeca-2,4,8-triene (A29) was obtained in accordance with general procedure D from the reaction of acetophenone (117 μL, 1.0 mmol, 1.0 equiv.), geranyl bromide (258 μL, 1.3 mmol, 1.3 equiv.), diphenylsilane (279 μL, 1.2 mmol, 1.2 equiv.) and A2 (490 mg, 3.5 mmol, 3.5 equiv.) using A1a (32 mg, 0.15 mmol, 15 mol %) in toluene (1.0 mL) using the pulse olefination technique. The crude product was purified via flash column chromatography (hexane, R_{f}=0.34) to afford an isomeric mixture of A29 as a colorless oil (195 mg, 81%, E/Z 55:45). E-A29: ¹H NMR (400 MHz, CDCl₃) δ: 1.63 (s, 3H), 1.70 (s, 3H), 1.84 (s, 3H), 1.95-2.20 (m, 4H), 2.15 (s, 3H), 5.14 (m, 1H), 6.21 (dd, J=7.5 Hz, 0.8 Hz, 1H), 6.63 (dd, J=7.5 Hz, 0.8 Hz, 1H), 7.20-7.50 (m, 5H). Z-A29: ¹H NMR (400 MHz, CDCl₃) δ: 1.54 (s, 3H), 1.66 (s, 3H), 1.79 (s, 3H), 1.95-2.20 (m, 4H), 2.13 (s, 3H), 5.04 (tt, J=4.2 Hz, 0.8 Hz, 1H), 6.21 (dd, J=7.5 Hz, 0.8 Hz, 1H), 6.63 (dd, J=7.5 Hz, 0.8, 1H), 7.20-7.50 (m, 5H).

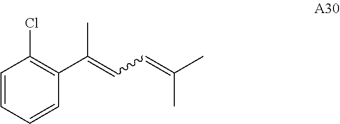

2-(2-Chlorophenyl)-5-methylhexa-2,4-diene (A30) was obtained in accordance with general procedure C from the reaction of 2′-chloroacetophenone (130 μL, 1.0 mmol, 1.0 equiv.), 3,3-dimethylallyl bromide (150 μL, 1.3 mmol, 1.3 equiv.), diphenylsilane (279 μL, 1.2 mmol, 1.2 equiv.) and A2 (490 mg, 3.5 mmol, 3.5 equiv.) using A1a (32 mg, 0.15 mmol, 15 mol %) in toluene (1.0 mL) using the pulse olefination technique. The crude product was purified via flash column chromatography (hexane, R_{f}=0.38) to afford an isomeric mixture of A30 as a yellow oil (143 mg, 69%, E/Z 70:30). E-A30: ¹H NMR (400 MHz, CDCl₃) δ: 1.81 (s, 3H), 1.91 (s, 3H), 2.14 (s, 3H), 6.16-6.21 (m, 1H), 6.27 (br. dq, J=11.4 Hz, 1.3 Hz, 1H), 7.13-7.29 (m, 3H), 7.36-7.39 (m, 1H); ¹³C NMR (100 MHz, CDCl₃) δ: 17.8, 18.5, 26.7, 121.3, 126.6, 126.7, 127.9, 129.7, 130.2, 132.5, 133.7, 136.8, 144.7. Z-A30: ¹H NMR (400 MHz, CDCl₃) δ: 1.69 (s, 3H), 1.82 (s, 3H), 2.11 (s, 3H), 5.42-5.47 (m, 1H), 6.40.

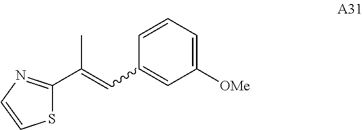 [SMILES: COc1cccc(C=C(C)c2nccs2)c1]

2-(1-(3-Methoxyphenyl)prop-1-en-2-yl]-1,3-thiazole (A31) was obtained in accordance with general procedure D from the reaction of 2-acetylthiazole (104 μL, 1.0 mmol, 1.0 equiv.), 3-methoxybenzyl bromide (182 μL, 1.3 mmol, 1.3 equiv.), diphenylsilane (279 μL, 1.2 mmol, 1.2 equiv.) and A2 (490 mg, 3.5 mmol, 3.5 equiv.) using A1a (32 mg, 0.15 mmol, 15 mol %) in toluene (1.0 mL) using the pulse olefination technique. The crude product was purified via flash column chromatography (5 column lengths of benzene, then 1% diethyl ether in benzene, R_{f} (benzene)=0.26) to afford an isomeric mixture of A31 as a yellow oil (178 mg, 77%, E/Z 65:35). E-A31: ¹H NMR (600 MHz, CDCl₃) δ: 2.44 (s, 3H), 3.83 (s, 3H), 6.85 (dd, J=8.6 Hz, 2.6 Hz, 1H), 6.96 (br. s, 1H), 7.02 (d, J=7.5 Hz, 1H), 7.25 (br. s, 1H), 7.31 (t, J=7.9 Hz, 1H), 7.48 (br. s, 1H), 7.81 (d, J=3.4 Hz, 1H); ¹³C NMR (151 MHz, CDCl₃) δ: 16.8, 55.3, 113.2, 115.0, 118.4, 122.0, 129.4, 130.8, 131.9, 138.0, 143.3, 159.6, 171.9. Z-A31: ¹H NMR (600 MHz, CDCl₃) δ: 2.37 (s, 3H), 3.71 (s, 3H), 6.71 (br. s, 1H), 6.76 (d, J=7.5 Hz, 1H), 6.82 (dd, J=8.3 Hz, 2.6 Hz, 1H), 6.84 (br. s, 1H), 7.48 (br. d, J=2.6 Hz, 1H), 7.21 (t, J=7.9 Hz, 1H), 7.75 (d, J=3.4 Hz, 1H); ¹³C NMR (151 MHz, CDCl₃) δ: 24.4, 55.2, 113.7, 114.1, 119.9, 121.5, 129.7, 131.5, 132.0, 138.3, 142.0, 159.8, 167.0. HRMS [M+H]⁺ m/z calcd. 232.0796. found 232.0804.

When A31 was prepared in accordance with general procedure D from the reaction of 2-acetylthiazole (104 μL, 1.0 mmol, 1.0 equiv.), 3-methoxybenzyl bromide (182 μL, 1.3 mmol, 1.3 equiv.), diphenylsilane (279 μL, 1.2 mmol, 1.2 equiv.) and A2 (490 mg, 3.5 mmol, 3.5 equiv.) using A3a (35 mg, 0.15 mmol, 15 mol %) in toluene (1.0 mL) using the pulse olefination technique, yield was 55% (127 mg, E/Z 80:20).

1. A method for increasing the rate of phosphine oxide reduction during a one-pot catalytic Wittig reaction, wherein the improvement comprises carrying out the reduction in the presence of an acid additive component, wherein the acid additive component is an aryl carboxylic acid.

2. A method for performing a catalytic Wittig reaction, comprising the steps of:
(i) providing a phosphine oxide precatalyst;
(ii) reducing the phosphine oxide precatalyst to produce a phosphine, using an organosilane, in the presence of an acid additive component, wherein the acid additive component is an aryl carboxylic acid;
(iii) forming a phosphonium ylide precursor by reacting the phosphine with a primary or secondary organohalide;
(iv) generating a phosphonium ylide from the phosphonium ylide precursor; and
(v) reacting the phosphonium ylide with a carbonyl containing compound selected from the group consisting of an aldehyde, ketone or ester to form an olefin and a phosphine oxide which re-enters the catalytic cycle; wherein the olefin formed comprises the carbon which formed the carbonyl group of the carbonyl containing compound.

3. The method of claim 2, wherein the phosphine oxide is a cyclic phosphine oxide and the method is performed at room temperature.

4. The method of claim 2, wherein the phosphine oxide is an acyclic phosphine oxide and the method is performed at a temperature higher than 80° C.

5. The method of claim 2, wherein the phosphine oxide has the formula: 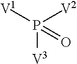
wherein V¹, V², and V³ are independently selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic; or together at least 2 of V¹, V² and V³ together form a ring system, comprising from 2 C atoms to 20 C atoms;
wherein any of V¹, V² and V³; or said ring system;
are unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

6. The method of claim 2, wherein the phosphine oxide has the formula: 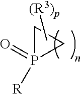
wherein n is 1 to 4; p is 0 to 10;
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

7. The method of claim 2, wherein the phosphine oxide has the formula: 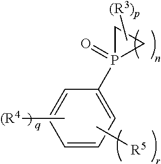
wherein n is 1 to 4; p is 0 to 14; q is 0 to 5; r is 1 to 5;
R³ is selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R⁴ is selected from the group consisting of selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R⁴ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R⁵ is selected from the group consisting of selected from the group consisting of hydrogen, halogen, nitro, nitroso, halogen, cyano, —C(O)O—C₁-C₆ alkyl, a C₁-C₆ sulfone, a C₁-C₆ sulfoxide, a C₁-C₆ primary amide, a C₁-C₆ secondary amide, a C₁-C₁₂ aliphatic, a C₃-C₁₀ cycloaliphatic, a C₂-C₁₀ aliphatic heterocycle, a C₆-C₂₀ aromatic and a C₂-C₂₀ heteroaromatic;
wherein any R⁵ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

8. The method of claim 2, wherein the phosphine oxide has the formula: 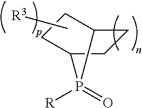
wherein n is 1 to 4; p is 0 to 14;
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R³ is selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

9. The method of claim 2, wherein the phosphine oxide has the formula: 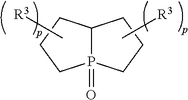
p is 0 to 4;
R³ is selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

10. The method of claim 2, wherein the phosphine oxide is selected from the group consisting of:

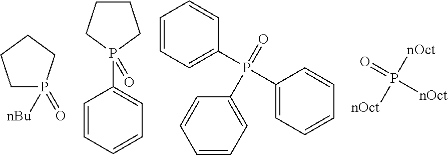

11. The method of claim 2, wherein the acid additive component has the formula: 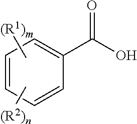
wherein m is from 1 to 5; n is 0-5; and m plus n≦5;
R¹ is an electron withdrawing group, selected from the group consisting of nitro, nitroso, fluoro, difluoromethyl, trifluoromethyl, cyano, a C₁-C₆ sulfone, a C₁-C₆ sulfoxide, a C₁-C₆ primary amide, a C₁-C₆ secondary amide; and
R² is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic; wherein R¹ can be unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ ester, a C₁-C₆ ketone, a C₁-C₆ ketimine, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, and a nitroso group.

12. The method according to claim 2, wherein the acid additive component is a nitrobenzoic acid.

13. The method according to claim 2, wherein the acid additive component is selected from the group consisting of o-nitrobenzoic acid, m-nitrobenzoic acid, and p-nitrobenzoic acid.

14. The method according to claim 2, wherein the acid additive component is trifluoromethyl benzoic acid, a bis(trifluoromethyl)benzoic acid, or a tris(trifluoromethyl)benzoic acid.

15. The method according to claim 2, wherein the acid additive component is selected from the group consisting of o-trifluorobenzoic acid, m-trifluorobenzoic acid, p-trifluorobenzoic acid, 2,4-bis(trifluoromethyl)benzoic acid, and 2,4,6-tris(trifluoromethyl)benzoic acid.

16. The method according to claim 2, wherein the phosphine oxide precatalyst is selected from the group consisting of: 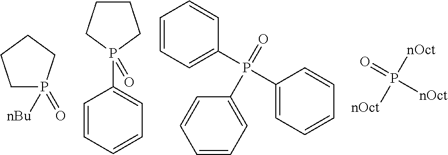
and the acid additive component is a nitrobenzoic acid selected from the group consisting of: o-nitrobenzoic acid, m-nitrobenzoic acid, and p-nitrobenzoic acid.

17. A method for performing a catalytic Wittig reaction, comprising the steps of:
(i) providing a phosphine oxide precatalyst;
(ii) reducing the phosphine oxide precatalyst to produce a phosphine;
(iii) forming a semi-stabilised or non-stabilised phosphonium ylide precursor by reacting the phosphine with a primary or secondary organohalide;
(iv) generating a semi-stabilised or non-stabilised phosphonium ylide from the semi-stabilised or non-stabilised phosphonium ylide precursor; and
(v) reacting the semi-stabilised or non-stabilised phosphonium ylide with a carbonyl containing compound to form an olefin and a phosphine oxide which re-enters the catalytic cycle.

18. The method of claim 17, wherein the phosphine oxide has the formula: 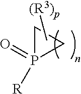
wherein n is 1 to 4; p is 0 to 10;
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

19. The method of claim 17, wherein the phosphine oxide precatalyst has the formula: 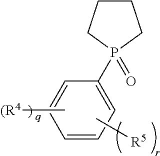
wherein q is 0 to 5; r is 1 to 5;
R⁴ is selected from the group consisting of selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R⁴ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R⁵ is selected from the group consisting of selected from the group consisting of hydrogen, halogen, nitro, nitroso, halogen, cyano, —C(O)O—C₁-C₆ alkyl, a C₁-C₆ sulfone, a C₁-C₆ sulfoxide, a C₁-C₆ primary amide, a C₁-C₆ secondary amide, a C₁-C₁₂ aliphatic, a C₃-C₁₀ cycloaliphatic, a C₂-C₁₀ aliphatic heterocycle, a C₆-C₂₀ aromatic and a C₂-C₂₀ heteroaromatic;
wherein any R⁵ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

20. The method of claim 17, wherein the phosphine oxide has the formula: 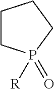
wherein R is a C₁-C₁₂ aliphatic.

21. The method of claim 17, wherein the phosphine oxide is selected from the group consisting of:

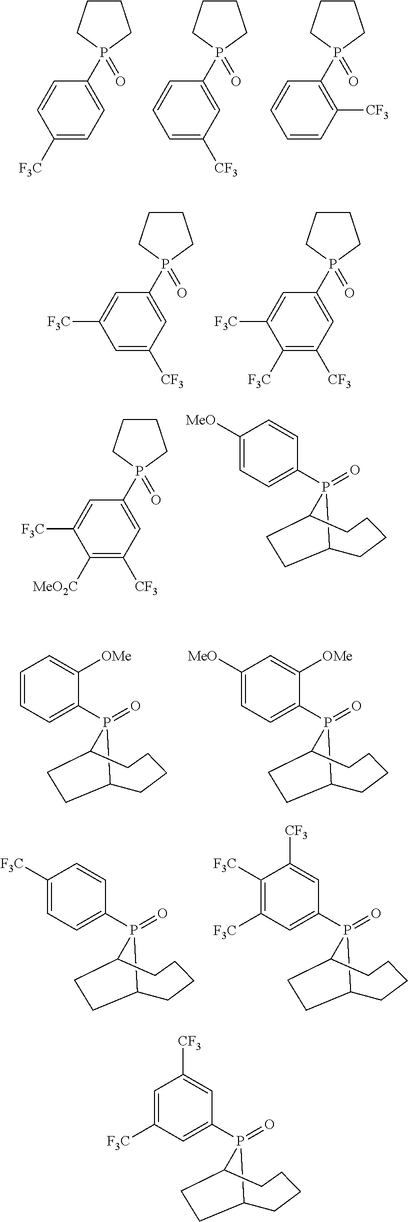

22. The method of claim 17, wherein the semi-stabilised or non-stabilised phosphonium ylid is formed by deprotonation of the semi-stabilised or non-stabilised phosphonium ylid precursor using a masked carbonate base which decomposes to produce an alkoxide base.

23. The method of claim 17, wherein the semi-stabilised or non-stabilised phosphonium ylid is formed by deprotonation of the semi-stabilised or non-stabilised phosphonium ylid precursor using a masked carbonate base which decomposes to produce an alkoxide base selected from the group consisting of sodium tert-butyl carbonate or potassium tert-butyl carbonate.

24. The method of claim 17, wherein the phosphine oxide is reduced using an organosilane reducing agent.

25. The method of claim 17, wherein the olefin is formed with an E/Z selectivity of >60:40.

26. A compound selected from the group consisting of:

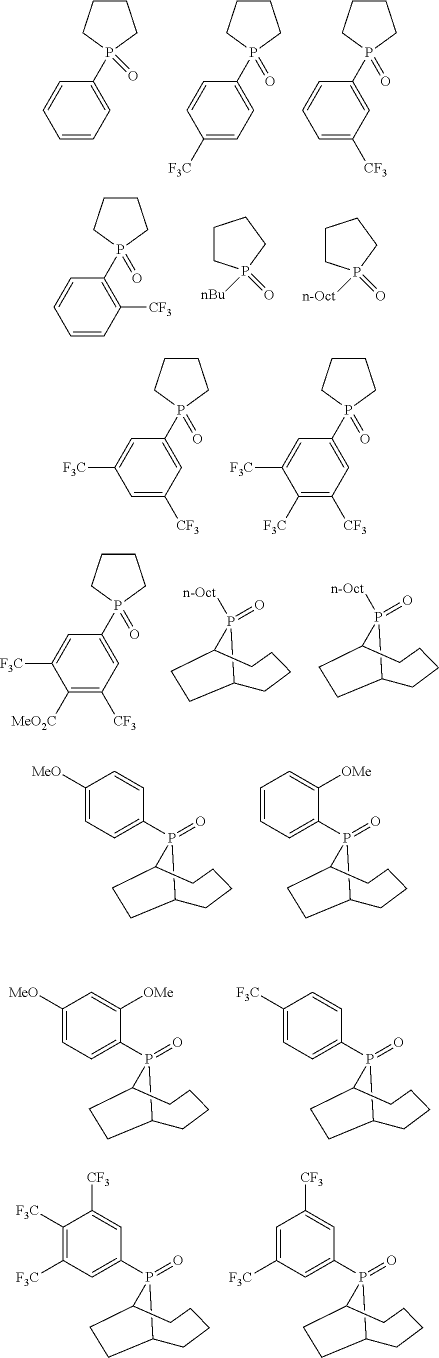

27. A compound having the formula: 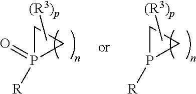
wherein n is 1 to 4; p is 0 to 10;
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl.

28. The compound according to claim 27 having the formula: 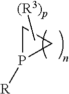
wherein n is 3 or 4; p is 0 to 10;
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R³ is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein any R³ is independently unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
wherein when p is 0 and n is 3, R is not methyl, ethyl, propyl, butyl, phenyl, tolyl or mesityl.

29. A compound claim 27 having the formula: 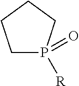
wherein R is selected from the group consisting of C₅-C₂₀ alkyl, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
wherein R is not phenyl.

30. A compound claim 27 having the formula: 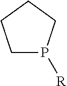
wherein R is selected from the group consisting of C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
wherein R is not phenyl, tolyl or mesityl.

31. A compound having the formula selected from the group consisting of: 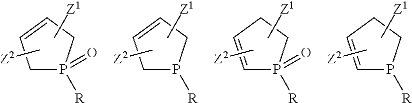
wherein Z¹ and Z² are independently selected from the group consisting of hydrogen, C₁-C₁₂ aliphatic, C₃-C₁₀ cycloaliphatic, C₂-C₁₀ aliphatic heterocycle, C₆-C₂₀ aromatic and C₂-C₂₀ heteroaromatic; or together Z¹ and Z² form a ring system, comprising from 2 C atoms to 20 C atoms;
wherein any of Z¹, Z² or said ring system;
are unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
wherein R is not methyl, ethyl, propyl, butyl, phenyl, tolyl or mesityl.

32. A compound claim 31 having the formula selected from the group consisting of: 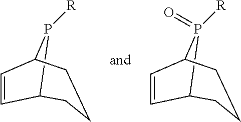
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
wherein R is not methyl, ethyl, or phenyl.

33. A compound claim 31 selected from the group consisting of: 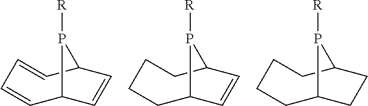
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
wherein R is not methyl, ethyl, or phenyl.

34. A compound claim 31 selected from the group consisting of: 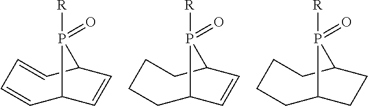
R is selected from the group consisting of C₁-C₁₂ aliphatic, C₃-C₁₀ cycloaliphatic, C₂-C₁₀ aliphatic heterocycle, C₆-C₂₀ aromatic and C₂-C₂₀ heteroaromatic;
wherein R is unsubstituted or substituted with at least one of a halogen, a hydroxyl, an amino group, a sulfonyl group, a sulphonamide group, a thiol, a C₁-C₆ alkyl, a C₁-C₆ alkoxy, a C₁-C₆ ether, a C₁-C₆ thioether, a C₁-C₆ sulfone, a C₁-C₆ sulfoxide, a C₁-C₆ primary amide, a C₁-C₆ secondary amide, a halo C₁-C₆ alkyl, a carboxyl group, a cyano group, a nitro group, a nitroso group, —OC(O)NR′R′, —N(R′)C(O)NR′R′, —N(R′)C(O)O—C₁-C₆ alkyl, C₃-C₆ cycloalkyl, C₃-C₆ heterocyclyl, C₂-C₅ heteroaryl and C₆-C₁₀ aryl; wherein each R′ is independently selected from the group consisting of hydrogen and C₁-C₆ alkyl;
wherein R is not methyl, ethyl, isopropyl or phenyl.

35. A method for performing a catalytic Wittig reaction, comprising the steps of:
(i) providing a phosphine;
(ii) forming a phosphonium ylide precursor by reacting the phosphine with a primary or secondary organohalide;
(iii) generating a phosphonium ylide from the phosphonium ylide precursor;
(iv) reacting the phosphonium ylide with a carbonyl containing compound selected from the group consisting of an aldehyde, ketone or ester to form an olefin and a phosphine oxide; wherein the olefin formed comprises the carbon which formed the carbonyl group of the carbonyl containing compound; and
(v) reducing the phosphine oxide to produce a phosphine, using an organosilane, in the presence of an acid additive component, wherein the acid additive component is an aryl carboxylic acid; and the phosphine re-enters the catalytic cycle.

36. (canceled)

37. A method according to claim 35, wherein the organosilane is selected from the group consisting of phenylsilane, trifluoromethylphenyl silane, methoxyphenylsilane, diphenylsilane, trimethoxysilane and poly(methylhydrosiloxane), 4-trifluoromethylphenyl silane, 4-methoxyphenylsilane and trimethoxysilane.
